(19) United States
(12) Patent Application Publication
(10) Pub. No.: US 2026/0155706 A1
(43) Pub. Date: Jun. 4, 2026

(54) INTEGRATED MOTOR DRIVE UNIT

(71) Applicant: ITT Manufacturing Enterprises LLC, Wilmington, DE (US)

(72) Inventors: Dean P. Williams, Moravia, NY (US); Daniel Jason Kernan, Liverpool, NY (US)

(21) Appl. No.: 19/278,371

(22) Filed: Jul. 23, 2025

Related U.S. Application Data
(60) Provisional application No. 63/675,233, filed on Jul. 24, 2024.

(51) Int. Cl. H02K 9/06; H02K 5/04; H02K 9/22; H02K 11/25

(52) U.S. Cl. CPC H02K 9/06; H02K 5/04; H02K 9/227; H02K 11/25

(57) ABSTRACT

A motor assembly for driving a pump or rotary device features a power plane with a circular geometry to be mounted inside a space envelope having a similar circular geometry formed on an end-plate between an inner hub portion and a peripheral portion that extends circumferentially around the space envelope of the end-plate. The power plane is a multi-layer circuit board or assembly having: a power layer with higher temperature power modules for providing power to a motor, a control layer with lower temperature control electronics modules for controlling the power provided to the motor, and a thermal barrier and printed circuit board layer between the power layer and the control layer that provides electrical connection paths between the power modules of the power plane and the control electronics modules of the control layer, and also provides insulation between the power layer and the control layer.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the priority benefit of U.S. Provisional Application No. 63/675,233 filed Jul. 24, 2024, the entirety of which is incorporated herein by reference.

### BRIEF DESCRIPTION OF RELATED ART

Electronics of a variable frequency drive are typically sensitive to high temperatures and can improperly operate or fail prematurely if operated at their maximum rating when combined with a motor assembly, and that the electronics can reside in a sealed enclosure contained within the motor envelope that protects the electronics from both harsh environments and excessive heat. The motor normally operates at a temperature much higher than is safe for the drive electronics.

In view of this, there is a need in the art to provide a better way to manage heat in variable frequency drives.

### SUMMARY

This application relates to techniques for improving heat management and cooling in an electronic motor drive, such as an integrated motor drive motor for driving a pump or other rotary device.

In some aspects, the techniques described herein relate to a motor assembly, including: a motor housing; an electrical motor at least partially disposed in the motor housing; a motor drive housing defining a first cavity and disposed in-line with the motor housing, the motor drive housing having a first motor drive housing wall proximal to the motor housing, and a second motor drive housing wall distal to the electrical motor, wherein the first motor drive housing wall includes a conductive material; a first fan disposed in-line with the motor housing and the motor drive housing, wherein the motor drive housing is disposed between the first fan and the motor housing; and a variable frequency drive electronics unit disposed within the first cavity and configured to provide power to the electrical motor, wherein the first motor drive housing wall serves as a heat sink for one or more components of the variable frequency drive electronics unit, the variable frequency drive electronics unit including: at least one circuit board, a plurality of power modules, a second fan, and a plurality of power control components including a plurality of power quality filter components mounted to the at least one circuit board.

In some aspects, the techniques described herein relate to a motor assembly, wherein the variable frequency drive electronics unit includes one or more thermal sensor.

In some aspects, the techniques described herein relate to a motor assembly, wherein the first fan is a variable speed fan, wherein the speed of the first fan is at least partly based on a temperature within the motor drive housing.

In some aspects, the techniques described herein relate to a motor assembly, wherein the second fan is a variable speed fan, wherein the speed of the second fan is at least partly based on the temperature within the motor drive housing.

In some aspects, the techniques described herein relate to a motor assembly, wherein the speed of the second fan is at least partly based on a temperature differential within the motor drive housing.

In some aspects, the techniques described herein relate to a motor assembly, wherein the speed of the first fan and second fan is at least partly based on a current being drawn by the motor.

In some aspects, the techniques described herein relate to a motor assembly, wherein the plurality of power quality filter components is in physical contact with the first motor drive housing wall.

In some aspects, the techniques described herein relate to a motor assembly, wherein the first motor drive housing wall has one or more receded sections configured to contact at least one power quality filter component of the plurality of power quality filter components.

In some aspects, the techniques described herein relate to a motor assembly, wherein the plurality of power modules is mounted to the at least one circuit board about a center of the at least one circuit board.

In some aspects, the techniques described herein relate to a motor assembly, wherein the plurality of power modules is in physical contact with the second motor drive housing wall, wherein the first motor drive housing wall and the second motor drive housing wall define the first cavity.

In some aspects, the techniques described herein relate to a motor assembly, wherein the at least one circuit board has a first side and a second side, wherein the plurality of power control components is on the first side, and the plurality of power modules is on the second side.

In some aspects, the techniques described herein relate to a motor assembly, further including a mid-plate disposed between the motor drive housing and the motor housing, wherein a first mid-plate wall of the mid-plate and the first motor drive housing wall are spaced from one another to define an insulative air gap.

In some aspects, the techniques described herein relate to a motor assembly, wherein the insulative air gap is 3.5 mm thick.

In some aspects, the techniques described herein relate to a motor assembly, wherein the insulative air gap has one or more vents, wherein the one or more vents are configured to dissipate heat from the insulative air gap.

In some aspects, the techniques described herein relate to a motor assembly, wherein the motor drive housing has one or more mounting guides.

In some aspects, the techniques described herein relate to a plate assembly, including: a mid-plate, the mid-plate having a mid-plate wall; an end-plate defining a first cavity and disposed in-line with the mid-plate, the end-plate having a first end-plate wall proximal to the mid-plate wall, wherein the first end-plate wall is included of a conductive material; a variable frequency drive electronics unit disposed within the first cavity and configured to provide power to an electrical motor, wherein the first end-plate wall serves as a heat sink for one or more components of the variable frequency drive electronics unit; a first fan disposed within the end-plate; and a second fan disposed in-line with the end-plate proximal to a second wall of the end-plate.

In some aspects, the techniques described herein relate to a plate assembly, wherein the variable frequency drive electronics unit includes one or more thermal sensor.

In some aspects, the techniques described herein relate to a plate assembly, wherein the first fan is a variable speed fan, wherein the speed of the first fan is at least partly based on a temperature within the end-plate.

In some aspects, the techniques described herein relate to a plate assembly, wherein the second fan is a variable speed fan, wherein the speed of the second fan is at least partly based on a temperature within the end-plate.

In some aspects, the techniques described herein relate to a plate assembly, wherein the speed of the first fan and second fan is at least partly based on a temperature differential within the end-plate.

In some aspects, the techniques described herein relate to a plate assembly, wherein the variable frequency drive electronics unit includes a circuit board, a plurality of power modules and a plurality of power control components, wherein the plurality of power control components includes a plurality of power quality filter components.

In some aspects, the techniques described herein relate to a plate assembly, wherein the plurality of power quality filter components is in physical contact with the first end-plate wall.

In some aspects, the techniques described herein relate to a plate assembly, wherein the first end-plate wall has one or more receded sections configured to contact at least one power quality filter component of the plurality of power quality filter components.

In some aspects, the techniques described herein relate to a plate assembly, wherein the mid-plate wall and the first end-plate wall are spaced from one another to define an insulative air gap.

In some aspects, the techniques described herein relate to a plate assembly, the insulative air gap has one or more vents, wherein the one or more vents are configured to dissipate heat from the insulative air gap.

In some aspects, the techniques described herein relate to a plate assembly, wherein the insulative air gap is 3.5 mm thick.

In some aspects, the techniques described herein relate to a plate assembly, wherein the plate assembly further includes: a motor housing disposed in-line with the mid-plate, wherein the mid-plate is between the motor housing and the end-plate and the mid-plate wall is distal to the motor housing; and the electrical motor at least partially disposed in the motor housing, wherein the electrical motor is distal to the mid-plate wall.

In some aspects, the techniques described herein relate to a motor assembly, including: a motor housing; an electrical motor at least partially disposed in the motor housing; a mid-plate disposed in-line with the motor housing, the mid-plate having a first mid-plate wall; an end-plate disposed in-line with the mid-plate such that the mid-plate is between the motor housing and the end-plate, the end-plate defining a first cavity and including a first end-plate wall proximal to the first mid-plate wall; and a variable frequency drive electronics unit disposed within the first cavity and configured to provide power to the electrical motor, wherein the variable frequency drive electronics unit includes one or more variable speed fans; wherein the mid-plate and the end-plate are arranged such that the first mid-plate wall and the first end-plate wall are spaced from one another to define an insulative air gap between the mid-plate and the end-plate.

In some aspects, the techniques described herein relate to a motor assembly, wherein the variable frequency drive electronics unit includes a circuit board, a plurality of power modules and a plurality of power control components.

In some aspects, the techniques described herein relate to a motor assembly, wherein the plurality of power control components includes a plurality of power quality filter components mounted to the circuit board about a center of the circuit board.

In some aspects, the techniques described herein relate to a motor assembly, wherein the first end-plate wall is a heat sink.

In some aspects, the techniques described herein relate to a motor assembly, wherein the plurality of power quality filter components is in physical contact with the first end-plate wall.

In some aspects, the techniques described herein relate to a motor assembly, wherein the first end-plate wall has one or more receded sections configured to contact at least one power quality filter component of the plurality of power quality filter components.

In some aspects, the techniques described herein relate to a motor assembly, wherein the insulative air gap is 3.5 mm thick.

In some aspects, the techniques described herein relate to a motor assembly, wherein the insulative air gap has one or more vents, wherein the one or more vents are configured to dissipate heat from the insulative air gap.

### The Basic Apparatus

According to some embodiments, an apparatus, e.g., such as a motor assembly for driving a pump or rotary device, having at least one plate having two sides, one side having a central portion, an intermediate portion and a peripheral portion.

The central portion may include, or be configured with, an opening to receive and arrange the at least one plate in relation to a rotor, e.g., of a motor drive the pump or rotary device.

The intermediate portion may be configured between an inner circumference of the central portion and the peripheral portion, and may include a multiplicity of internal radial cooling fins extending from the inner circumference of the central portion and diverging outwardly towards the peripheral portion to transfer heat from the central portion to the peripheral portion allowing for internal conduction heat capability.

The peripheral portion may include an outer circumferential surface having a multiplicity of external radial cooling fins diverging outwardly away from the plate to transfer the heat to surrounding air allowing for external convection heat capability.

The at least one plate may be, or take the form of, a mid-plate, an end-plate, or a combination thereof, that form part of the pump or rotary device, consistent with that set forth herein.

### Mid-Plate Embodiments

For example, the at least one plate may include, or take the form of, a mid-plate having a bearing housing flange portion configured to receive a motor bearing assembly, and also configured with the opening to receive the motor rotor shaft.

Mid-plate embodiments may also include one or more of the following features:

The apparatus may be, or take the form of, the motor assembly for driving the pump or rotary device, e.g., having a combination of the rotor and the motor bearing assembly having a bearing assembly arranged on the rotor.

The other of the two sides may be a smooth side having a corresponding intermediate portion with no internal or external cooling fins.

The motor assembly may include an insulation layer arranged in relation to the mid-plate, and configured to reduce the rate of heat transfer, including all forms of heat transfer from conduction, convection and radiation. By way of example, the insulation layer may be made of mica.

The motor assembly may include a power plane having electrical components, including electronics of a variable frequency drive, and the mid-plate may be configured so that the smooth side is facing the power plane

In operation, the heat may be transferred via conduction from the rotor through the mid-plate and the internal radial cooling fins to the external radial cooling fins, and may also then be transferred via convection from the external radial cooling fins to the surrounding air. The mid-plate may be configured to absorb the heat both via conduction from the rotor through the bearing assembly, and via convection through the external radial cooling fins located in the air chamber of the motor, including the heat generated from the motor from electrical and mechanical losses, including from either motor end windings, resistive or eddy currents, or both, that cause the rotor to directly conduct heat as well as to release the heat into an air chamber of the motor.

The mid-plate may be configured to provide a thermal path either from the motor end-windings to the airflow on the outside of a stator, or from the rotor to the ambient through the bearing assembly, or both.

The motor assembly may include front and rear grease retainer configured on each side of the motor bearing housing.

The motor assembly may include an insulating gasket assembly configured on the mid-plate to minimize thermal contact between the mid-plate and an end-plate.

By way of example, the mid-plate may be made of copper, aluminum or cast iron.

The mid-plate may include an outside insulation layer that limits heat flow from a mid-plate heat sink to a power converter area having a power plane and limits heat into an end-plate electronics area that form part of the end-plate.

The internal radial cooling fins of the mid-plate may be configured on and about the intermediate portion substantially uniformly and equidistantly spaced from one another.

The external radial cooling fins of the mid-plate may be configured on and about the peripheral portion uniformly and equidistantly spaced from one another.

By way of example, the mid-plate may have more external radial cooling fins then the internal radial cooling fins, including more than twice as many.

### End-Plate Embodiments

By way of further example, the at least one plate may include, or take the form of, an end-plate, where the opening of the central portion is configured to receive and engage the motor rotor shaft.

End-plate embodiments may also include one or more of the following features:

The other of the two sides may be a smooth side having a corresponding intermediate portion with no internal or external cooling fins.

The apparatus may include a motor assembly having a power plane with electrical components, including electronics of a variable frequency drive, the end-plate may be configured with an electronics housing chamber, and the power plane may be configured within the electronics housing chamber so that the smooth side is facing the power plane.

The motor assembly may include an electronics module arranged between the power plane and the smooth side of the end-plate within the electronics housing chamber.

The external radial cooling fins of the end-plate may be configured on and about the intermediate portion substantially uniformly and equidistantly spaced from one another.

The external radial cooling fins of the end-plate may be configured on and about the peripheral portion uniformly and equidistantly spaced from one another.

### Power Plane Embodiments

Apparatus, e.g., such as a motor assembly for driving a pump or rotary device, may include a power plane with a circular geometry to be mounted inside a space envelope having a similar circular geometry formed on an end-plate between an inner hub portion and a peripheral portion that extends circumferentially around the space envelope of the end-plate. The power plane may be a multi-layer circuit board or assembly having: a power layer with at least one higher temperature power module for providing power to a motor, a control layer with at least one lower temperature control electronics modules for controlling the power provided to the motor, and a thermal barrier and printed circuit board layer between the power layer and the control layer that provides electrical connection paths between the power modules of the power plane and the control electronics modules of the control layer, and also provides insulation between the power layer and the control layer.

Power plane embodiments may also include one or more of the following features: The power plane may be configured to do at least the following: allow the mounting of the at least one power module and the at least one control electronics modules on opposite sides of a thermal barrier, provide the electrical connection paths for interconnecting together the at least one power module and the at least one control electronics modules, as well as for interconnecting input/output power connections and the at least one power module and the at least one control electronics modules, and insulate and/or direct heat emitted from one or more of the at least one power module, the at least one control electronics modules and a shaft of the motor to the outer diameter of the power plane where there is a higher air flow.

The power plane may be configured as a doughnut shaped power plane printed circuit board or assembly in order to fit in the space envelope of the end-plate for providing a maximum space for mounting the power layer and the control layer, and to allow the shaft of the motor rotor to pass through to drive a cooling fan.

The power layer may be configured with higher temperature power modules; the control layer may be configured with lower temperature control electronic modules and components and power quality filter components; and the thermal barrier and printed circuit board layer may be configured from a material having a structural thickness and strength to mount the control layer on one side and the power layer on an opposite side, the material configured to provide insulation to reduce the transfer of heat between the power layer and the control layer.

The thermal barrier and printed circuit board layer may be constructed of a laminated material, including fiberglass, that provides structural strength and acts as an insulator for separating hotter power semiconductors of the power layer from cooler and sensitive control electronics and power quality capacitors of the control layer.

The power layer may include a circular power modules arrangement configured on one side of the thermal barrier and printed circuit board layer to couple to power plane low inductance input and integrated output connections, e.g., attached to an intermediate portion of the end-plate.

The at least one power module may include matrix converter power modules configured as part of a matrix converter to receive AC input signaling having an AC waveform with a voltage and frequency and provide converted AC signaling having a converted AC waveform with a converted voltage and frequency to drive the motor.

The control layer may include at least one power quality filter component configured to reduce the level of electrical noise and harmonic distortions.

The at least one power quality filter component may be attached directly onto the thermal barrier and printed circuit board layer and configured physically close or next to the matrix converter to reduce the amount of distortions emitted from matrix converter electronics in the matrix converter.

The at least one power module may include power semiconductor modules; the at least one control electronics module may include power quality capacitors; and the power plane may include low inductance and resistance inputs configured between the power semiconductor modules and the power quality capacitors in order to reduce switching stress and electromagnetic interference.

The power plane may include one or more compact power quality filters integrated therein.

The power plane may include a built-in power quality filter configured to produce minimal harmonic distortion, and protect the variable speed drive from most power quality abnormalities.

The power plane may be configured to combine both power and control circuits or circuitry into one integrated printed circuit board configuration for ease of assembly and compactness in size.

The power plane may include a combination of one or more of the following: current sensors, at least one gate driver, a power supply, a clamp circuit, power semi-conductor modules and power quality capacitors; and the electrical connection paths may be configured to interconnect input/output power connections and the combination of one or more of the current sensors, the at least one gate driver, the power supply, the clamp circuit, the power semi-conductor modules and the power quality capacitors.

The motor assembly may include the end-plate; the inner hub portion may be configured to receive the shaft of the motor rotor; and the peripheral portion may include heat fins configured to dissipate away from the end-plate heat generated by the at least one power module and the at least one control electronic module.

The motor assembly may include a motor casing configured to be utilized as a heat sink to allow a compact size and thermally optimized operation of the power plane.

The motor assembly may include, or takes the form of, a rotary device or pump, e.g., having the end-plate with the power plane arranged therein.

Embodiments of the present disclosure provide a better way to increase the power density of variable frequency electronics and reduce the sensitivity of the electronics of a variable frequency drive to high temperatures for the purpose of installing the variable speed electronics inside a motor assembly; so as to eliminate or reduce substantially the improper operation or failure prematurely of such electronics of such a variable frequency drive if operated at their maximum rating.

### Additional Embodiments of Motor Assembly

In some aspects, the techniques described herein relate to a motor assembly, including: a motor housing; an electrical motor at least partially disposed in the motor housing; a mid-plate disposed in-line with the motor housing, the mid-plate having a first mid-plate wall distal to the motor housing; an end-plate defining a first cavity and disposed in-line with the mid-plate such that the mid-plate is between the motor housing and the end-plate, the end-plate having a first end-plate wall proximal to the first mid-plate wall, wherein the first end-plate wall is included of a conductive material; and a variable frequency drive electronics unit disposed within the first cavity and configured to provide power to the electrical motor, wherein the first end-plate wall serves as a heat sink for one or more components of the variable frequency drive electronics unit.

In some aspects, the techniques described herein relate to a motor assembly, wherein the variable frequency drive electronics unit includes a circuit board, a plurality of power modules and a plurality of power control components.

In some aspects, the techniques described herein relate to a motor assembly, wherein the plurality of power control components includes a plurality of power quality filter components mounted to the circuit board about a center of the circuit board.

In some aspects, the techniques described herein relate to a motor assembly, wherein the plurality of power quality filter components is in physical contact with the first end-plate wall.

In some aspects, the techniques described herein relate to a motor assembly, wherein the first end-plate wall has one or more receded sections configured to contact at least one power quality filter component of the plurality of power quality filter components.

In some aspects, the techniques described herein relate to a motor assembly, wherein the plurality of power modules is mounted to the circuit board about a center of the circuit board.

In some aspects, the techniques described herein relate to a motor assembly, wherein the plurality of power modules is in physical contact with a second end-plate wall, wherein the first end-plate wall and the second end-plate wall define the first cavity.

In some aspects, the techniques described herein relate to a motor assembly, wherein the circuit board has a first side and a second side, wherein the plurality of power control components is on the first side, and the plurality of power modules is on the second side.

In some aspects, the techniques described herein relate to a motor assembly, wherein the first mid-plate wall and the first end-plate wall are spaced from one another to define an insulative air gap.

In some aspects, the techniques described herein relate to a motor assembly, wherein the insulative air gap is 3.5 mm thick.

In some aspects, the techniques described herein relate to a motor assembly, the insulative air gap has one or more vents, wherein the one or more vents are configured to dissipate heat from the insulative air gap.

In some aspects, the techniques described herein relate to a motor assembly, wherein the end-plate has one or more mounting guides.

In some aspects, the techniques described herein relate to a motor assembly, including: a motor housing; an electrical motor at least partially disposed in the motor housing; a mid-plate disposed in-line with the motor housing, the mid-plate having a first mid-plate wall; an end-plate disposed in-line with the mid-plate such that the mid-plate is between the motor housing and the end-plate, the end-plate defining a first cavity and including a first end-plate wall proximal to the first mid-plate wall; a variable frequency drive electronics unit disposed within the first cavity and configured to provide power to the electrical motor; wherein the mid-plate and the end-plate are arranged such that the first mid-plate wall and the first end-plate wall are spaced from one another to define an insulative air gap between the mid-plate and the end-plate.

In some aspects, the techniques described herein relate to a motor assembly, wherein the variable frequency drive electronics unit includes a circuit board, a plurality of power modules and a plurality of power control components.

In some aspects, the techniques described herein relate to a motor assembly, wherein the plurality of power control components includes a plurality of power quality filter components mounted to the circuit board about a center of the circuit board.

In some aspects, the techniques described herein relate to a motor assembly, wherein the first end-plate wall is a heat sink.

In some aspects, the techniques described herein relate to a motor assembly, wherein the plurality of power quality filter components is in physical contact with the first end-plate wall.

In some aspects, the techniques described herein relate to a motor assembly, wherein the first end-plate wall has one or more receded sections configured to contact at least one power quality filter component of the plurality of power quality filter components.

In some aspects, the techniques described herein relate to a motor assembly, wherein the insulative air gap is 3.5 mm thick.

In some aspects, the techniques described herein relate to a motor assembly, the insulative air gap has one or more vents, wherein the one or more vents are configured to dissipate heat from the insulative air gap.

In some aspects, the techniques described herein relate to a motor assembly, including: a motor housing; an electrical motor at least partially disposed in the motor housing; a variable frequency drive unit disposed in-line with the motor housing, the variable frequency drive unit including a drive unit housing defining a first cavity; a terminal box supported by the motor housing, wherein the terminal box defines a second cavity; and a variable frequency drive electronics unit disposed partially within the first cavity and partially within the second cavity and configured to provide power to the electrical motor.

In some aspects, the techniques described herein relate to a motor assembly, wherein the variable frequency drive electronics unit includes a circuit board, a plurality of power modules and a plurality of power control components.

In some aspects, the techniques described herein relate to a motor assembly, wherein the plurality of power modules is positioned within the first cavity, and the plurality of power control components is positioned within the first cavity and the second cavity.

In some aspects, the techniques described herein relate to a motor assembly, wherein the plurality of power control components positioned within the second cavity include one or more inductors.

In some aspects, the techniques described herein relate to a motor assembly, wherein the plurality of power control components positioned within the second cavity are one or more power quality filter components.

In some aspects, the techniques described herein relate to a motor assembly, wherein the plurality of power control components positioned within the second cavity include one or more surge protection varistors, one or more capacitors, one or more RFI filters, and a circuit board.

In some aspects, the techniques described herein relate to a motor assembly, wherein the terminal box is removably coupled from the motor housing.

In some aspects, the techniques described herein relate to a motor assembly, wherein the terminal box has one or more connectors with self-sealing grommets.

In some aspects, the techniques described herein relate to a motor assembly, including: a motor housing; an electrical motor at least partially disposed in the motor housing; an variable frequency drive electronics unit housing disposed in-line with the motor housing and defining a first cavity, the drive electronics unit housing having one or more guide features configured to align with one or more corresponding guide features for removable mounting of the variable frequency drive electronics unit housing, such that the variable frequency drive electronics unit housing is supported by the motor housing; and variable frequency drive electronics disposed within the first cavity and configured to provide power to the electrical motor.

In some aspects, the techniques described herein relate to a motor assembly, wherein the variable frequency drive electronics includes a circuit board, a plurality of power modules and a plurality of power control components.

In some aspects, the techniques described herein relate to a motor assembly, wherein the plurality of power control components includes a plurality of power quality filter components mounted to the circuit board about a center of the circuit board.

In some aspects, the techniques described herein relate to a motor assembly, further including a mid-plate disposed between the variable frequency drive electronics unit housing and the motor housing, the mid-plate including the one or more corresponding guide features.

In some aspects, the techniques described herein relate to a motor assembly, wherein the circuit board has a first side and a second side, wherein the plurality of power control components is on the first side, and the plurality of power modules is on the second side.

In some aspects, the techniques described herein relate to a motor assembly, wherein the motor housing includes the one or more corresponding guide features.

In some aspects, the techniques described herein relate to a motor assembly wherein the one or more guide features are of male orientation and the one or more corresponding guide features are of female orientation.

In some aspects, the techniques described herein relate to a method of installing a variable frequency drive electronics unit housing including mating one or more guide features of the variable frequency drive electronics unit housing with one or more corresponding guide features of a motor housing, and subsequently fastening the variable frequency drive electronics unit housing for mounted support by the motor housing.

In some aspects, the techniques described herein relate to a motor assembly, including: a motor housing; an electrical motor at least partially disposed in the motor housing; a variable frequency drive unit disposed in-line with the motor housing, the variable frequency drive unit defining a first cavity and including a first wall proximal to the motor housing and a second wall distal to the motor housing; a terminal box disposed on the motor housing, wherein the terminal box includes of a second cavity; and a variable frequency drive electronics unit configured to provide power to the electrical motor including: a first segment including group of a plurality of electrical components disposed within the first cavity; and a second segment including one or more electrical components disposed within the second cavity.

In some aspects, the techniques described herein relate to a motor assembly wherein the first wall includes a thermal heat sink configured to dissipate heat generated by the variable frequency drive electronics unit.

In some aspects, the techniques described herein relate to a motor assembly, further including a mid-plate disposed between the variable frequency drive unit and the motor housing such that the first wall of the motor housing is proximal to the mid-plate.

In some aspects, the techniques described herein relate to a motor assembly wherein the first and second segments of the variable frequency drive electronics unit implement a matrix converter.

In some aspects, the techniques described herein relate to a motor assembly, including: a motor housing; an electrical motor at least partially disposed in the motor housing; a mid-plate disposed in-line with the motor housing, the mid-plate having a first mid-plate wall distal to the motor housing; an end-plate defining a first cavity and disposed in-line with the mid-plate such that the mid-plate is between the motor housing and the end-plate, the end-plate having a first end-plate wall proximal to the first mid-plate wall, wherein the first end-plate wall is included of a conductive material; and a variable frequency drive electronics unit disposed within the first cavity and configured to provide power to the electrical motor, wherein the first end-plate wall serves as a heat sink for one or more components of the variable frequency drive electronics unit.

In some aspects, the techniques described herein relate to a motor assembly, wherein the variable frequency drive electronics unit includes a circuit board, a plurality of power modules and a plurality of power control components.

In some aspects, the techniques described herein relate to a motor assembly, wherein the plurality of power control components includes a plurality of power quality filter components mounted to the circuit board about a center of the circuit board.

In some aspects, the techniques described herein relate to a motor assembly, wherein the plurality of power quality filter components is in physical contact with the first end-plate wall.

In some aspects, the techniques described herein relate to a motor assembly, wherein the first end-plate wall has one or more receded sections configured to contact at least one power quality filter component of the plurality of power quality filter components.

In some aspects, the techniques described herein relate to a motor assembly, wherein the plurality of power modules is mounted to the circuit board about a center of the circuit board.

In some aspects, the techniques described herein relate to a motor assembly, wherein the plurality of power modules is in physical contact with a second end-plate wall, wherein the first end-plate wall and the second end-plate wall define the first cavity.

In some aspects, the techniques described herein relate to a motor assembly, wherein the circuit board has a first side and a second side, wherein the plurality of power control components is on the first side, and the plurality of power modules is on the second side.

In some aspects, the techniques described herein relate to a motor assembly, wherein the first mid-plate wall and the first end-plate wall are spaced from one another to define an insulative air gap.

In some aspects, the techniques described herein relate to a motor assembly, wherein the insulative air gap is 3.5 mm thick.

In some aspects, the techniques described herein relate to a motor assembly, wherein the insulative air gap has one or more vents, wherein the one or more vents are configured to dissipate heat from the insulative air gap.

In some aspects, the techniques described herein relate to a motor assembly, wherein the end-plate has one or more mounting guides.

In some aspects, the techniques described herein relate to a plate assembly, including: a mid-plate, the mid-plate having a mid-plate wall; an end-plate defining a first cavity and disposed in-line with the mid-plate, the end-plate having a first end-plate wall proximal to the mid-plate wall, wherein the first end-plate wall is included of a conductive material; and a variable frequency drive electronics unit disposed within the first cavity and configured to provide power to an electrical motor, wherein the first end-plate wall serves as a heat sink for one or more components of the variable frequency drive electronics unit.

In some aspects, the techniques described herein relate to a plate assembly, wherein the variable frequency drive electronics unit includes a circuit board, a plurality of power modules and a plurality of power control components, wherein the plurality of power control components includes a plurality of power quality filter components.

In some aspects, the techniques described herein relate to a plate assembly, wherein the plurality of power quality filter components is in physical contact with the first end-plate wall.

In some aspects, the techniques described herein relate to a plate assembly, wherein the first end-plate wall has one or more receded sections configured to contact at least one power quality filter component of the plurality of power quality filter components.

In some aspects, the techniques described herein relate to a plate assembly, wherein the mid-plate wall and the first end-plate wall are spaced from one another to define an insulative air gap.

In some aspects, the techniques described herein relate to a plate assembly, the insulative air gap has one or more vents, wherein the one or more vents are configured to dissipate heat from the insulative air gap.

In some aspects, the techniques described herein relate to a plate assembly, wherein the insulative air gap is 3.5 mm thick.

In some aspects, the techniques described herein relate to a plate assembly, wherein the plate assembly further includes: a motor housing disposed in-line with the mid-plate, wherein the mid-plate is between the motor housing and the end-plate and the mid-plate wall is distal to the motor housing; and, the electrical motor at least partially disposed in the motor housing, wherein the electrical motor is distal to the mid-plate wall.

### BRIEF DESCRIPTION OF THE DRAWINGS

The drawing includes the following Figures, which are not necessarily drawn to scale:

FIG. 1 is an exploded view of apparatus, e.g., in the form of a motor assembly for driving a pump or rotary device, according to some embodiments.

FIGS. 2A and 2B are cross-sectional views of part of a motor assembly, e.g., similar to or like that shown in FIG. 1.

FIG. 3A shows a perspective view of a motor side of a mid-plate according to an embodiment.

FIG. 3B shows a perspective view of a power plane side of the mid-plate shown in FIG. 3A, e.g., for configuring in the motor assembly shown in FIG. 1 or 2, according to some embodiments.

FIG. 4A shows a perspective view of a fan side of an end-plate according to an embodiment.

FIG. 4B shows a perspective view of a mid-plate side of the end-plate shown in FIG. 4A, e.g., for configuring in the motor assembly shown in FIG. 1 or 2, according to some embodiments.

FIG. 5A shows a motor assembly having labeled and identified a motor frame, a mid-plate, an end-plate, a terminal box and a fan; FIG. 5B showing a prospective view of a motor assembly that includes a partial exploded view of the terminal box; FIG. 5C showing a prospective view of a motor assembly that includes a partial exploded view of a motor and mid-plate combination, an end-plate, a fan and a shroud; and FIG. 5D showing an exploded view of a self-contained drive module assembly, e.g., all according to some embodiments.

FIG. 6A shows a diagram of a bi-directional switch for implementing some part of the power functionality, e.g., of the power plane, according to some embodiments, and FIG. 6B shows an example of a bi-directional switch power module for implementing some part of the power functionality, according to some embodiments.

FIG. 7 shows a motor end-plate having a power plane with a matrix converter arranged therein, e.g., configured with an example of a main power supply, a controller, a gate drive layer, clamp capacitors (CC) and input filter capacitors (IFC), according to some embodiments.

FIG. 8 shows a typical graph of a 40 HP EMD (aka a “variable frequency or speed drive) input voltage and current waveform.

FIG. 9A shows a diagram of a top view of an end-plate having a space envelope formed therein between an inner hub portion and a peripheral portion, that includes arrows representing heat flowing away from the inner hub portion and towards the peripheral portion, e.g., when operating according to some embodiments; FIG. 9B shows a diagram of a side cross-sectional view of the end-plate in FIG. 9A having corresponding arrows representing heat flowing away from the inner hub portion and towards the peripheral portion of the end-plate, when operating according to some embodiments.

FIG. 10A shows an end-plate having an example of one possible clamp resistor implementation, according to some embodiments; and FIG. 10B shows a donut shaped power plane printed circuit board layer, e.g., including an example of connections to three shunt resistors and gate driver connections, according to some embodiments.

FIG. 11 is an exploded view of apparatus, e.g., in the form of a motor assembly for driving a pump or rotary device, according to some embodiments.

FIGS. 12A and 12B are cross-sectional views of part of a motor assembly, e.g., similar to or like that shown in FIG. 11.

FIG. 13A(1), 13A(2), and 13B show a mid-plate according to some embodiments—including FIG. 13A(1) showing a perspective view of a motor side of the mid-plate, and FIG. 13A(2) showing a perspective view of a power plane side of the mid-plate shown in FIG. 13A(1), e.g., for configuring in the motor assembly shown in FIG. 11 or 12A and 12B, according to some embodiments; and FIG. 13B shows one side of a mid-plate, e.g., for configuring in the motor assembly shown in FIGS. 11 or 12A and 12B, according to some embodiments.

FIGS. 14A and 14B show an end-plate according to some embodiments—including FIG. 14A showing a perspective view of a fan side of the end-plate, and FIG. 14B showing a perspective view of a mid-plate side of the end-plate shown in FIG. 14A, e.g., for configuring in the motor assembly device shown in FIGS. 11 or 12A and 12B, according to some embodiments.

FIG. 15 shows a motor assembly having labeled and identified a motor frame, a mid-plate, an end-plate, and a fan, e.g., according to some embodiments.

FIG. 16 shows a motor end-plate having a power plane arranged therein and configured with a printed circuit board (PCB) and a matrix converter, according to some embodiments.

FIG. 17A shows a diagram of a top view of an end-plate having a space envelope formed therein between an inner hub portion and a peripheral portion, that includes arrows representing heat flowing away from the inner hub portion and towards the peripheral portion, e.g., when operating according to some embodiments; FIG. 17B shows a diagram of a side cross-sectional view of the end-plate in FIG. 17A having corresponding arrows representing heat flowing away from the inner hub portion and towards the peripheral portion of the end-plate, when operating according to some embodiments; and FIG. 17C shows a diagram of a side cross-sectional view of the end-plate in FIG. 17B having various modules and components arranged in the space envelope, including a circular power modules arrangement, power plane low inductance input and integrated output connections, low temperature electronic components, e.g., mounted on the power plane, and power quality filter capacitors, according to some embodiments.

FIG. 18A showing a power modules layout that forms part of a motor assembly, all according to some embodiments.

FIG. 18B shows a photograph of a final assembly of a matrix converter arranged in an end-plate, e.g., having a power plane circuit board with a gate driver power supply, a clamp circuit control, input filter capacitors clamp capacitors and control cards assembled thereon, according to some embodiments.

FIG. 19 is an exploded view of one embodiment of a motor assembly for driving a pump or rotary device.

FIG. 20 is a cross-sectional view of part of the motor assembly of FIG. 19.

FIG. 21 is a close-up view of one embodiment of the thermal insulation gap of the motor assembly of FIG. 19.

FIG. 22 is a front view (mid-plate side) of the end-plate of the motor assembly of FIG. 19.

FIG. 23 and FIG. 24A are a back view and a front perspective view, respectively, of the end-plate of the motor assembly of FIG. 19.

FIG. 24B is an exploded perspective view of the motor, terminal box, mid-plate, and end-plate.

FIG. 25 is a perspective view of the end-plate 1940 of the motor assembly of FIG. 19 with the conductive cover removed.

FIG. 26 is a perspective view of the multi-board power plane and the corresponding electronics.

FIG. 27 is an exploded view of the end-plate and its internal components (e.g., multi-board power plane).

FIG. 28 is a cross-section view of the end-plate and its internal components (e.g., multi-board power plane).

FIG. 29A and FIG. 29B are a front cross-section views (mid-plate side) of the end-plate and the motor assembly of FIG. 19.

FIG. 30 is a front view (e.g., mid-plate side) of the power layer of the multi-board power plane.

FIG. 31 is a back view (e.g., fan side) of the power layer of the multi-board power plane.

FIG. 32 and FIG. 33 are front and back views, respectively, of the control layer of the multi-board power plane.

FIG. 34 and FIG. 35 are front and back views, respectively, of the second control layer of the multi-board power plane.

FIG. 36A and FIG. 36B are front and back views of the control PCB board and housing of the third control layer of the multi-board power plane.

FIG. 37 shows front and back views of the switched-mode power supply of the multi-board power plane.

FIG. 38 and FIG. 39 are a front and front-perspective view, respectively of the mid-plate of the motor assembly of FIG. 19.

FIG. 40 and FIG. 41 are a back and back-perspective view, respectively of the mid-plate of the motor assembly of FIG. 19.

FIG. 42 is a perspective view of the motor assembly of FIG. 19.

FIG. 43A, FIG. 43B, and FIG. 43C are top views of the terminal box of the motor assembly of FIG. 19.

FIG. 44 and FIG. 45 are a side view and a cross-section side view, respectively, of the terminal box of the motor assembly of FIG. 19.

FIG. 46A illustrates the connector with a protective cover.

FIG. 46B illustrates the connector with no protective cover.

FIG. 47 is a top-exploded view of the connectors of the terminal box of the motor assembly.

FIG. 48 and FIG. 49 are front views of the connectors of the terminal box of the motor assembly.

FIG. 50 is a schematic diagram of a matrix converter according to one embodiment.

FIG. 51 is a schematic diagram of one embodiment of a clamp for a matrix converter.

FIG. 52 is a schematic diagram of one embodiment of a portion of circuitry of a matrix converter.

FIG. 53A is a schematic diagram of a bidirectional switch according to one embodiment.

FIG. 53B is a schematic diagram of a bidirectional switch according to another embodiment.

FIG. 53C is a schematic diagram of a bidirectional switch according to another embodiment.

FIG. 54 is a schematic diagram of a matrix converter according to another embodiment.

FIG. 55A is front cross-section view (mid-plate side) of the end-plate and the motor assembly.

FIG. 55B is a cross-sectional view of part of the motor assembly.

FIG. 55C is a front views of an embodiment of the end-plate.

FIGS. 56A and 56B are back and side views of an embodiment of the endplate.

The drawing includes examples of possible implementations; and the scope is not intended to be limited to the implementations shown therein. For example, the scope of is intended to include, and embodiments are envisioned using, other implementations besides, or in addition to, that shown in the drawing, which may be configured within the spirit of the disclosure in the present application as a whole.

### DETAILED DESCRIPTION

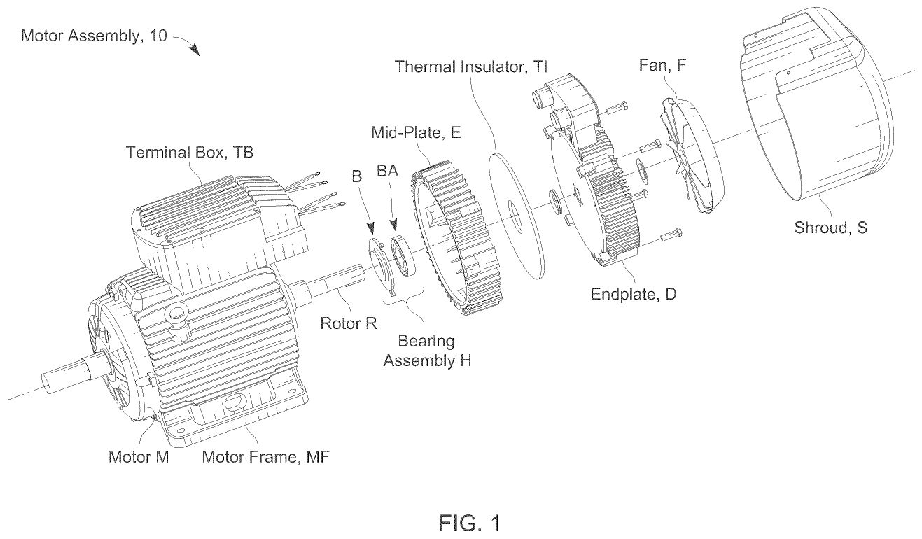

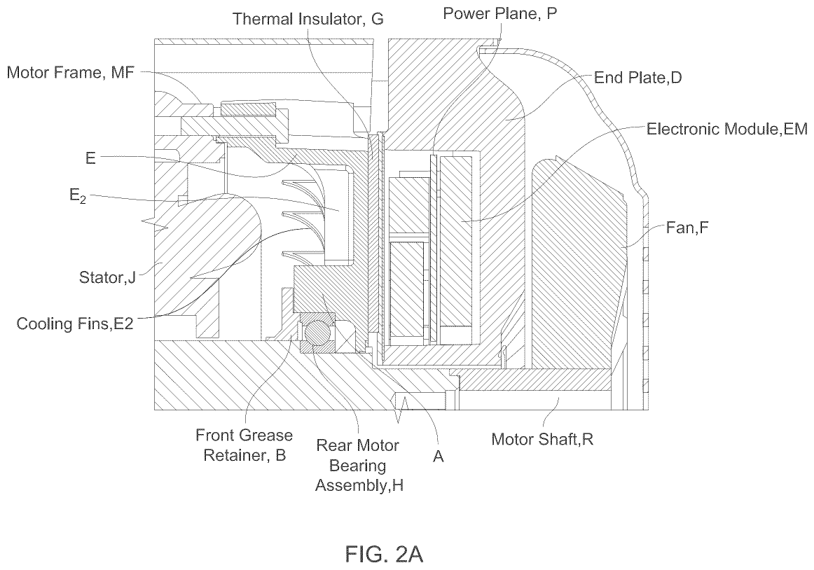

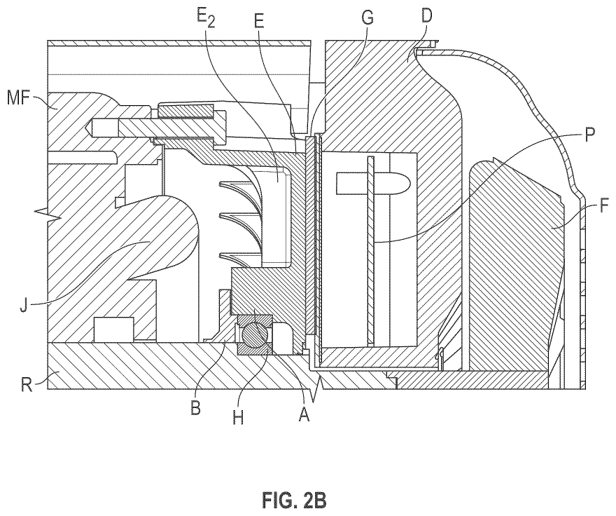

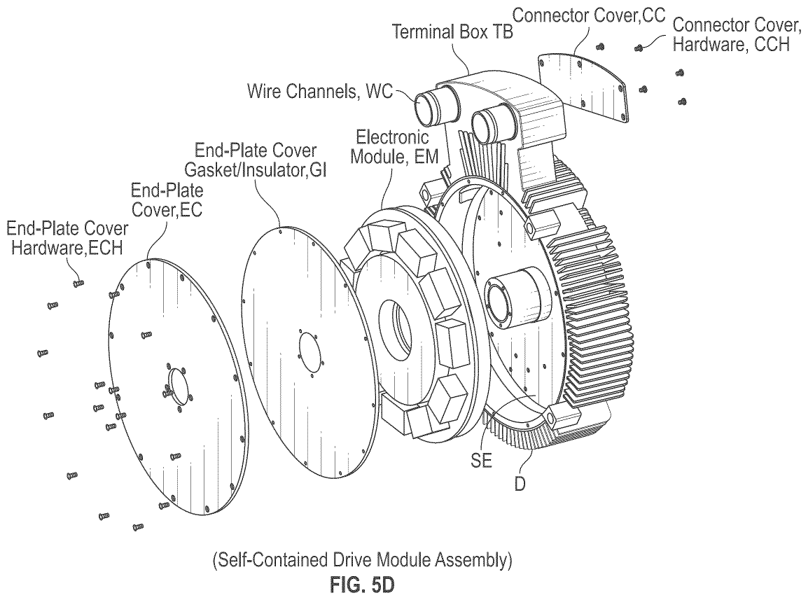

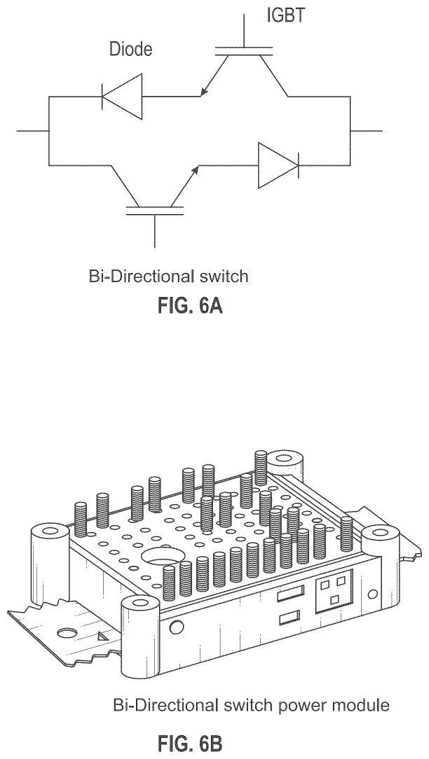

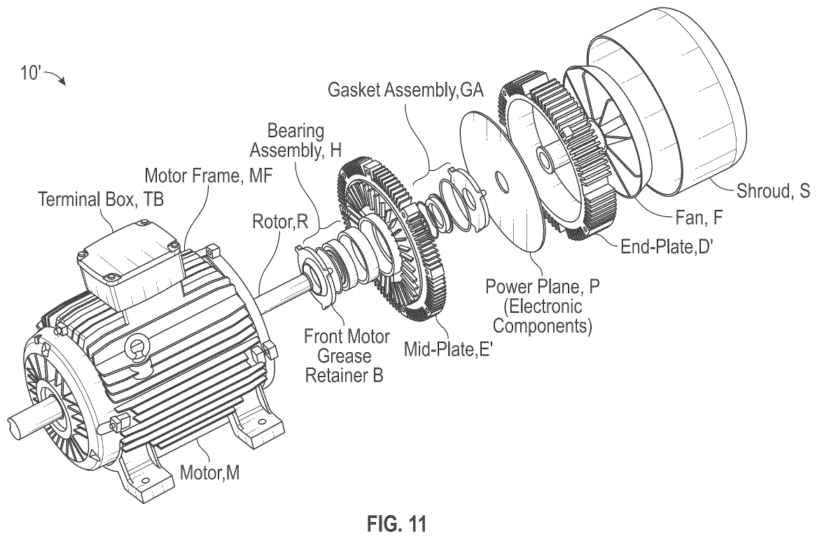

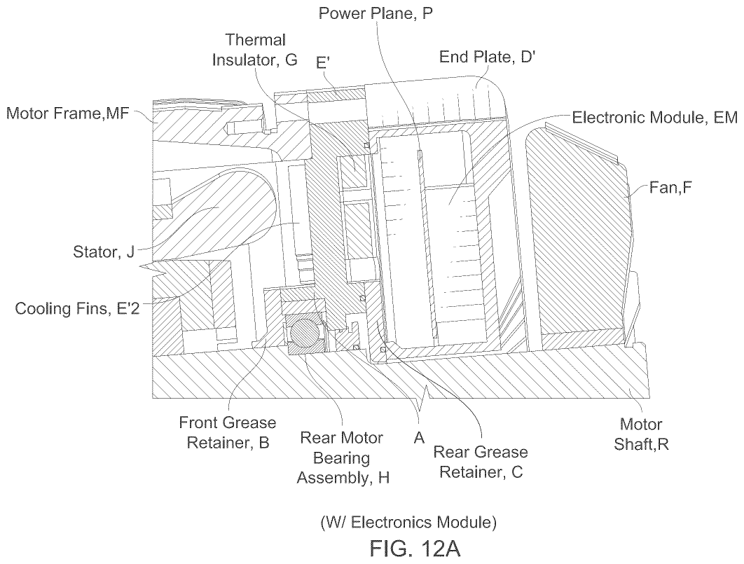

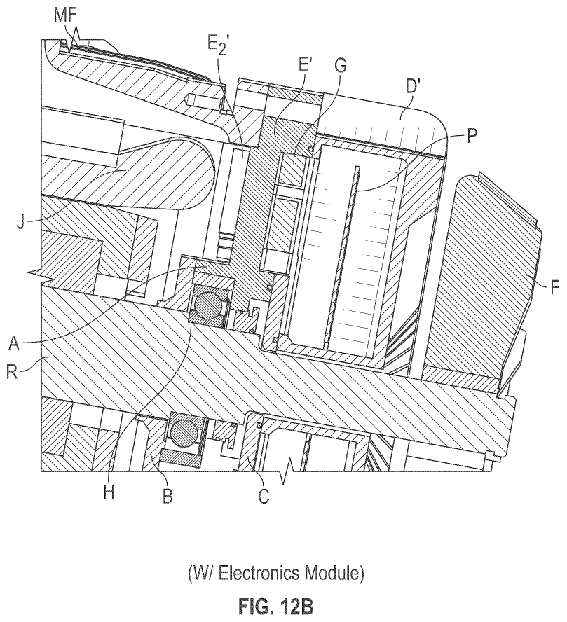

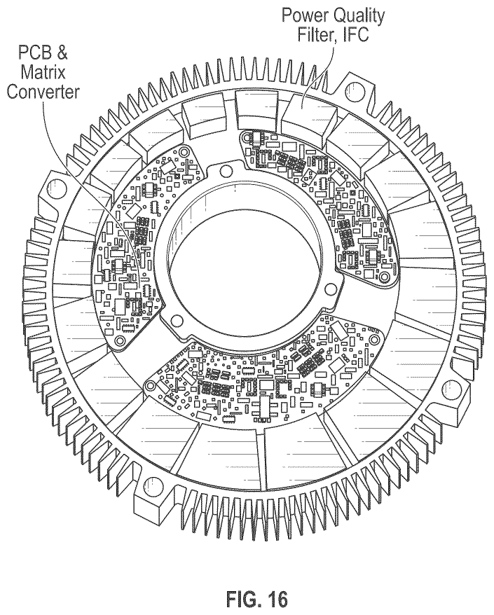

FIGS. 1 and 11 show an apparatus generally indicated as 10, 10′, e.g., that may include, or take the form of, a motor assembly 10 for driving a pump or rotary device (not shown). The motor assembly 10 includes a motor M having a motor frame MF with a stator J (see FIGS. 2A, 2B; 12A, 12B) arranged therein, a rotor R coupled to the motor M, a mid-plate E having a bearing housing flange portion A (see FIGS. 2A, 2B; 12A, 12B), a rear motor bearing assembly generally indicated as H having a bearing assembly BA, front B and rear C grease retainers, a fan F, an integrated insulated layer G (FIGS. 12A, 12B), a gasket assembly GA (FIG. 11), an end-plate D, a power plane P (FIGS. 2A, 2B, 11, 12A, 12B) and a shroud S. The motor frame MF also includes a terminal box TB, e.g., as shown in FIGS. 1 and 11. The power plane P may be configured to include electronics, e.g., including a variable frequency drive, configured for controlling the operation of the motor M, which in turn is used for driving the pump or other rotary device. The power plane P is described in further detail, e.g., in relation to that shown in FIGS. 6A through 10B, as well as FIGS. 16, 17C, 18A and 18B.

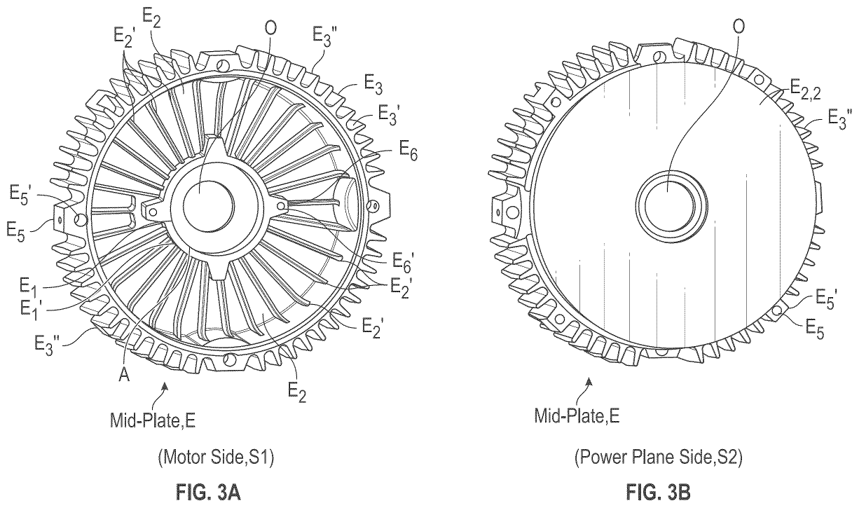

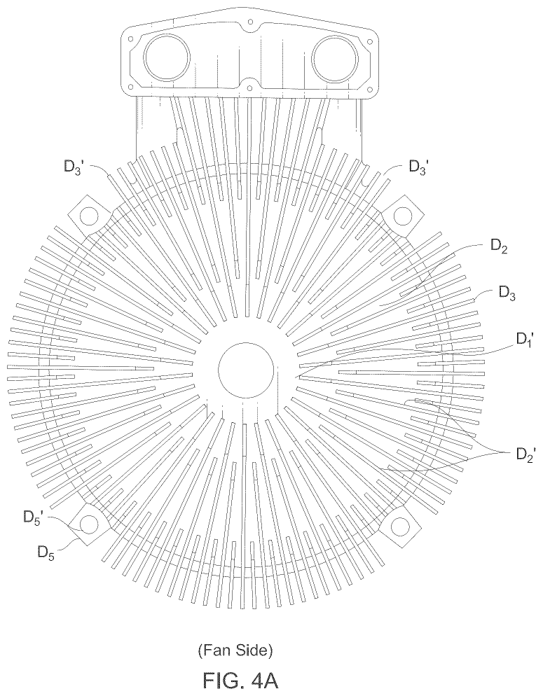

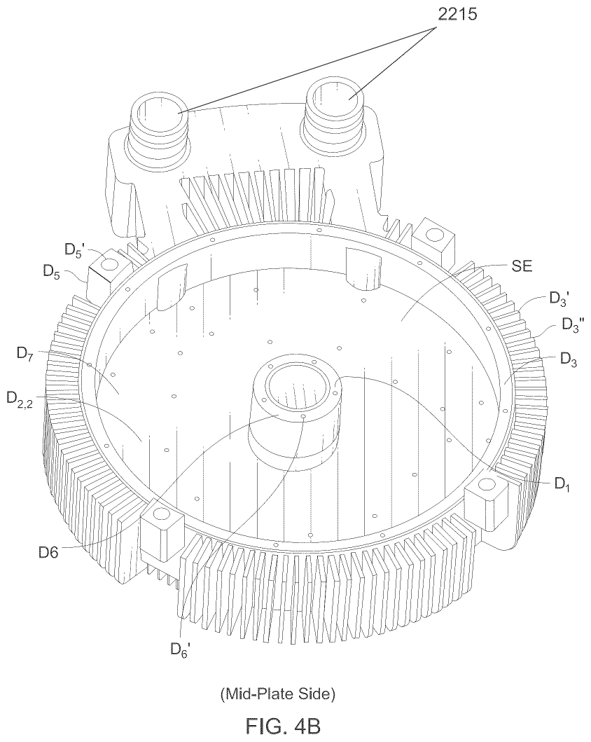

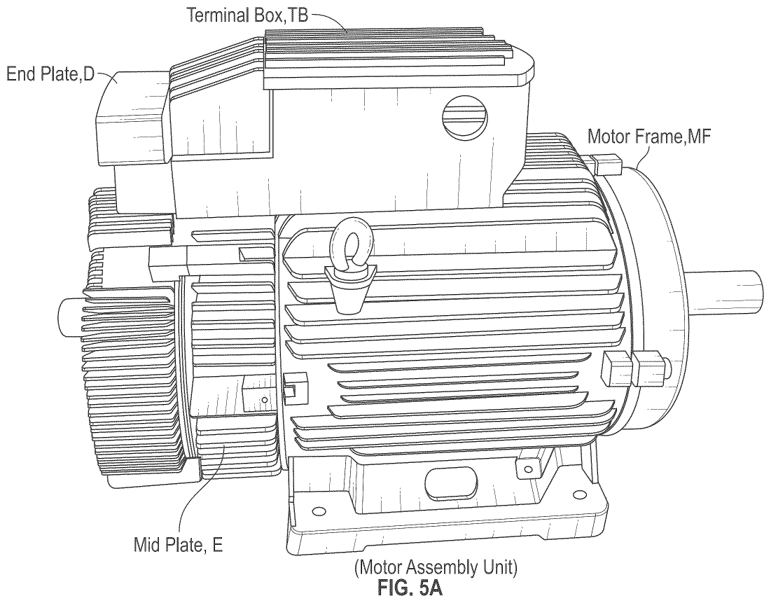

By way of example, and according to some embodiments, the motor assembly 10 may feature, or be configured with, a new and unique mid-plate E, end-plate D, or a combination thereof, e.g., consistent with that set forth below in relation to FIGS. 3A-4B .

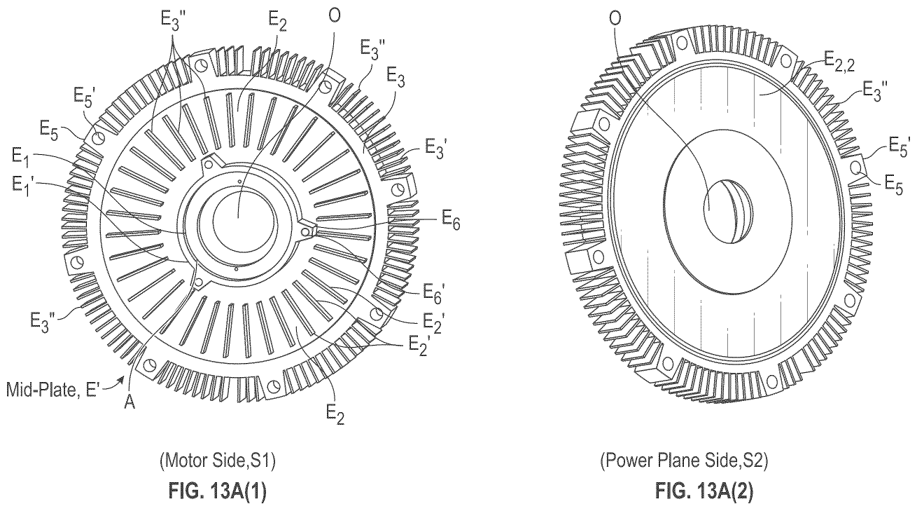

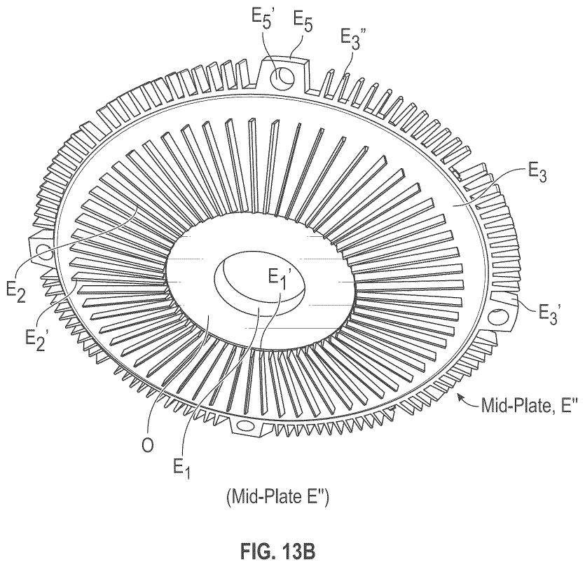

### FIGS. 3A-3B and 13(A)(1)-13(B): The Mid-Plate E

For example, FIGS. 3A-3B, 13A(1), 13A(2), and 13B shows the mid-plate E, E′, E″, each mid-plate having two sides S₁, S₂, including a motor side S₁ having a central portion E₁, an intermediate portion E₂, and a peripheral portion E₃.

The intermediate portion E₂ may be configured between the inner circumference E_{1 ′} of the central portion E₁ and the peripheral portion E₃, consistent with that shown in 3A and 13A(1). The intermediate portion E₂ may include a multiplicity of internal radial cooling fins E_{2′} extending from part of the inner circumference E_{1′} of the central portion E₁ and diverging outwardly (e.g., away from one another) towards the peripheral portion E₃ to transfer heat from the central portion E₁ to the peripheral portion E₃ allowing for internal conduction heat capability.

The peripheral portion E₃ may include an outer circumferential surface E_{3′} having a multiplicity of external radial cooling fins E_{3″} diverging away from the peripheral portion E₃ to transfer the heat to surrounding air allowing for external convection heat capability.

The central portion E₁ may include the bearing housing flange portion A (see also FIGS. 2A, 2B; 11, 12A, 12B) configured to receive the motor bearing assembly H, and also configured with the opening O to receive and engage the rotor R. The motor assembly 10 may include a combination of the rotor R and the motor bearing assembly H (FIGS. 1-2A, 2B; 11, 12A, 12B) arranged on the rotor R.

FIGS. 3B, 13A(2) shows a power plane side S₂ of the two side, e.g., that may be a smooth side having a corresponding intermediate portion E_{2,2} with no cooling fins.

The motor assembly 10 may include the thermal insulator TI (FIG. 1), or the insulation layer G (FIGS. 12A-12B), arranged in relation to the mid-plate E and the end-plate D, and configured to reduce the rate of heat transfer, including all forms of heat transfer from conduction, convection and radiation.

FIG. 13B shows an alternative embodiment of a mid-plate generally indicated as E″. Similar elements in FIG. 13A(1), 13A(2), 13B are labeled with similar reference labels. By way of example, one difference between the mid-plates E′ and E″ in FIGS. 13A(1), 13A(2), 13B respectively is that the mid-plate E′ includes the bearing housing flange portion A, e.g., also shown in FIG. 3A, while the mid-plate E″ does not. Embodiments are envisioned, and the scope is intended to include, mid-plates having such a bearing housing flange portion A, as well as embodiments that do not.

Consistent with that shown in FIG. 3A, the internal radial cooling fins E_{2′} may be configured on and about the intermediate portion E₂ substantially uniformly and equidistantly spaced from one another. The external radial cooling fins E_{3″} may be configured on and about the peripheral portion E₃ substantially uniformly and equidistantly spaced from one another. By way of example, and consistent with that shown in FIG. 3A-3B, the mid-plate E may be configured with more external radial cooling fins E_{3″} than the internal radial cooling fins E_{2′} e.g., including than more than twice as many more. In FIG. 3A, the mid-plate E is shown with 30 (e.g. compare mid-plate E′ in FIG. 13A(1) with 36) internal radial cooling fins E_{2′} that are substantially uniformly and equidistantly spaced from one another. In FIG. 3A, the mid-plate E(1) is shown with 48 (e.g. compare mid-plate E′ in FIG. 13A(1) with 94) external radial cooling fins E_{3″} that are substantially uniformly and equidistantly spaced from one another. However, the scope of the embodiment is not intended to be limited to the number of the internal radial cooling fins E_{2′}, the number of the external radial cooling fins E_{3″}, or numerical relationship between the number of the internal radial cooling fins E_{2′} and the number of the external radial cooling fins E_{3″}. For example, embodiments are envisioned, and the scope is intended to include, implementations in which the number of the internal radial cooling fins E and the number of the external radial cooling fins E_{3″} is greater or less than that shown in FIGS. 3A-3B. Embodiments are also envisioned, and the scope is intended to include, implementations in which the numerical relationship between the number of the internal radial cooling fins E_{2′} and the number of the external radial cooling fins E_{3″} is different than that shown in FIGS 3A-3B .

In FIGS. 3A-3B and 13A(1), the mid-plates E′ and E″ can include other features, including outer retaining members E₅ configured with apertures E_{5′} for receiving fasteners (not shown), e.g., to couple the mid-plates E′ and E″ to some other part of the motor assembly, such as the motor frame MF (FIGS. 1 and 11), as well as including two or three outer retaining members E₆ configured with apertures E_{6′} for receiving fasteners (not shown), e.g., to couple the mid-plates E′ and E″ to some other part of the motor assembly, such as the motor frame MF (FIGS. 1 and 11).

In effect, the mid-plate embodiments set forth herein consist of a system having several highly engineered elements:

By way of example, the motor assembly 10 may be configured with a specially designed motor casing to improve thermal efficiency consisting of the following elements:
1) The mid-plate E, also called and known as a motor end-plate, may be made of copper, aluminum, or cast iron, with the rear motor bearing or bearing housing H incorporated into the mid-plate E. The mid-plate E may be optimized to conduct heat away from the pump's non-drive end bearing, the motor's stator J and rotor R, and insulate the electronics forming part of the power plane P at the same time. This innovative configuration would place the bearing housing flange portion A inside the mid-plate E or E′ as shown in FIGS. 1 and 11, and as such, the mid-plate E or E′ would effectively then become the structural support for the rotor R.
2) The special heat sink fins E_{2″}, E_{3′} may be designed for low audible noise, and increased surface area, allowing for greater thermal efficiency.
3) Circular design unique geometry may be implemented to provide optimized space and ease of manufacturing.
4) Circular geometry may be implemented that allows for configuration of power electronic modules (FIGS. 1 and 11) and electronics (FIGS. 2 and 12A), which allows the rotor/shaft R to pass through to power the cooling fan F (FIGS. 1 and 11).

The mid-plate E or E′ may include one or more of the following: The mid-plate E or E′ may be configured for housing the rear motor bearing H; The mid-plate E or E′ may be configured in relation to the power plane component P; The mid-plate E or E′ may be configured or incorporated with bearing oil/grease tubes. The mid-plate E or E′ may be configured so heat may be redirected radially versus axially. The mid-plate E or E′ may also be configured to use the radial cooling fins E_{2′} to redirect the heat from the motor end windings of the motor M to the peripheral portion or edges E₃ of the mid-plate E or E′. The mid-plate E or E′ may be configured to provide thermal paths from the motor end windings to airflow on the outside of the stator J.

The mid-plate E or E′ may be configured to provide a thermal path for the rotor R to the ambient through the bearing assembly H.

The mid-plate E or E′ may be configured to create and provide the structural support for the rotor R.

The front B and rear C grease retainers may also be used in conjunction with the mid-plate E or E′.

An integrated insulation layer G on the outside of this mid-plate E or E′ limits the heat flow from the mid-plate heat-sink to the power converter area and limits heat into the end-plate electronics area.

Minimized thermal contact may be implemented between the mid-plate E or E′ and the end-plate D via an insulating gasket G that forms part of the gasket assembly GA.

### Mid-Plate: Theory of Operation

The mid-plate E or E′ is configured with a unique design that incorporates a circular geometry with internal and external heat sink fins E_{2′}, E_{3″}, e.g., consistent with that shown in FIGS. 1 and 11. The internal fins E_{2′} are located along the inner circumference E_{1′} of the mid-plate E or E′, leaving space in the center for the rotor bearing housing H. The external fins E_{3″} are spread across the entire outer diameter/circumference of the mid-plate E or E′, allowing for external convection capability, e.g., consistent with that shown in FIGS. 1 and 11.

The mid-plate E or E′ also features a thin insulation layer G on the electronics side of the mid-plate E, which is smooth and has no fins, e.g., as shown in FIGS. 2A-2B.

This thin insulation layer G will allow various configurations for power electronic modules and electronics while still allowing the shaft/rotor R to pass through to power the cooling fan F. The main function of this design is threefold. The mid-plate E or E′ acts as a structural support for the motor M and the motor's rotor R, a heat sink for the non-drive end, and a thermal insulator for the electronics chamber, e.g., that forms part of the end-plate D.

Thermal conductors are usually made of metal, due to their higher levels of thermal conductivity and ability to absorb heat. Therefore, by way of example, the mid-plate E or E′ may be made of either aluminum, copper, or cast-iron. These metals have higher levels of thermal conductivity, good structural rigidity and are cost effective as compared to other exotic materials.

In operation, the mid-plate E or E′ achieves its function through conduction and convection, where conduction is understood to be the transfer of heat between solids that are in contact with each other, and where convection is understood to be the heat transfer between a solid and a fluid. Conduction will occur between the shaft/rotor R and the mid-plate E or E′ thru the bearing housing H, while convection occurs between the heat sink fins E_{2′}, E_{3″} and the air.

In operation, air cooled heat sinks, e.g., like element E_{3″} may act as cooling mechanisms. They conduct the heat from the object it is in contact with and transfer heat to the air through convection. To function properly, the heat sink has to be hotter than the ambient temperature and the surface area contact should be maximized to ensure efficient thermal transfer. In the context of the present motor casing design, the mid-plate E or E′ will conduct the heat generated from the electrical and mechanical losses of the motor M to the outside ambient air.

The losses from the rotor R can be attributed to the electrical losses (e.g., resistive and eddy current) caused by current flow, e.g., through aluminum bars located in the rotor R. These losses cause the rotor R to release heat into the motor's air chamber as well as directly conduct into the shaft/rotor R. The mid-plate E or E′ will absorb this heat both through conduction from the shaft/rotor R through the bearing assembly H into the mid-plate E or E′, and via convection through the heat sink fins E_{2′} or E_{3″} located in the motor's internal air chamber.

The purpose of the thermal insulator G is to reduce the rate of heat transfer between two solids/fluids. As a person skilled in the art would appreciate, insulators reduce all forms of heat transfer, which are, or may take the form of: conduction, convection, and radiation. Thermal insulators are usually made of material with high resistance to thermal conductivity, due to their ability to reject heat. Therefore, the insulation layer will be made of either mica, fiberglass, thermoplastic, or some inexpensive material with a low level of thermal conductivity and good structural rigidity.

This design is incorporated in the mid-plate E or E′ through an additional layer that is attached to the mid-plate E or E′, e.g., as shown in FIG. 2. This insulation layer G may be comprised of mica, or some other optimal insulator, that acts as a thermal insulator for the electronic components forming part of the power plane P. The insulation acts as a barrier from the losses coming from the motor M in order to redirect heat towards the heat sink fins E or E_{3″}. The mid-plate E or E′ also houses the bearing housing H, which in turn supports the rotor and motor shaft R.

The overall design of the mid-plate E or E′ makes it a novel element serving a multitude of functions simultaneously. The mid-plate E mechanically supports the non-drive end of the motor M, and allows the rotor R to spin due to the attachment of the shaft bearing contained in the center of the mid-plate E or E′. The mid-plate E or E′ efficiently conducts motor heat to the exterior of the motor body, allowing the motor M to run reliably at an efficient temperature. Thirdly, the insulator G insulates the electronics from the elevated motor temperature, and allows components to operate at temperatures below their maximum rating.

### Advantages

Advantages may include one or more of the following:
1) Allows for the manufacture of an embedded electronic motor drive (e.g., a variable frequency drive) in power levels greater than currently produced in the prior art, e.g., at power levels of at least 40HP, or at least 50HP.
2) Allows for the manufacture of a variable speed motor in the same footprint as current industrial motors at power levels greater than currently produced in the prior art, e.g., at power levels of at least 40HP, or at least 50HP.
3) Via both internal and external heat sink fins E_{2′} or E_{3″}, the mid-plate E provides a thermally conductive pathway for both the motor winding heat, and non-drive end bearing heat.
4) Via the integrated insulation, the mid-plate E or E′ provides a barrier to prevent heat from the motor to pass through to the sensitive electronics.
5) Due to its compact size, the mid-plate E or E′ allows, e.g., a matrix converter to be designed to be installed into hazardous locations containing corrosives, moisture, and Class 1, Division 2 hazardous locations, as well.

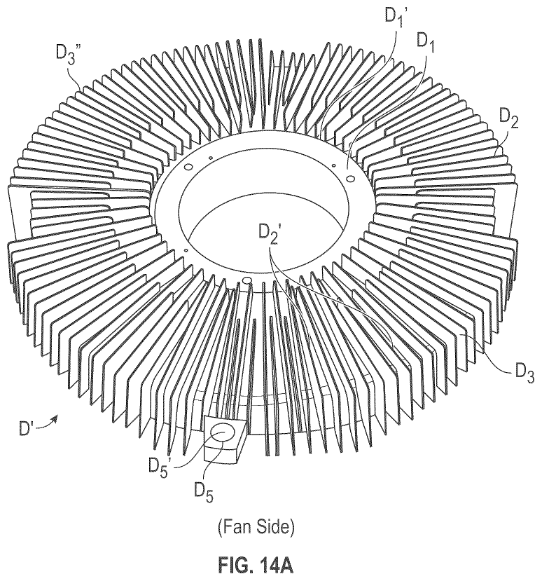

### FIGS. 4(A)-4(B) and 14: The End-Plate D, D′

FIGS. 4A-4B show the at least one plate in the form of an end-plate D, D′ having two sides, a fan side FS having a central portion D₁, an intermediate portion D₂, a peripheral portion D₃.

The central portion D₁ may be configured with an opening O to receive and arrange the end-plate D, D′ in relation to the rotor R (FIGS. 1 and 11).

The intermediate portion D₂ may be configured between an inner circumference D_{1′} of the central portion D₁ and the peripheral portion D₃. The intermediate portion D₂ may include internal radial cooling fins D_{2′} extending from the inner circumference D_{1′} of the central portion D₁ and diverging outwardly towards the peripheral portion D₃ to transfer heat from the central portion D₁ to the peripheral portion D₃ allowing for internal conduction heat capability.

The peripheral portion D₃ may include an outer circumferential surface D_{3′} (best shown as indicated in FIGS. 4B and 14B) having external radial cooling fins D_{3″} diverging outwardly away from the end-plate D to transfer the heat to surrounding air allowing for external convection heat capability.

FIGS. 4B and 14B show a mid-plate side MPS of the two side, e.g., that may be a smooth side having a corresponding intermediate portion D_{2, 2} with no cooling fins.

The power plane P may include electrical components, including electronics of a variable frequency drive, and the end-plate D, D′ may be configured so that the smooth side MPS is facing the power plane P, e.g., as shown in FIG. 2A. The electronics module EM may be arranged between the power plane P and the smooth side MPS, e.g., as shown in FIG. 2A.

Consistent with that shown in FIGS. 4A and 14, the internal radial cooling fins D_{2′} may be configured on and about the intermediate portion D₂ substantially uniformly and equidistantly spaced from one another. The external radial cooling fins D_{3″} may be configured on and about the peripheral portion E₃ substantially uniformly and equidistantly spaced from one another. By way of example, and consistent with that shown in FIG. 4A, the end-plate D, D′ may be configured so that the internal radial cooling fins D_{2′} extend and diverge outwardly towards and connect to the external radial cooling fins D_{3″}, as shown in FIGS. 4A and 14A. However, the scope of the embodiment is not intended to be limited to the number of the internal radial cooling fins D_{2′}, the number of the external radial cooling fins D_{3″}, or the numerical or physical relationship between the internal radial cooling fins D_{2′} and the external radial cooling fins D_{3″}. For example, embodiments are envisioned, and the scope is intended to include, implementations in which the number of the internal radial cooling fins D_{2′} and the number of the external radial cooling fins D_{3″} is greater or less than that shown in FIGS. 4A and 14A. Embodiments are also envisioned, and the scope is intended to include, implementations in which the physical relationship between the internal radial cooling fins D_{2′} and the external radial cooling fins D_{3″} is different than that shown in FIGS. 4A-4B and 14, e.g., including where the internal radial cooling fins D_{2′} and the external radial cooling fins D_{3″} are not connected, as well as where the number of the internal radial cooling fins D_{2′} is greater or less than the number of the external radial cooling fins D_{3″}, when compared to that shown in FIGS. 4A and 14A.

In FIGS. 4A-4B and 14, the end-plate D, D′ may include other features, including outer retaining members D₅ configured with apertures D_{5′} for receiving fasteners (not shown), e.g., to couple the end-plates D, D′ to some other part of the motor assembly, such as the motor frame MF (FIGS. 1 and 11), as well as including two or three outer retaining members D₆ configured with apertures D_{6′} for receiving fasteners (not shown), e.g., to couple the end-plates D, D′ to some other part of the motor assembly, such as the motor frame MF (FIGS. 1 and 11).

In addition to that set forth above, and by way of further example, the several other highly engineered elements of the motor assembly 10 may also include the end-plate D, D′; and the specially designed motor casing to contain electronics and improve thermal efficiency may also include: The motor end-plate D, D′, e.g., may be made of a metal such as aluminum. The end-plate D, D′ may be optimized to conduct heat away from the electronics P and/or EM contained inside of the end-plate envelope, e.g., by having an insulating gasket in the gasket assembly GA to minimize thermal contact between the mid-plate E and the end-plate D, D′.

Special heat sink fins D_{2′}, D_{3″} may be designed for low audible noise and increased surface area, allowing for greater thermal efficiency.

Circular designed unique geometry may be implemented to provide optimized space and ease of manufacturing.

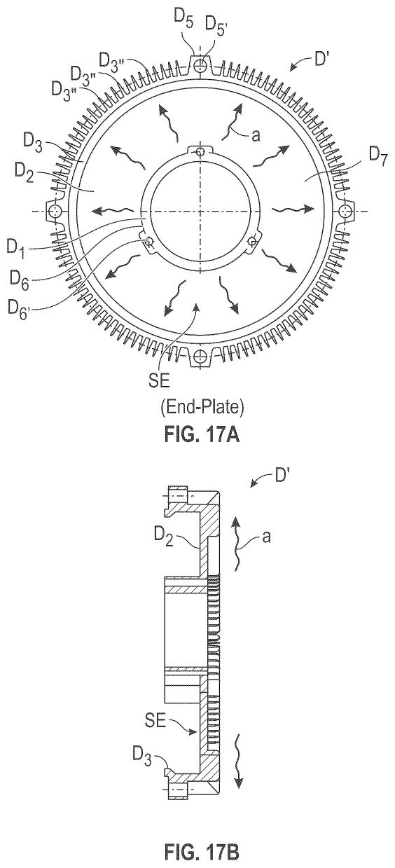

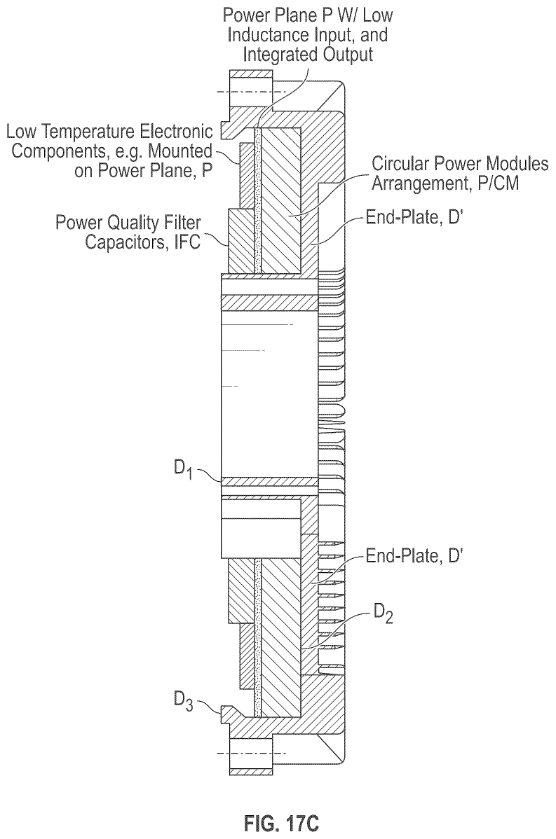

Circular geometry may be implemented that allows for a configuration of power electronic modules and electronics (FIGS. 2A-2B and 17C) that allows the shaft R to pass through to power the cooling fan F.

### End-Plate: Theory of Operation

The design of the end-plate D, D′ incorporates a circular geometry, which consists of forming an electronics housing chamber generally indicated as D₇ on the mid-plate side and heat sink fins D_{2′}, D_{3″} on the fan side of the end-plate D. (As shown in FIG. 4B, the electronics housing chamber D₇ is formed as a hollowed out intermediate portion between the central portion D₁ and the peripheral portion D₃ of the end-plate D, D′.) This design allows electronic components P, EM (FIGS. 2A-2B) to be contained inside the electronics housing chamber D₇ of the end-plate D and provides ample cooling due to the heat sink fins D_{2′}, D_{3″}. The electronics housing chamber D₇ is integrated on one smooth mid-plate side of the end-plate D, D′, where the inner diameter is hollowed as shown in FIG. 4B to allow room for power electronic modules and printed circuit boards to be installed. The heat sink fins D_{2′}, D_{3″} are formed on the fan side of the end-plate D, D′ in a radial arrangement extending from the motor shaft center or central portion D₁, extending outward and across the outer axial surface. The heat sink fins D_{2′}, D_{3″} share the same basic pattern as those built on the bearing supporting plate called the “mid-plate” E, E′. (FIGS. 3A-3B and 13). The end-plate D, D′ also has room in the center to allow the shaft/rotor R to pass through in order to power the cooling fan F (FIG. 12B). The function of the end-plate D, D′ is twofold: to act as a heat sink for the waste heat emitting from the electronics, and a sealed enclosure to allow the electronic components a place to be mounted and protected from harsh environments.

The end-plate D, D′ functions through both conduction and convection. As a person skilled in the art would appreciate, and consistent with that set forth above, conduction is the transfer of heat between solids that are in contact with each other, and convection is the heat transfer between a solid and a fluid. Conduction will occur due to the power modules, e.g. EM, mounted to the inner face of the end-plate D, D′. The electronic printed circuit boards, and components will produce waste heat while in operation. This heat will be absorbed by the end-plate's heat sink characteristic. All heat will then be released by convection through the fins D D_{3″} and cooling fan F. Convection will mainly occur between the heat sink fins D_{2′}, D_{3″} and ambient air.

As a thermal conductor, this design may work best when constructed of metal. This is due to their higher levels of thermal conductivity and ability to absorb heat. Therefore, the end-plate D, D′ will typically be made of a metal like aluminum. By way of example, this material was chosen for its structural rigidity, ability to conduct heat extremely well, and cost effectiveness over other considerations, although the scope is intended to include other types or kind of metals either now known or later developed in the future.

The end-plate D, D′ may be mounted between the mid-plate E, E′ and the cooling fan F, as shown in FIGS. 1-2B and 5A-5D. Thermal contact between the mid-plate E, E′ and the end-plate D, D′ is limited through the thermal insulator G, as shown in FIGS. 2A-2B. This shields the electronics from waste heat coming from the motor and bearing. The end-plate D, D′ as a whole acts as an enclosure for the components and protects them from both harsh environments and excessive heat.

In addition to shielding the electronics from heat, this design is also able to expel that heat into the ambient air and maintain viable operating temperatures. This function is achieved by both the heat sink fins D_{2′}, D_{3″} and the cooling fan F. Since the fins D_{2′}, D_{3″} are spread along the vast surface area of the end-plate D, D′; they have the ability to conduct heat from the power modules, and air chamber to the outside of the end-plate chamber. Once outside the end-plate chamber, the heat is removed by convection. The cooling fan F provides proper airflow over the entire surface of the metal (e.g., aluminum) fins of the end-plate D, D′ and aids in maintaining the temperature of the components below their maximum rating.

Heat sinks act D_{2′}, D_{3″} as cooling mechanisms. They conduct the heat from the object it is in contact with and transfer heat to the air through convection. To function properly, the heat sink fin D_{2′}, D_{3″} has to be hotter than the ambient temperature and the surface area contact should be maximized to ensure efficient thermal transfer. In terms of the end-plate D, D′, it will absorb the heat generated from both the power modules and the air chamber of the variable frequency drive (VFD) and transfer it to the outside ambient air.

Overall, the design of the end-plate D, D′ allows it to serve multiple functions during operation. First, it provides a protective enclosure to contain all of the electronics. Second, it acts as a heat sink to remove heat generated by the losses in the components, thereby protecting the components from excessive temperatures. The unique geometry of the end-plate D, D′ allows these components to be placed in the same envelope as a standard electric motor rated for normally hazardous areas. Lastly, the heat sink fins D_{2′}, D_{3″} and cooling fan F aid in handling heat distribution throughout the end-plate D, D′. With all of these features, the end-plate D, D′ allows the electronics to run smoothly during operation and maintain their temperature below the maximum rating.

### Advantages

Advantages may include the following:

Via external heat sink fins D_{2′}, D_{3″}, the end-plate D, D′ provides a thermally conductive pathway for the power module heat.

Allows for the electronic variable speed drive to be contained within the footprint of a current electric motor M.

Due to the compact size, it allows the power electronics to be installed into hazardous locations containing corrosives or moisture

Allows for the manufacture of an embedded electronic motor drive in power levels greater than currently produced

The power electronics will be housed in the motor end-plate D, D′ and sealed between the mid-plate E, E′.

The end-plate D, D′ design will permit easy removal from motor and easy disconnect of power and communication connections.

The combined end-plate/mid-plate design shall have IP66 protection. All wiring/cable pass through to be sealed, static seals at mid-plate E to motor M, end-plate D, D′ to mid-plate E, E′, end-plate power electronics to be sealed at the outside diameter (OD) and the inside diameter (ID). Dynamic seal at shaft/mid-plate.

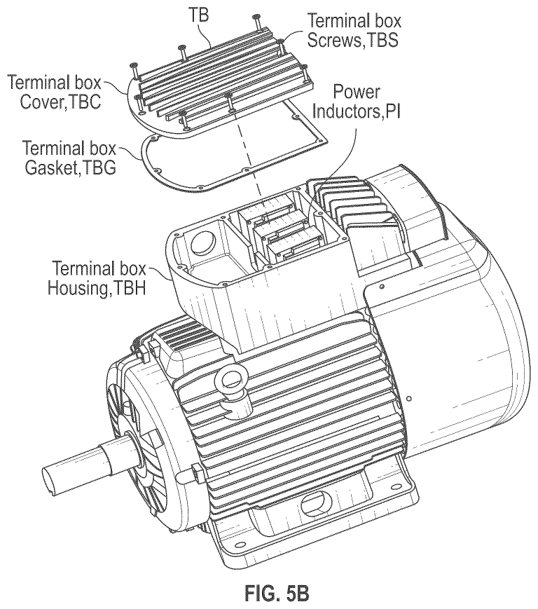

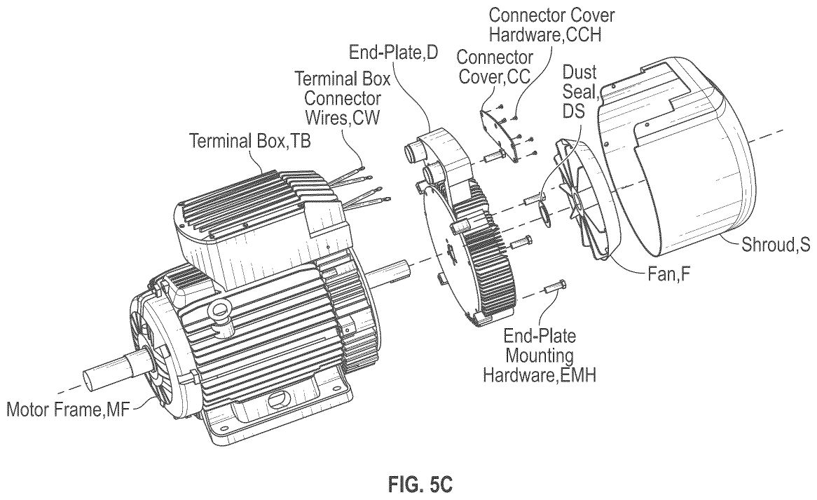

### FIG. 5A to 5D

FIGS. 5A and 5B shows the motor assembly 10 having the main terminal box TB arranged thereon, which provides a sealed junction point for the motor, the motor drive, the drive interface and external power wiring, as well as a terminal box housing having power inductors PI arranged therein, as shown. The main terminal box TB includes a terminal box cover TBC, a terminal box gasket TBG, and terminal box screws for affixing the terminal box cover on the terminal box housing TBH.

FIG. 5C shows the motor assembly in an exploded view, which illustrates the simplicity of the end-plate's (D) electrical and mechanical connection to the motor frame (MF). FIG. 5C also shows that the end-plate (D) is a complete self-contained drive module as shown in 5D, which provides portability to service in a suitable environment or for a quick replacement to a new end-plate(D) drive module, if the old end-plate breaks down, which affords the overall motor assembly design a ‘Plug and Play” style that is unique to the motor assembly art. By way of example, FIG. 5C shows terminal box connector wires CW (e.g., which can be more or less wires than that specifically shown), a connector cover CC, a connector hardware CH, a dust seal DS and end-plate mounting hardware MH.

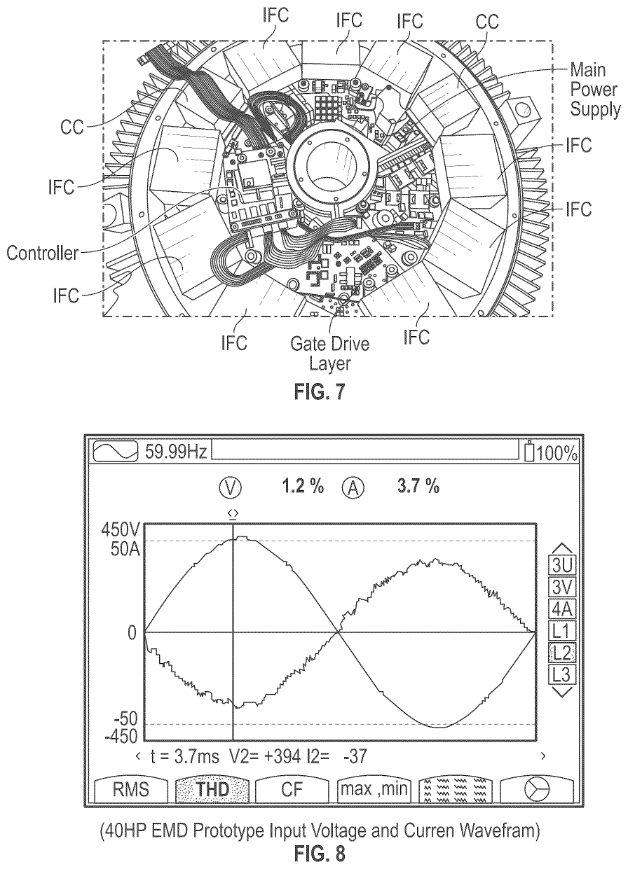

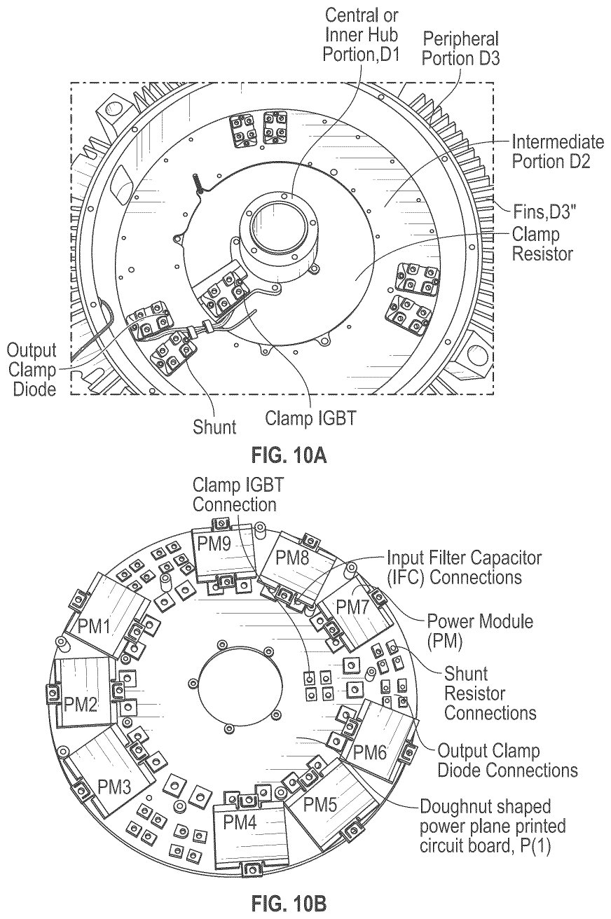

FIG. 5D shows the self-contained drive module assembly, e.g., which includes the end-plate D, the terminal box TB, wire channels WC, the connector cover CC, the connector cover hardware CCH, an electronics module EM (see also FIGS. 7 and 10B), the end-plate cover gasket/insulator GI, the end-plate cover EC and end-plate cover hardware ECH.

In summary, consistent with that shown in FIGS. 5C and 5D, the process for disassembly the end-plate D is as follows:
1) remove the shroud hardware (not shown) and the shroud S (FIGS. 5C),
2) remove fan set screw/hardware (not shown) and the fan F (FIGS. 5C),
3) remove the connector cover hardware CCH and connector cover CC,
4) disconnect the end-plate connector (not shown) from terminal box connector wires CW,
5) remove the end-plate mounting hardware ECH and the self-contained drive end-plate(D) module EM. The self-contained drive end-plate(D) module EM can be replaced and the end-plate D can be reassembled using the same steps.

### FIGS. 6A-10B: The Power Plane P

Some embodiments disclosed herein may consist of a system or apparatus, e.g., having, or in the form of, the power plane P configured for providing power and control functionality, e.g., for operating the motor assembly in order to drive a pump or rotary device. The power plane P features several highly engineered elements, as follows:

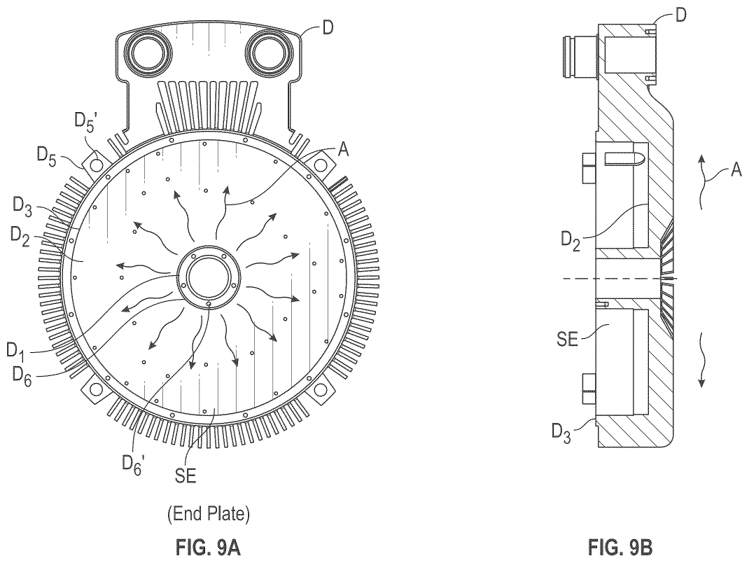

By way of example, the power plane P may have a circular geometry to be mounted inside a space envelope SE (FIGS. 5D and 9B) having a similar circular geometry formed on the end-plate D, D′ (e.g., see FIGS. 1, 4A-4B, 9A-9B, 11, 14A-14B) between the inner hub portion D₁ and the peripheral portion D₃ that extends circumferentially around the space envelope SE (aka the electronics housing chamber D₇ (see FIGS. 4B, 5D and 14B)) of the end-plate D, D′. The power plane P may be a multi-layer circuit board or assembly, e.g., having: a power layer, a control layer and a thermal barrier and printed circuit board layer P(1). The power layer includes higher temperature power modules like circular power modules P/CM (e.g., see FIG. 17C) for providing power to the motor M, e.g., of the pump or rotary device. The control layer includes lower temperature control electronics modules like power quality filter capacitors IFC (e.g., see FIG. 17C) for controlling the power provided to the motor M. The thermal barrier and printed circuit board layer P(1) in FIG. 10B in configured between the power layer and the control layer and provides electrical connection paths between the power modules of the power plane and the control electronics modules of the control layer, and also provides thermal insulation between the power layer and the control layer.

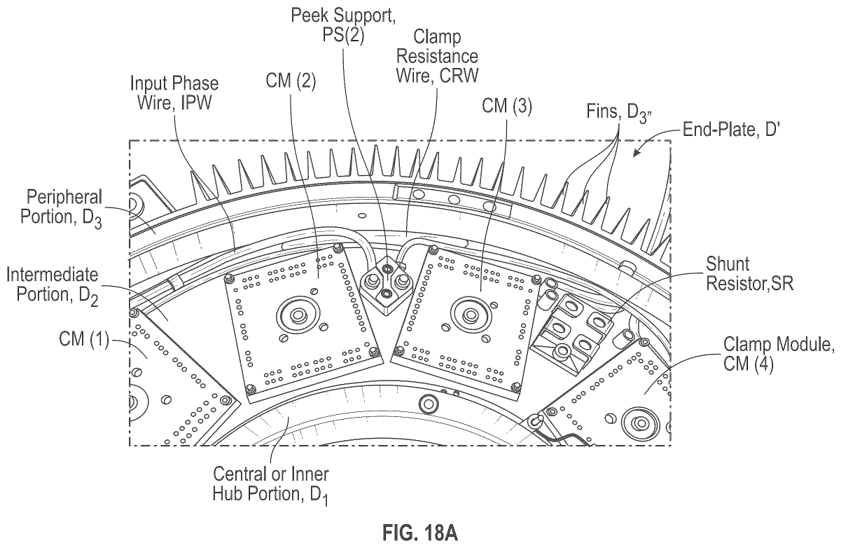

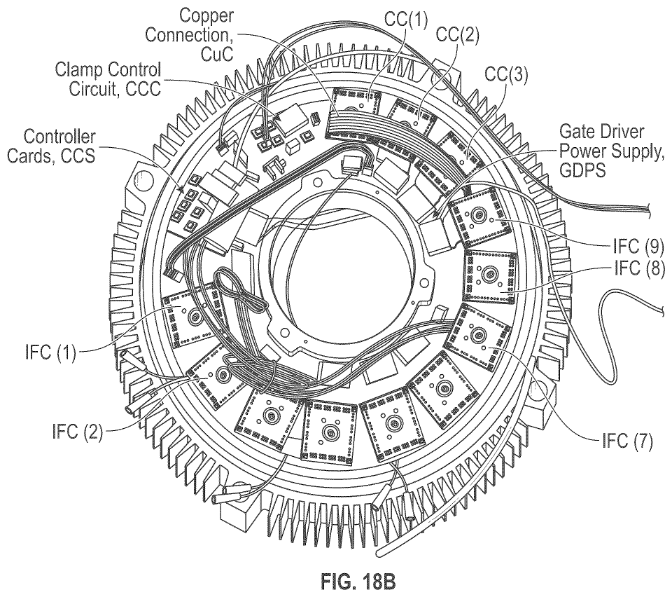

By way of example, the power plane P may be configured to do at least the following:
1) allow the mounting of the power modules like elements P/CM (e.g., see FIGS. 10B and 17C) and the control electronics modules like elements IFC (e.g., see FIGS. 10B and 17C) on opposite sides of the thermal barrier, e.g., such as element P(1) shown in FIG. 10B;
2) provide the electrical connection paths (e.g., see connections C₁, C₂, C₃ and gate driver or layer connections GDC in FIGS. 7 and 18B) for interconnecting together the power modules like element P/CM and the control electronics modules like element IFC, as well as for interconnecting input/output power connections (see FIG. 18A re PEEK supports PS(2), re the input phase connection, and re the input phase wire with connection) and the power modules like element P/CM (e.g., see FIG. 17C) and the control electronics modules like element IFC (e.g., see FIG. 17C), and
3) insulate and/or direct heat emitted from one or more of the power modules like element P/CM (e.g., see FIG. 17C), the control electronics modules like element IFC (e.g., see FIG. 17C) and a shaft or rotor R of the motor M to the outer diameter of the power plane where there is a higher air flow, e.g., consistent with that shown in FIGS. 9A and 9B.

The power plane P may be configured as a doughnut shaped power plane printed circuit board or assembly like element P(1) in FIG. 10B in order to fit in the space envelope SE of the end-plate D, D′ for providing a maximum space for mounting the power layer and the control layer, and to allow the shaft or rotor R to pass through to power the cooling fan F (see FIGS. 1 and 11).

The power layer may be configured with an arrangement of higher temperature power modules, e.g., like elements P/CM (FIG. 17C). The control layer may be configured with an arrangement of lower temperature control electronic components and power quality filter components, e.g., like elements IFC (FIGS. 7 and 17C). The thermal barrier and printed circuit board layer P(1) may be configured from a material having a structural thickness and strength to mount the control layer on one side and the power layer on an opposite side. The fiberglass material configured to provide insulation to reduce the transfer of heat between the power layer and the control layer.

It is understood that the power layer and the control layer may include other modules or components within the spirit of the present disclosure, e.g., consistent with that disclosed herein, including one or more control cards, clamp capacitors, a gate driver power supply, etc., e.g., as shown in FIGS. 10B and 18B.

### Theory of Operation

In effect, the power plane P (see also FIGS. 1 and 11) is a component that will be mounted inside the space envelope SE (e.g., see FIG. 17B) of the end-plate D, D′ (FIGS. 1 and 17B). It shares the same circular geometry, which will allow the shaft or rotor R to pass through to power the cooling fan F (FIGS. 1 and 11). By way of example, the circular geometry may take the form of, or be characterized as, doughnut-shaped, or disk-like, e.g., consistent with that disclosed herein. This will also allow ease of manufacture and installation of its components. The power plane P consists of several elements, e.g., which are shown and described in relation to

FIGS. 6A-10B . The elements may include matrix converter power modules, matrix converter control electronics, power quality filter capacitors, and a printed circuit board, e.g., consistent with that disclosed herein. The function of the power plane P is threefold:
(1) provide a novel geometry allowing the mounting of power modules and control electronic components,
(2) provide an electric connection path for all modules and components, including power modules and control electronic components, mounted thereon, and
(3) insulate/direct heat emitted from all the electronic power modules, control electronics and motor shaft R (FIGS. 1 and 11).

The matrix converter is the main system configured on the power plane P, e.g., that is represented as shown in FIGS. 6A-6B , which includes FIG. 6A showing a diagram of a bi-directional switch, e.g., using IGBT technology for implementing the desired power functionality (FIG. 6A), and also includes FIG. 6B which shows an example of a bi-directional switch power module for implementing the desired power functionality. (As a person skilled in the art would appreciate, an insulated-gate bipolar transistor (IGBT) is a three-terminal power semiconductor device primarily used as an electronic switch which, as it was developed, came to combine high efficiency and fast switching. For example, Infineon Technologies AG distributed various products using such IGBT technology.) The purpose of having this circuit shown in FIG. 6A is to allow the matrix converter to convert an AC input of fixed voltage and frequency to a desired AC output waveform. Traditionally, in the prior art input AC power would have to be converted to a DC waveform before being synthesized into an AC output. According to some embodiments, the matrix converter may be configured to execute this process in fewer steps and with fewer components. Among the electronic modules, the power quality filter IFC may be configured as a prominent component (see FIG. 7). In such a case, its function is to reduce the level of electrical noise and harmonic distortions, e.g., consistent with that shown in FIG. 8. In some embodiments, this power quality filter component may be preferably attached directly onto the printed circuit board, such as element P(1) to be as close to the matrix converter as possible. This greatly improves its ability to reduce the amount of distortions emitted from the matrix converter electronics. The overall geometry and size of the power plane P allows for ease of manufacture and installation for power modules and control electronics.

In this power plane portion of the overall motor assembly shown in FIGS. 1 and 11, heat will be emitted from at least two sources: the power semi-conductor modules and the shaft or rotor R (FIGS. 1 and 11). Consistent with that set forth herein, the power semiconductor modules may include one or more of the following: the circular power modules arrangement shown in FIG. 17C or the power modules layout shown in FIG. 18A, power modules and clamp module layout in FIG. 10B or the layout of the power/clamping modules in FIG. 10B. Although the mid-plate E, E′ (e.g., see FIGS. 1, 2A, 2B and 3A-3B; 11, 12A, 12B, 13A(1)-13B) may be configured with an insulation layer protecting the electronics, as described above, there will likely still be residual heat from the shaft or rotor R. This is due to the temperature difference between the fan side and the mid-plate portion of the motor assembly (FIGS. 1 and 11). It is also understood that semi-conductors in the power plane P will naturally generate heat during operation. The challenge is maintaining an operating temperature in order for the electronics to operate properly, e.g., below the failure point of the electronics.

Therefore, insulation and dissipation of heat are two functions that the power plane P must perform. The former regarding insulation is achieved through the multi-layered circuit board implementation disclosed herein. The multi-layered circuit board may be constructed of laminated material such as fiberglass, by way of example, which increases its thickness and strength. Fiberglass is known and understood to be a strong and light-weight material which has been used for insulation applications. This allows the power plane P to act as a thermal barrier between hotter power modules, the power quality capacitors and control electronics.

For the latter, heat will be dissipated through the heat sink fins D_{2′} and/or D_{3″} (FIGS. 4A-4B and 14) located on the end-plate D, D′. The heat sink fins D_{2′} and/or D_{3″} will be air cooled and act as cooling mechanisms. They operate through conduction and convection, two forms of heat transfer, where conduction is understood to be the transfer of heat between solids that are in contact with each other, while convection is understood to be the transfer of heat between a solid and a fluid. Heat transfer will first occur between the printed circuit board and the semi-conductors. It will then travel into the end-plate D, D′ and heat sink fins D_{2′} and/or D_{3″}. Lastly, convection occurs between the heat fins D_{3″} and the ambient air, e.g., surrounding the overall motor assembly 10 (FIG. 1) dispersing the heat. To function properly, the fins D_{3″} have to be cooler to absorb heat and be elevated to a hot enough temperature to diffuse it into ambient air. Since the power plane P also shares a similar geometry with the intermediate portion D₂ of the end-plate D, the heat will be distributed uniformly along the surface.

The overall configuration of this multi-purpose power plane P makes it an important contribution to the state of the art. The space envelope SE (FIGS. 4B, 5D, 17B) from the end-plate D, D′ allocates room for the overall power plane P and allows it to support both power modules and control electronics. In addition, the power plane P has access to the heat sink fins D_{2′} and/or D_{3″} from the end-plate D; enabling it to cool the electronics at an operable temperature. The fiberglass circuit board construction of layer or element P(1) acts as an excellent insulator; separating hotter power semi-conductors from the sensitive control electronics and power quality capacitors. These combined components allow the power plane P to facilitate operating conditions and maintain the temperature of the control electronics well below maximum temperature levels.

### Advantages

Advantages of this power plane embodiment may include one or more of the following:

The printed circuit board layer P(1) may be configured to act as a thermal barrier between hotter power modules to the cooler control electronics and power quality capacitors area.

The overall power plane implementation may be configured so as to direct heat to outer diameter where there is a higher air flow and away from control circuits, e.g., as best represented by that shown in FIGS. 9A-9B .

The overall printed circuit board assembly provides a low inductance and resistance input between the power quality capacitors and the power semiconductor modules, thereby reducing switching stress and electromagnetic interference, e.g., consistent with that shown in the graph in FIG. 8.

The overall power plane implementation may be configured with a unique compact power quality filter arrangement that is integrated into the power plane P.

The overall power plane implementation may be configured with a built-in power quality filter that produces minimal harmonic distortion, and protects the variable frequency electronics from most power quality abnormalities.

The overall power plane implementation may be configured with or as a unique doughnut shaped power plane printed circuit board (PCB), e.g., shaped like element P(1), to fit in the space envelope SE of motor end-plate D providing for maximum space utilization, and simplifying construction and manufacturing. (By way of example, see that shown FIGS. 1 and 11, as well as that shown in FIGS. 7, 16 and 18B)

The doughnut shape allows the motor shaft or rotor R (FIGS. 1 and 11) to pass through to power the cooling fan F.

The overall power plane implementation combines both power and control modules, circuits or components into one integrated printed circuit board assembly, e.g., as shown in FIG. 18B, for ease of assembly and compactness in size.

The overall power plane implementation provides interconnections for input/output power, current sensors, gate driver GDPS, clamp control circuit CCCs, power/clamp semi-conductor modules, power quality capacitors IFC, e.g. with limited wiring and connectors required, thus allowing for a robust and reliable operation.

The overall power plane implementation allows for the manufacture of an embedded electronic motor drive in power levels greater than that currently produced in the marketplace and in the space envelope of an electric motor.

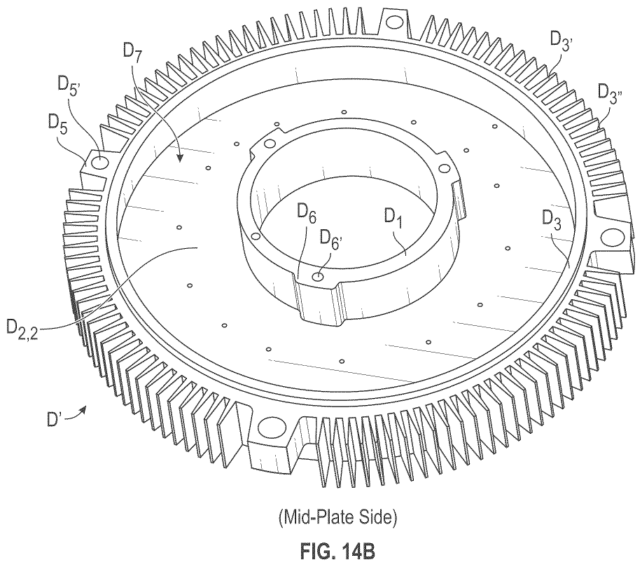

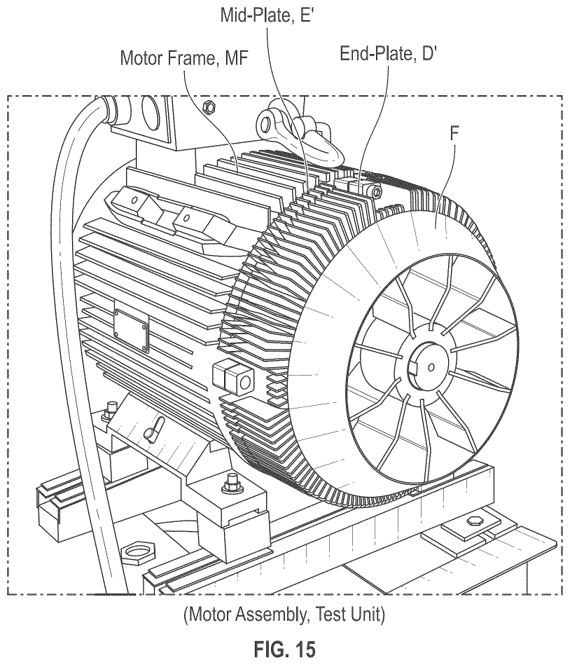

The motor frame or casing MF (FIGS. 5A and 15) is effectively utilized as a heat sink to allow compact size and thermally optimized operation of the power plane P and matrix converter configuration.

### Alternate Embodiment of the Motor Assembly

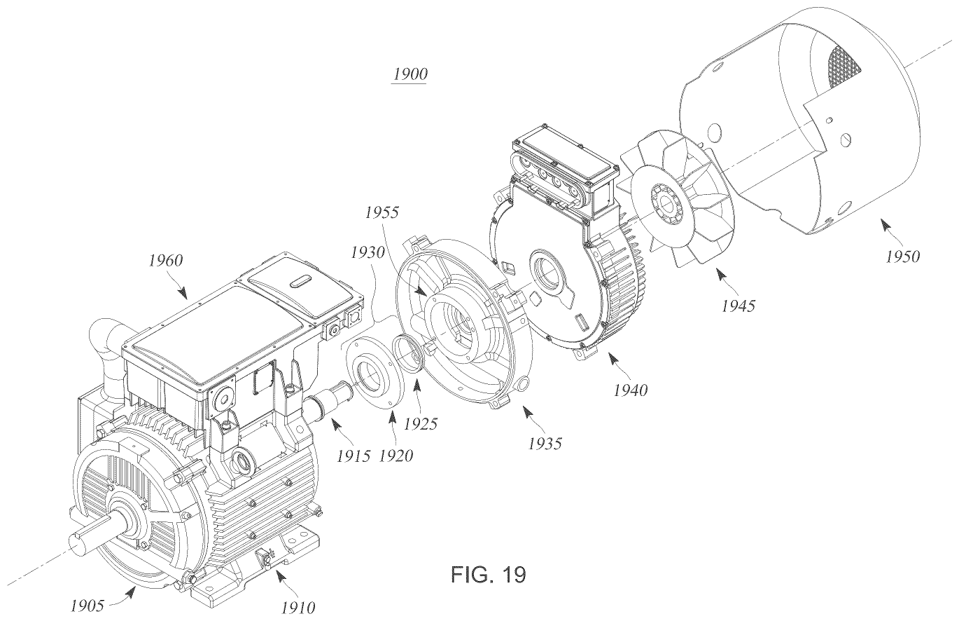

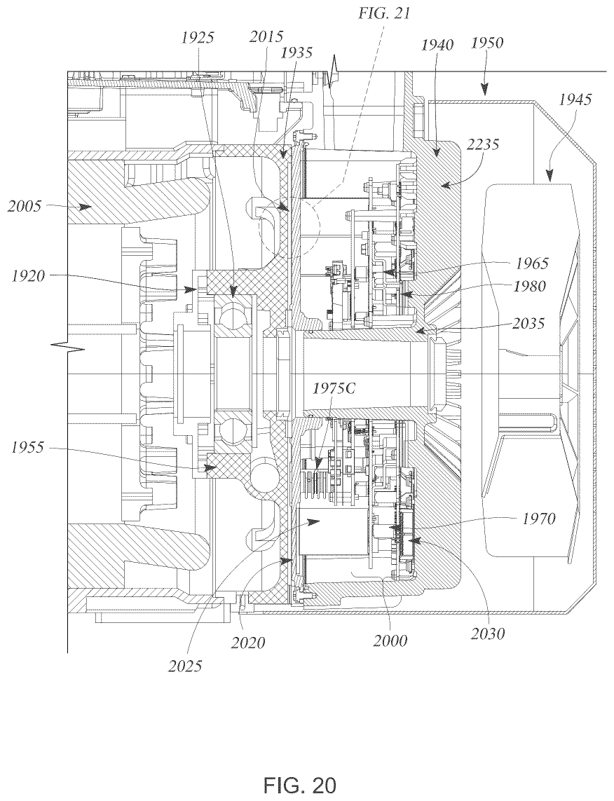

FIG. 19 is an exploded view of one embodiment of a motor assembly 1900 for driving a pump or rotary device. Similarly, to motor assembly 10 and 10′, the motor assembly 1900 may be used for driving a pump, compressor, fan, and/or rotary device (not shown). In some embodiments, the motor assembly 1900 includes a motor 1905. The motor 1905 may include a motor frame 1910 with a space envelope (e.g., cavity) that at least partially envelops a stator 2005 (see FIG. 20) and a rotor 1915. The rotor 1915 may couple to a mid-plate 1935, an end-plate 1940, and/or a fan 1945. In some embodiments, the mid-plate 1935 and the end-plate 1940 may be axially mounted to the motor frame 1910 in an in-line configuration, extending from the non-drive end side of the motor frame 1910. In some embodiments, the fan 1945 is powered by the motor 1905 (e.g., as in the illustrated embodiment via the rotor 1915).

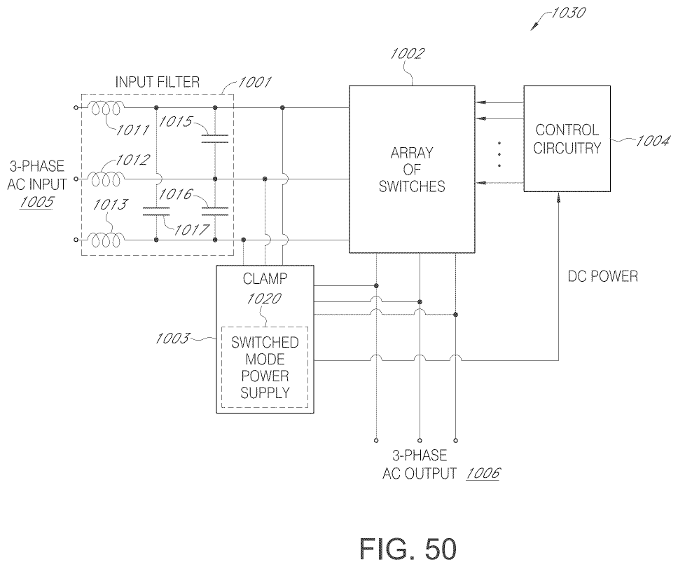

In some embodiments, the mid-plate 1935 may have a bearing housing flange portion 1955. In some embodiments, the motor 1905 includes a motor bearing assembly 1930 that includes a bearing assembly 1925, a front grease retainer 1920, and/or a rear grease retainer (not shown). The end-plate 1940 may include a multi-board power plane 2000 (see FIG. 20). in other embodiments, the end-plate 1940 may include a power plane P of any of the embodiments described herein (see FIGS. 2A, 2B, 11, 12A, 12B). The motor assembly 1900 may also, or alternatively, include a shroud 1950 and a terminal box 1960. In some embodiments, the terminal box 1960 is attached to the top of the motor frame 1910 and may include electronics, e.g., including a variable frequency drive, capacitors, inductors, and/or power modules. The terminal box 1960 will be described in more detail below. In some embodiments, the electronic components of the variable frequency drive (VFD) and/or matrix converter may be split between the terminal box 1960 and the end-plate 1940. As one example, the matrix converter can include some or all of the components of the matrix converter 1030 of FIG. 50, where the inductors 1011, 1012, 1013 are included in the terminal box 1960, and some or all of the remaining components of the matrix converter 1030, such as the array of switches 1002 and or capacitors 1015, 1016, 1017, are included in the end plate 1940. As described herein, the electronic components of the variable frequency drive may include one or more circuit boards, power modules, and power control components.

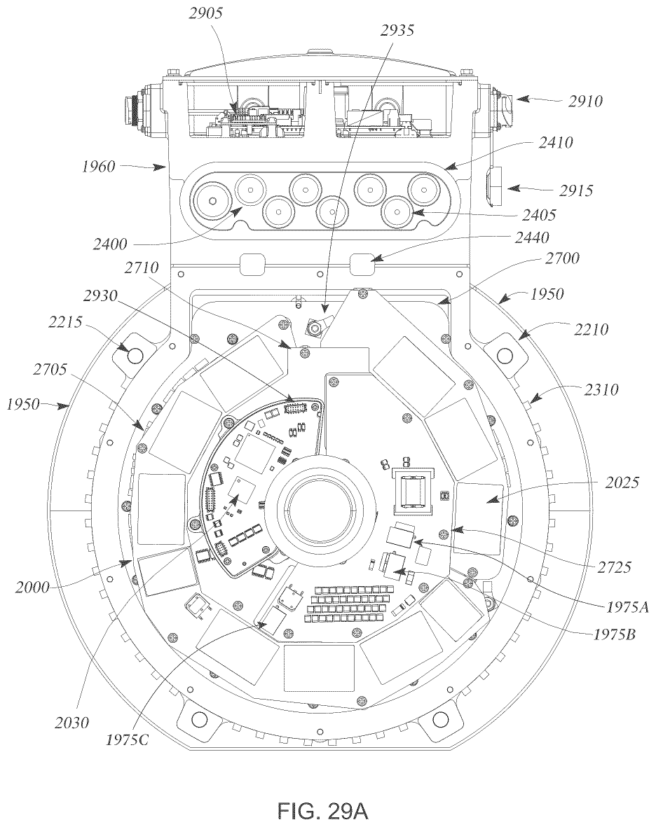

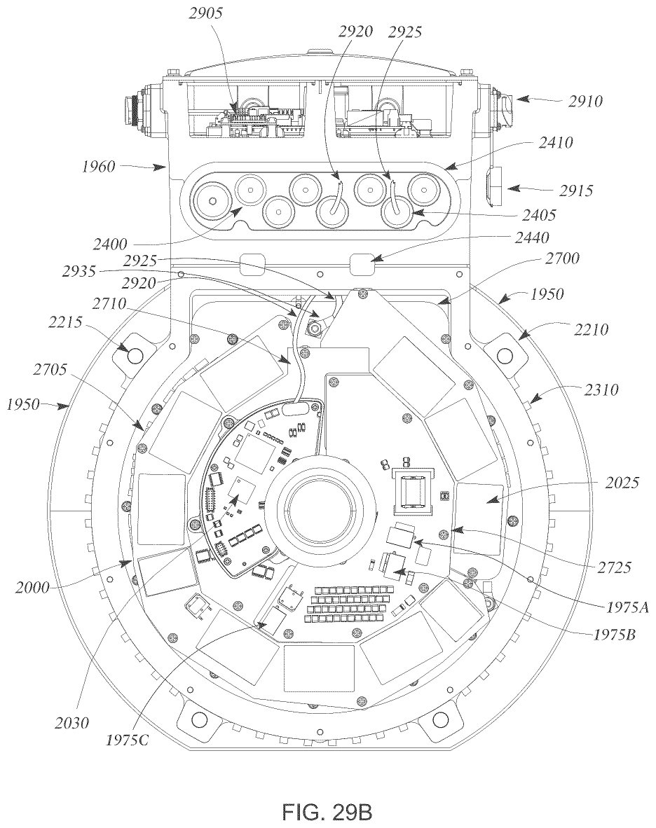

FIG. 20 is a cross-sectional view of part of the motor assembly 1900 of FIG. 19. As described above, the end-plate 1940 may have a multi-board power plane 2000. For example, the multi-board power plane 2000 may include two, three, four, five, six, or more than six separate printed circuit boards. In some embodiments, the multi-board power plane 2000 may have one or more power layers or segments and one or more control layers or segments. Alternatively, or in addition, the multi-board power plane 2000 may include the electronics of a variable frequency drive and/or a matrix converter (e.g., one or more power modules and power control components). For example, one or more of the PCB boards of the multi-board power plane 2000 may include high temperature components 2030 (e.g., power semi-conductors, power modules, etc.) while one or more other PCBs include low temperature (e.g., temperature sensitive) components 2025 (e.g., control electronics, power quality filter capacitors, etc.). One or more of the low temperature components 2025 may be coupled to a heat sink 1975A, 1975B, 1975C (see FIG. 29A) to advantageously cool the low temperature components 2025. The heat sinks 1975A, 1975B, 1975C may have cooling fins to improve heat dissipation.

In some embodiments, the multi-board power plane 2000 may include a communication board. The communication board may facilitate communication between the power layers and the control layers. However, in some embodiments, the power layers and control layers communicate to each other without using a separate communication board. For example, the power layers and control layers may be connected to each other through data connectors 1970, which can be PCB-to-PCB connectors, for example, allowing components on the different layers to communicate with one another. Similarly, the power layers and control layers may be connected to a power distribution system via one or more busbars 1965, 1980. In some embodiments, the busbar 1965 may be a double-L bar made of a conductive material (e.g., copper, gold). Additionally, or alternatively, the multi-board power plane 2000 may include a busbar 1980 that is toroidal-shaped or cylindrical-shaped that encircles the central column 2035 of the end-plate 1940. It should be noted that the multi-board power plane 2000 may include one or more busbars of any other shape to connect the PCB boards and electrical components to one or more power distribution systems.

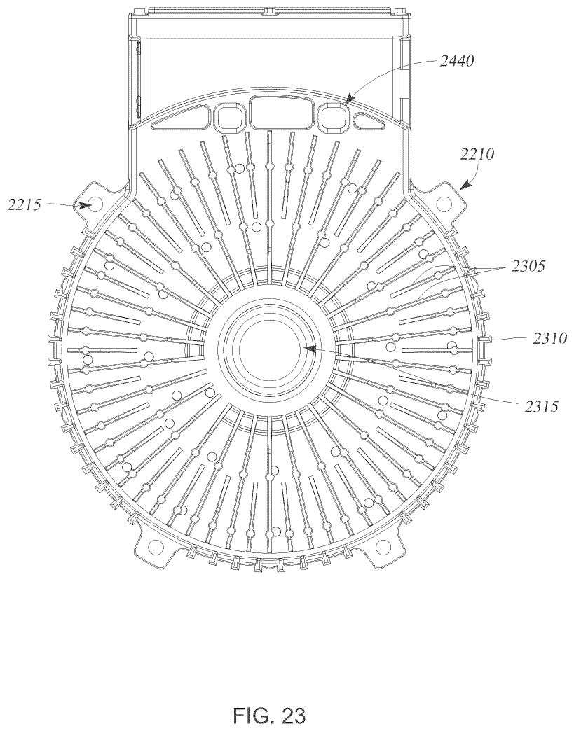

As described above, the first side of the end-plate 1940 may be coupled to the second side of the mid-plate 1935. The first side of the end-plate 1940 may have a thermally conductive cover 2020. In some embodiments, some or all of the low temperature components 2025 (e.g., some of the electronic components of the variable frequency drive) are in physical contact with the conductive cover 2020. Thus, the end-plate 1940 may advantageously have a thermal pathway for dissipating the heat from, e.g., the low temperature components 2025 to the conductive cover 2020 (e.g., the conductive cover 2020 acts as a heat sink). The conductive cover 2020 may be made of any thermally conductive material (e.g., copper, gold), including any materials described herein. Furthermore, the high temperature components 2030 may be in physical contact with the end-plate housing 2235. Thus, the end-plate 1940 may advantageously have a thermal pathway for dissipating the heat from the high temperature components 2030 to the end-plate housing 2235 and further to the radial cooling fins 2305 and peripheral cooling fins 2310 (FIG. 23). The end-plate housing 2235 may be made of any thermally conductive material (e.g., metal, such as aluminum, steel, etc.), including any materials described herein. Thus, the end-plate 1940 may efficiently dissipate the heat caused by the operation of the motor 1905 and the multi-board power plane 2000 away from the electronic components and to the external environment.

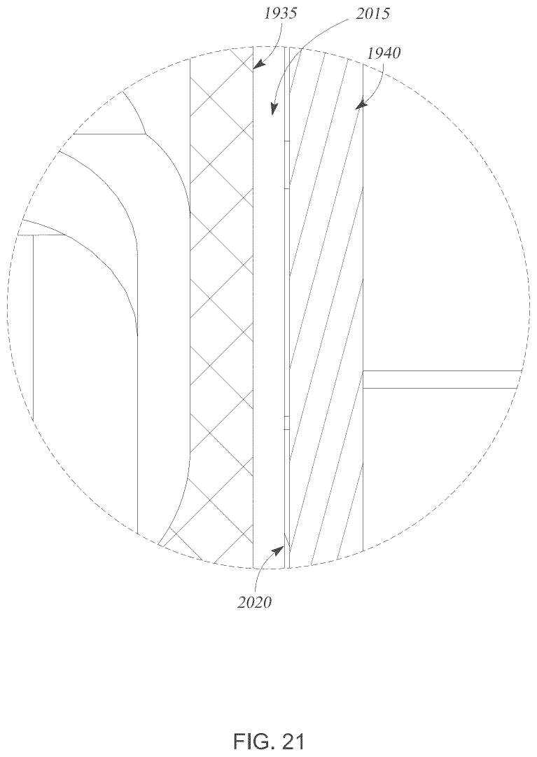

Furthermore, referring to FIG. 19 again, the motor assembly 1900 may include a thermal insulation gap 2015 between the end-plate 1940 and the mid-plate 1935. FIG. 21 is a close-up view of one embodiment of the thermal insulation gap 2015 of the motor assembly 1900 of FIG. 19. The thermal insulation gap 2015 may be an insulative air gap. Advantageously, the insulative air gap 2015 may be relatively narrow enough to allows the motor assembly 1900 to be compact, while wide enough to allow heat to escape and reduce heat transfer between the mid-plate 1935 and the end plate 1940. For example, the insulative air gap may have a thickness of 1 mm, 2, mm, 3.5 mm, 5 mm, 10 mm, more than 10 mm, or any thickness in-between. Alternatively, in higher temperature applications, the insulative air gap 2015 may be 1 cm, 2 cm, 5 cm, 10 cm, more than 10 cm, or any thickness in-between. The insulative air gap 2015 may inhibit (e.g., prevent or limit) the heat emitted from the motor 1905 from reaching the electrical components in the end-plate 1940. In some embodiments, the insulative air gap 2015 may be connected to the external environment (e.g., through a vent or gap at mid-plate/end-plate coupling point) and allow at least some portion of the heat generated by the motor 1905 and low temperature components 2025 to be transferred to the external environment. Thus, the insulative air gap 2015 may advantageously protect the electronic components in the end-plate 1940 from the heat of the motor 1905 while simultaneously enabling the motor 1905 and the conductive cover 2020 to dissipate heat. Alternatively, or in addition, the thermal insulation gap 2015 may be a layer of any non-conductive material.

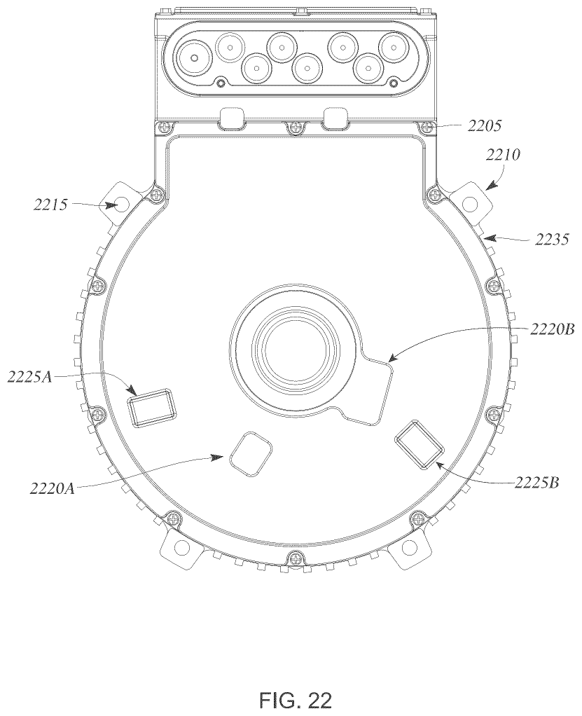

FIG. 22 is a front view (mid-plate 1935 side) of the end-plate 1940 of the motor assembly 1900 of FIG. 19. The conductive cover 2020 may be coupled to the end-plate housing 2235 via one or more fasteners 2205 (e.g., screws, snap-fit connectors, etc.). Alternatively, or in addition, the end-plate 1940 may have one or more retaining members 2210 (e.g., four) that include an aperture 2215 for receiving a fastener (e.g., a dowel, screw or threaded bolt, snap-fit connector, etc.) to fasten the end-plate 1940 to the mid-plate 1935. The retaining members 2210 may be mounting guides that advantageously help a user assemble the motor assembly 1900. For example, a user may slide one or more dowels or bolts into the apertures 2215 and easily push the end-plate 1940 into place (e.g., in-between the mid-plate 1935 and fan 1945). In some embodiments, the dowels may be tapered to make it easier to insert the dowels into the aperture 2215. Furthermore, the retaining members 2210 may axially protrude beyond the conductive cover 2020 to leave space for or set the thickness of the thermal insulation gap 2015 between the end-plate 1940 and mid-plate 1935. However, in some embodiments, the retaining members 2210 may be co-planar with the conductive cover 2020.

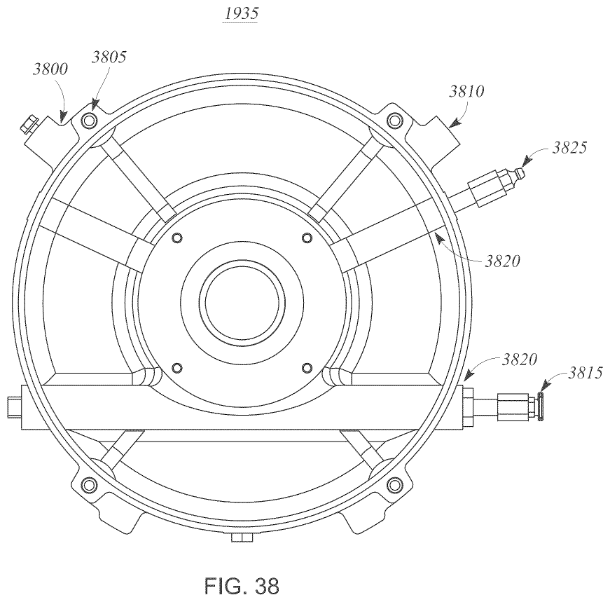

In some alternative embodiments, the apertures 2215 of the retaining member 2210 receive dowels or bolts that are attached to the motor frame 1910 (e.g., instead of the mid-plate 1935). Similarly, the mid-plate 1935 may have apertures 3805 (see FIG. 38) that receive dowels or bolts that are attached to the motor frame 1910, to secure the mid-plate 1935 to the motor frame 1910. For example, the mid-plate 1935 and end-plate 1940 may either (1) receive the same bolts from the motor frame 1910 (e.g., same bolt extends from motor frame 1910 through aligned apertures in the mid-plate 1935 and end-plate 1940) or (2) have different dowels or bolts (e.g., one set for the mid-plate 1935 and a second set for the end-plate 1940). Thus, the retaining members 2210 may advantageously help a user align and easily couple the end-plate 1940 to motor frame 1910 with the mid-plate 1935 in-between.

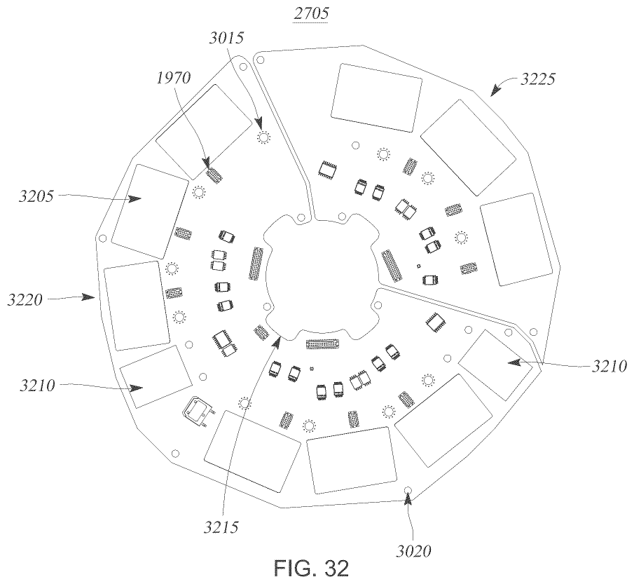

The conductive cover 2020 may have one or more protruded sections 2220A, 2200B, and/or receded sections 2225A, 2225B. Each of the protruded sections 2220A, 2200B and receded sections 2225A, 2225B may advantageously correspond to one or more electronic components. For instance, if an electronic component mounted within the end-plate 1940 is shorter than the space provided between the PCB board to which the electronic component is mounted and the main surface of the conductive cover 2020, the conductive cover 2020 may have a receded section 2225A, 2225B extending towards the electronic component (e.g., a power quality filter component), bringing the electronic component into physical contact with the conductive cover 2020. For example, in the illustrated embodiment, the two clamp capacitors 3210 (see FIG. 32) are shorter than other electronic components mounted to the PCB board 2705 (see FIG. 32) and the main surface of the conductive cover 2020 (e.g., shorter than the power quality capacitors 3205). To compensate for the disparity in length, the one or more clamp capacitors 3210 are each mounted to the PCB board 2705 on a first end of the respective clamp capacitor 3210 and contact a corresponding receded section 2225A or 2225B of the conductive cover 20020 on a second end of the respective clamp capacitor 3210. Thus, the one or more clamp capacitors 3210 may effectively dissipate heat via the conductive cover 2020 while being mounted next to longer electronic components.

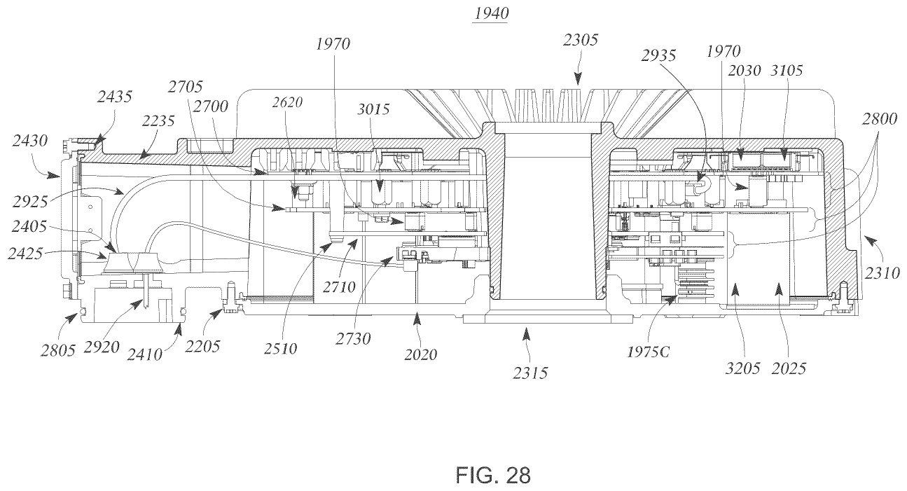

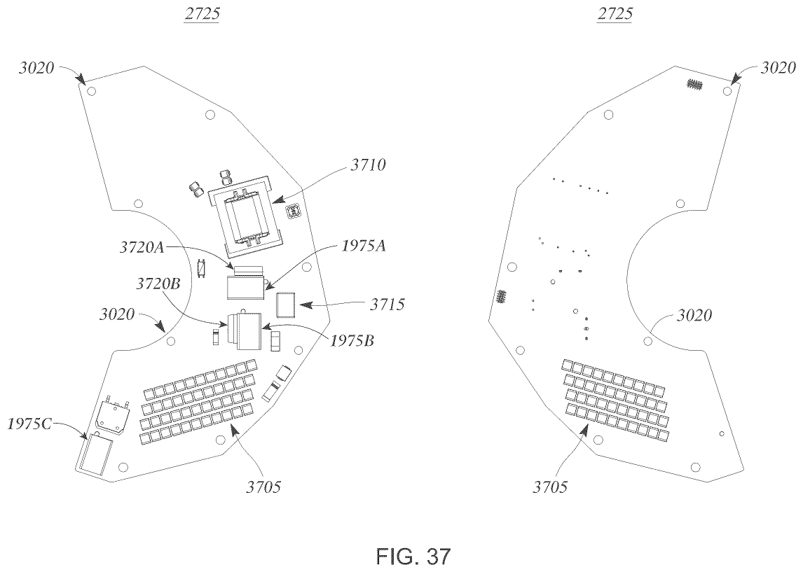

In some embodiments, if the electronic component is taller than the space provided between the PCB board to which the electronic component is mounted and the main surface of the conductive cover 2020, the conductive cover 2020 may have protruded sections 2220A, 2220B to accommodate the taller electronic component. For example, in the illustrated embodiment, one or more heat sinks 1975A, 1975B, 1975C may be longer than other electronic components mounted to the PCB board 2725 (see FIG. 28 and FIG. 37) and the main surface of the conductive cover 2020. To compensate for the disparity in length, the heat sinks 1975A, 1975B, 1975C are mounted to the PCB board 2725 on a first end of each respective heat sink 1975A, 1975B, 1975C and contact a corresponding protruded section 2220A (heat sinks 1975A, 1975B) or 2220B (heat sinks 1975A, 1975B) of the conductive cover 2020 on a second end of the respective heat sink 1975A, 1975B, 1975C. Thus, the heat sinks 1975A, 1975B, 1975C may effectively dissipate heat via the conductive cover 2020 while being mounted next to shorter electronic components.

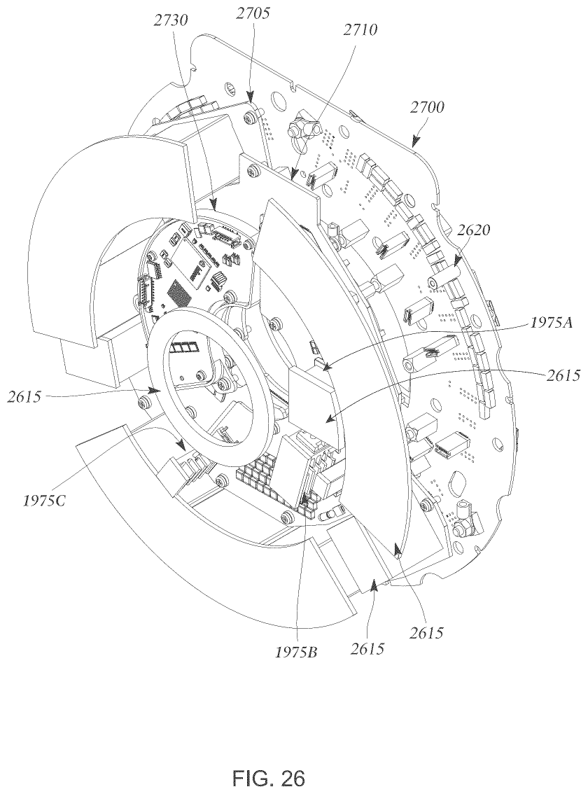

Thus, electronic components of different dimensions may be used without disrupting the thermal pathways for dissipating heat (e.g., from the low temperature components 2025 to the conductive cover 2020 to the thermal insulation gap 2015/external environment). Similarly, the heat sinks 1975A, 1975B, 1975C (see, e.g., FIGS. 20 and 26) may be in physical contact (e.g., be thermally coupled) to the conductive cover 2020. Additionally, the physical contact between the electronic components and the conductive cover 2020 may provide additional mechanical support for the electronic components to secure them in place. For example, the physical contact may prevent the electronic components from disconnecting or flexing due to the vibrations cause by the motor 1905.

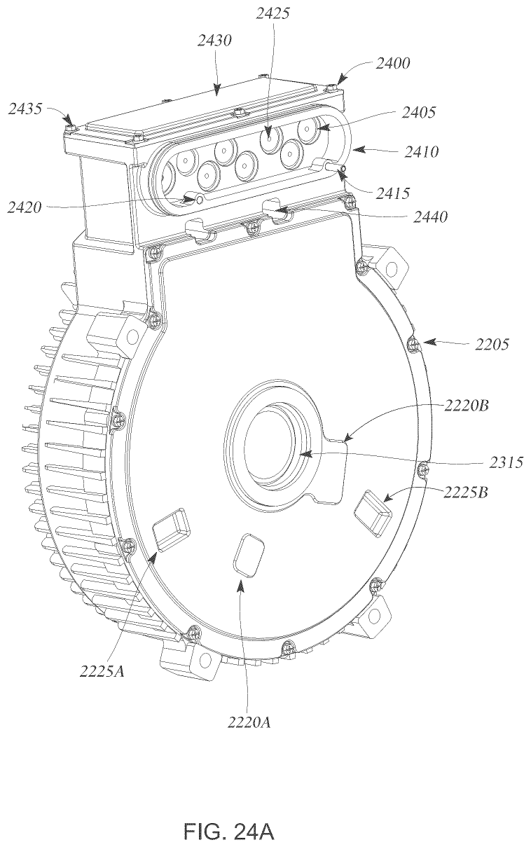

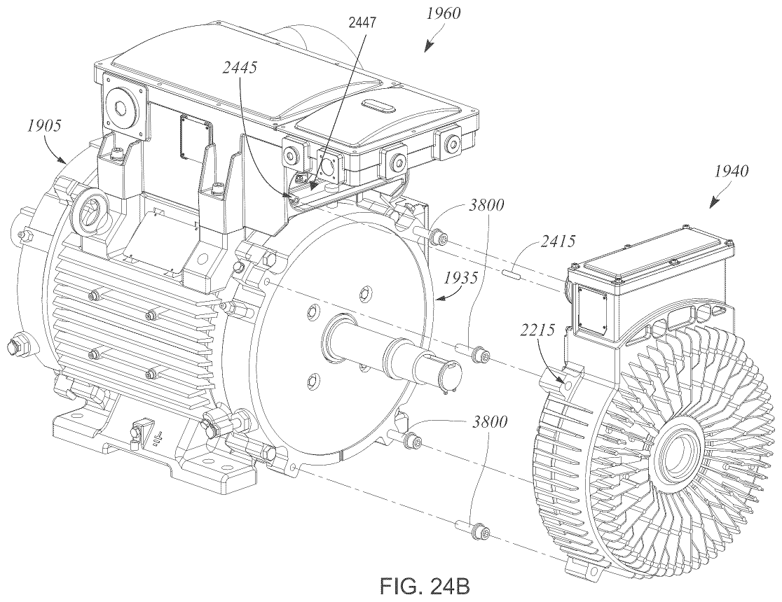

FIG. 23 and FIG. 24A are a back view and a front perspective view, respectively, of the end-plate 1940 of the motor assembly 1900 of FIG. 19. As described above, the end-plate 1940 may have an opening 2315, radial cooling fins 2305 on the back side or surface of the end-plate 1940, and peripheral cooling fins 2310 on the side of the end-plate 1940. In some embodiments, the end-plate 1940 may have a wiring terminal 2400 that may couple to the terminal box 1960. The wiring terminal 2400 may have one or more terminal points 2405. For example, the wiring terminal 2400 may have one, two, four, eight, ten, twenty, or more than twenty terminal points 2405, or any number in-between. In some embodiments, the openings of terminal points 2405 may include self-sealing grommets 2425. The self-sealing grommets 2425 may advantageously prevent moisture, dust, grease, and/or excess heat from entering the wiring terminal 2400.

In some embodiments, the wiring terminal 2400 has a top cover 2430. The top cover 2430 may include a gasket and may be attached to the wiring terminal 2400 by one or more fasteners 2435 (e.g., screws, magnets, snap-fit, etc.). Removing the top cover 2430 allows a user to quickly install and repair any connections inside the wiring terminal 2400. In some embodiments, the wiring terminal 2400 is water-proof and dust-proof when the top cover 2430 is attached. For example, the end-plate 1940 and wiring terminal 2400 may have a high ingress protection rating (e.g., IP 66) and not allow any dust and/or water to enter. Alternatively, the end-plate 1940 and wiring terminal 2400 may have a lower IP rating (e.g., IP 55) when the motor assembly 1900 is being installed in less harsh environments.

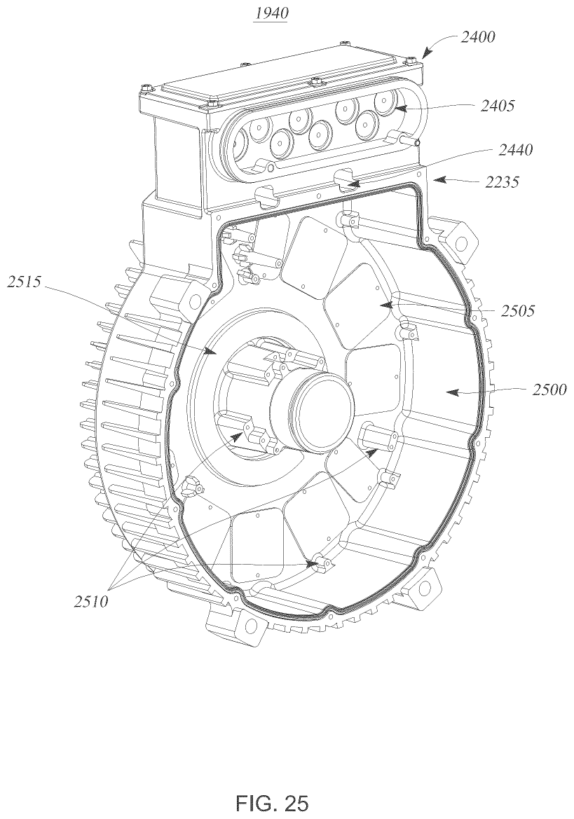

The wiring terminal 2400 may have one or more retaining members 2420 comprising an aperture. The retaining members 2420 can receive dowels or other elongate guide members 2415 which can couple to corresponding aperture of the terminal box 1960. In the embodiment illustrated in FIGS. 24A-25, the guide member 2415 is a dowel 2415 configured to couple to an aperture in the terminal box 1960, and to guide alignment of the end-plate 1940 with the mid-plate 1935 and motor housing 1910. While FIG. 24A only shows the rightmost retaining member 2420 including a dowel 2415, the other retaining member 2420 can also include a dowel (as shown in FIG. 19).

FIG. 24B is an exploded perspective view of the motor 1905, terminal box 1960, mid-plate 1935, and end-plate 1940. As described in more detail below, the mid-plate 1935 may be attached to the motor 1905 via retaining members 3800. During installation of the end-plate 1940, the user can insert the dowels 2415 into corresponding retaining members 2445 on the terminal box 1960, facilitating alignment of the end-plate 1940. Then the user can insert threaded bolts through the apertures 2215 for threaded mating with the corresponding apertures 4000 of the mid-plate 1935 (which are aligned with the apertures 2215 through the use of the dowels 2415), thereby fastening the end-plate 1940 to the mid-plate 1935. In other embodiments, the gender of the guide features can be reversed, e.g., such that the dowels or other male elongate guide members 2415 are held in the motor housing 1910 and the end-plate 1940 has apertures configured to receive the guide members 2415 during installation.

Referring to FIGS. 1, 4B, 5C, 5D, for example, the end-plate D of FIG. 4B can similarly include guides 2215 that can mate with corresponding apertures on the terminal box TB (e.g., FIG. 1) that are shaped to mate with the guides 2215, thereby facilitating alignment of the end-plate D prior to fastening the end-plate D to the mid-plate E using the bolts of the end-plate mounting hardware EMH (FIG. 5C). The guides 2215 of FIGS. 1, 4B, 5C, 5D, etc., are the fixed conduits 2215 that form the wire channels WC, instead of dowels. In other embodiments, the gender of the guide features can be reversed, e.g., the terminal box TB can include conduits that form the wire channels WC and the end-plate D can include corresponding apertures to receive the conduits that form the wire channels. Alternatively, or in addition, the wiring terminal 2400 may use snap-fit connectors, magnets, screws, or any other type of fasteners to couple to the terminal box 1960, mid-plate 1935, fan 1945, and/or any other component of the motor assembly 1900.

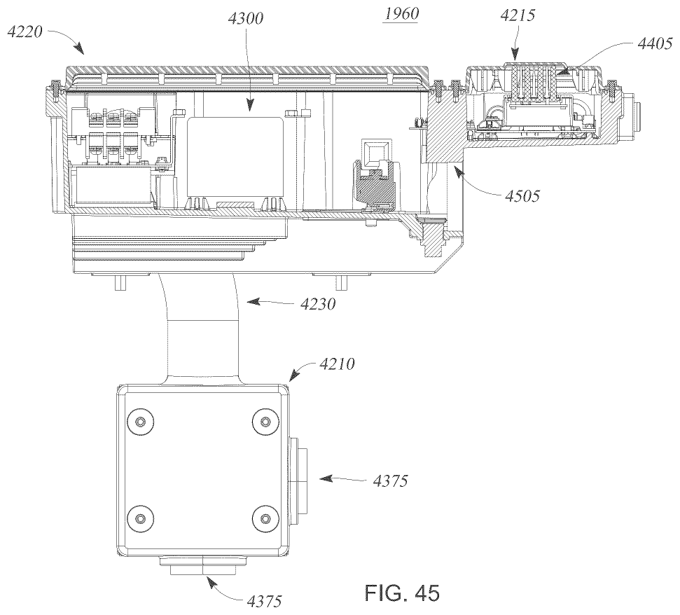

Referring again to FIG. 24, in some embodiments, the wiring terminal 2400 includes a connection flange 2410 and a gasket 2805 (see FIG. 28) that facilitates coupling with the terminal box 1960. For example, the terminal box 1960 may have a corresponding receptacle 4505 (see FIG. 45) to receive connection flange 2410. It should be understood that gaskets may be placed in-between any coupled components to prevent dust, water, grease, and/or excess heat from damaging the motor 1905 and electronic components.

Referring to FIGS. 24A and 24B, the terminal box 1960 can include an opening 2447 that receives and mates with the flange 2410 of the end-plate 1940. The wiring terminal 2400 generally facilitates electrical connection between electronics within the end-plate 1940 and electronics within the terminal box 1960. For instance, for each connection point 2405 of the wiring terminal 2400, a corresponding wire can extend within the end-plate 1940 from a connection to electronics within the end-plate 1940, through the grommet 2425 of the connection point 2405, into the opening 2447 of the terminal box 1960, and finally within the terminal box 1960 to connect to electronics within the terminal box 1960.

FIG. 25 is a perspective view of the end-plate 1940 of the motor assembly 1900 of FIG. 19 with the conductive cover removed 2020. In some embodiments, the end-plate 1940 may have one or more ventilation channels 2440 to allow air flow from the fan 1945 to reach the terminal box 1960. The air flow in the ventilation channels 2440 may also, or alternatively, cool the end-plate 1940. In some embodiments, the end-plate 1940 may have a space envelope 2500 (e.g., a hollow internal area with a periphery defined by a peripheral wall of the end-plate housing 2235, a rear wall of the end-plate housing 2235, and the cover 2020). A gasket (not shown) may be interposed between the conductive cover 2020 and the end-plate housing 2235 to advantageously prevent moisture, dust, grease, and/or excess heat from entering the space envelope 2500. The space envelope 2500 may include mounting surfaces 2505 for the electronic components or other hardware. In some embodiments, the mounting surface 2505 have a layer of conductive epoxy pads. The mounting surfaces 2505 may each have different dimensions and may protrude (e.g., 1 mm- 10 mm) into the space envelope 2500 to better accommodate different electronic components. The space envelope 2500 may also, or alternatively, have attachment points 2510 for the multi-board power plane 2000. For example, the attachment points 2510 may protrude different amounts for the different levels of the multi-board power plane 2000. In some embodiments, the end-plate 1940 may have a toroidal-shaped conductive epoxy pads 2515 to provide additional heat diffusion (e.g., from the busbar 1980 to the end-plate housing 2235).

FIG. 26 is a perspective view of the multi-board power plane 2000 and the corresponding electronics, dimensioned to fit within the space envelope 2500 of the end-plate housing 2235. As described above, the multi-board power plane 2000 may include one or more control layers and one or more power layers. For example, the multi-board power plane 2000 may have a control layer 2705, a second control layer 2710, a third control layer 2730, and a power layer 2700. The multi-board power plane 2000 may have one or more spacers 2620 in-between the layers. In some embodiments, the end-plate 1940 includes one or more conductive epoxy pads 2615. The conductive epoxy pads 2615 may be made of any conductive material (e.g., silver-filled resin) and may be interposed between the conductive cover 2020 and the low temperature components 2025 and/or heat sinks 1975A, 1975B, 1975C to increase heat diffusion and prevent the low temperature components 2025 from overheating. In some embodiments, the conductive epoxy pads 2615 are interposed between one or more components and the protruded sections 2220A, 2220B and/or receded section 2225A, 2225B (see FIG. 22) of the conductive cover 2020. For example, the conductive epoxy pads may be interposed between the heat sinks 1975A, 1975B, 1975C, input filter capacitors 3205, and/or clamp capacitors 3210 (see FIG. 32). It should be understood the conductive epoxy pads 2515, 2615 may be thermally conductive while being electrically insulative.

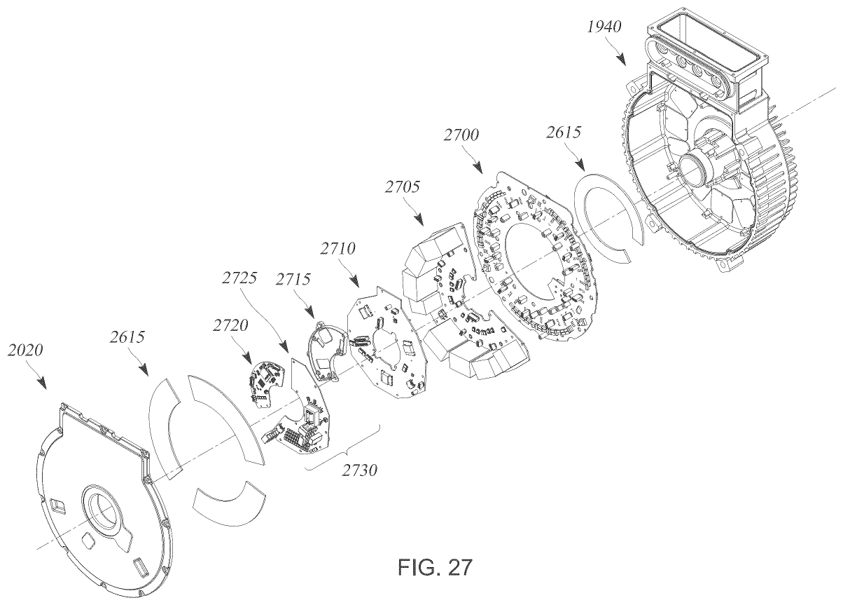

FIG. 27 is an exploded view of the end-plate 1940 and its internal components including the multi-board power plane 2000. In some embodiments, each layer of the multi-board power plane 2000 consists of a PCB. Alternatively, or in addition, one or more of the layers may consist of two or more PCB boards. For example, the third control layer 2730 may consist of a control PCB board 2720 with a housing 2715 and a switched-mode power supply 2725. The housing 2715 may provide additional support for the control PCB board 2720, and/or thermal and electric insulation from other electronic components.

In some embodiments, the PCBs of the multi-board power plane 2000 are double-sided PCBs with electronic components on both sides. The PCBs may also, or alternatively, be single-sided PCBs or multi-layered PCBs that advantageously allow complex circuits within a small area. Additionally, the PCBs may be made of either rigid or flexible materials. For example, the PCBs may be made of copper, fiberglass, epoxy resin, polyester resin, and/or any other material described herein. In some embodiments, the multi-board power plane 2000 may be a toroidal-shaped assembly to advantageously fit in the space envelope 2500 of the end-plate 1940 while providing interconnections for the input/output power, current sensors, gate driver, clamp control circuit, power/clamp semi-conductor modules, clamp resistors, busbars, and power quality capacitors. In some embodiments, the electronic components (e.g., the power quality filters and/or power modules) are mounted about the center of the multi-board power plane 2000 (e.g., in a circular pattern). Furthermore, the multi-board power plane 2000 may have an opening to allow the shaft of the motor rotor 1915 to pass through.

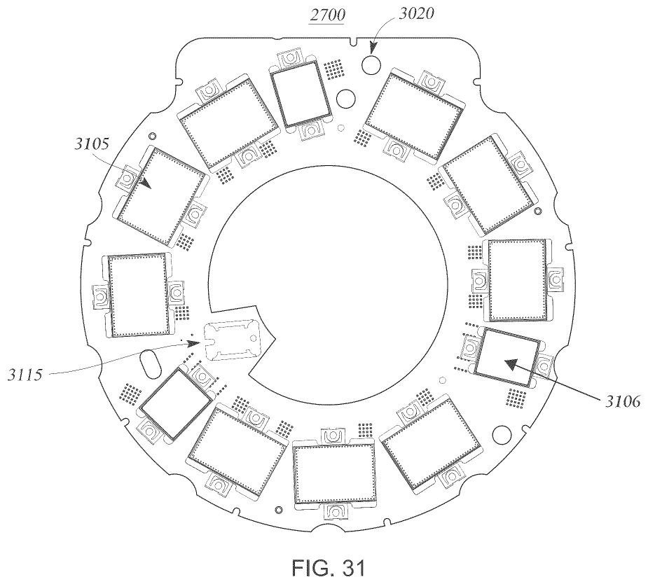

FIG. 28 is a cross-section view of the end-plate 1940 and its internal components (e.g., multi-board power plane 2000 and/or some or all of the variable frequency drive electronics unit). In some embodiments, the multi-board power plane 2000 includes one or more thermal insulation air gaps 2800. The thermal insulation air gaps 2800 prevent the heat from the power layer 2700 and the high temperature components 2030 from damaging the low temperature components 2025. The exemplary low temperature component 2025 referred to in the cross-section of FIG. 28 is a power quality capacitor 3205 (see, e.g., FIG. 32). The exemplary high temperature component 2030 referred to in the cross-section of FIG. 28 is one of the power modules 3105 (see, e.g., FIG. 31). The thermal insulation air gaps 2800 may have a thickness of 5 mm, 10 mm, 20 mm, 30 mm, 50 mm, or more than 50 mm, or any thickness in-between. For example, the thermal insulation air gap 2800 between the power layer 2700 and the control layer 2705 may be 20 mm, and the thermal insulation air gap 2800 between the control layer 2705 and the second control layer 2710 may be 12 mm. In some embodiments, the thermal insulation air gaps 2800 allow the multi-board power plane 2000 to satisfy creepage and clearance standards. Thus, the thermal insulation air gaps 2800 advantageously prevents high voltage components from electrically interfering with or damaging other electronic components. In some embodiments, the attachment points 2510, spacers 2620, power connectors 3015, and/or data connectors 1970 may be used separate the layers from one another to create the thermal insulation air gaps 2800.

FIG. 29A and FIG. 29B are front cross-section views (mid-plate 1935 side) of the end-plate 1940 and of the portion of the terminal box 1960 that overhangs the mid-plate 1935 and mates with the flange 2410 and wiring terminal 2400 of the end-plate 1940. As shown in FIG. 29A and FIG. 29B, the multi-board power plane 2000 may be generally toroidal-shaped and have a stack configuration so that the required electronic components and connectors can easily fit within the space envelope 2500 of the end-plate 1940. For example, all the PCB boards of the multi-board power plane 2000 may be toroidal-shaped with an opening in the middle. The periphery of the end-plate 1940 may be shaped to match and mate with the form factor of the motor 1905 and terminal box 1960. The terminal box 1960 may connect to the wiring terminal 2400. In some embodiments, the terminal box 1960 may have a first electronic compartment 2905 that is positioned above the wiring terminal 2400. The multi-board power plane 2000 may communicate to electronic components in the terminal box 1960 via the terminal points 2405. In some embodiments, the terminal points 2405 may allow for electrical connection between the terminal box 1960 and the multi-board power plane 2000. For example, in FIG. 28 and FIG. 29B a cable 2920 extending from the terminal box 1960 is routed through one of the terminal points 2045 to connect to an I/O port 2930 of the power plane 2000. Alternatively, or in addition, one or more of the terminal points 2405 may be used to route power cables from the terminal box 1960 to the multi-board power plane 2000. For example, a power cable 2925 may be routed through the terminal point 2405 to connect to the ground terminal 2935. Alternatively, or in addition, the terminal box 1960 may have one or more connectors 2910 with protective covers 2915. The terminal box 1960 and connectors 2910 will be discussed in more detail below.

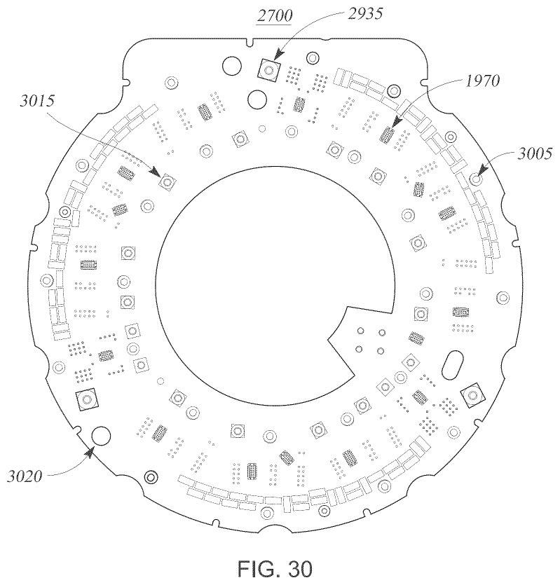

FIG. 30 is a front view (e.g., mid-plate 1935 side) of the power layer 2700 of the multi-board power plane 2000. The power layer 2700 may include one or more data connectors 1970, component attachment points 3005, support apertures 3020, power connectors 3015, and/or ground terminal 2935. The component attachment points 3005 may allow electronic components to be mounted onto the board. Alternatively, or in addition, the electronic components may be surface mounted. In some embodiments, the support apertures 3020 may be mounting holes used to mount the power layer 2700 onto the end-plate 1940. The support apertures 3020 may also, or alternatively, allow one or more raised attachment points 2510 (see FIG. 25) to pass through a support aperture 3020 and connect to a different PCB (e.g., the control layer 2705) in the multi-board power plane 2000. In some embodiments, the opening 3010 allows the power layer 2700 to encircle the central column 2035 of the end-plate 1940.

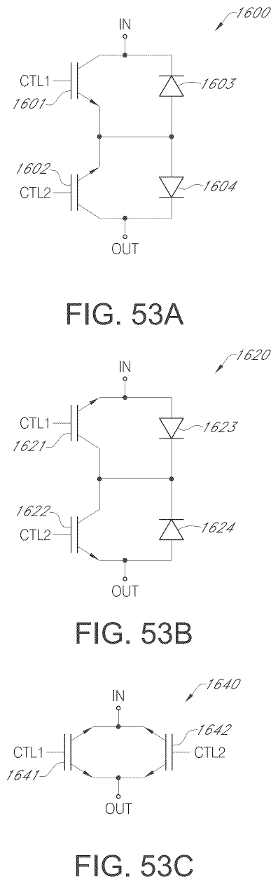

FIG. 31 is a back view (e.g., fan 1945 side) of the power layer 2700 of the multi-board power plane 2000, which can include one or more components of the matrix converter (e.g., any of the matrix converters of FIGS. 50, 52 or 54. In some embodiments, for example, the power layer 2700 has one or more power modules 3105 and one or more current sensing modules 3106. For example, the power modules 3105 may include one or more power converters, power semi-conductors, and/or bi-directional switches (e.g., like the switches and/or power modules of FIGS. 6A-6B or 53A-53C). In some embodiments, the power modules 3105 are one component of the matrix converter and communicate with other components (e.g., in the terminal box 1960 and on other PCBs) to create the full matrix converter. As described above, the matrix converter can receive AC input signaling and provide converted AC signaling having a converted AC waveform with a converted voltage and frequency to drive the motor 1905. For example, the matrix converter can be a direct AC-AC matrix converter without an intermediate DC stage.

The arrangement and distribution of the components of the matrix converter may allow the motor 1905 to run efficiently while the end-plate 1940 and/or the mid-plate 1935 and end-plate 1940 together maintain a small overall form factor (e.g., a length and diameter that complies with industry standards). As shown, the power modules 3105 may be positioned in a circular arrangement. The power modules 3105 may be in contact with the end-plate housing 2235 to effectively transfer heat from the high temperature components 2030 to the cooling fins 2305, 2310 of the end-plate housing 2235. This is illustrated, for example, in FIG. 28, where the power module 2030 is in contact with the end-plate housing 2235. Furthermore, the power layer 2700 may include one or more input filter capacitor connectors, a clamp IGBT connectors, shunt resistor connectors 3115, and/or an output clamp diode connector. The power modules 3105 (larger rectangles) may correspond to the bi-directional switches of the arrays of switches 1002, 1102, 1702 of FIGS. 50, 52, and 54, for example, and can any of the switches of FIGS. 6A, 53A-53C, or the power module of FIG. 6B. The current sensing modules 3106 in some embodiments include resistive shunts, although other types of current sensors are possible.

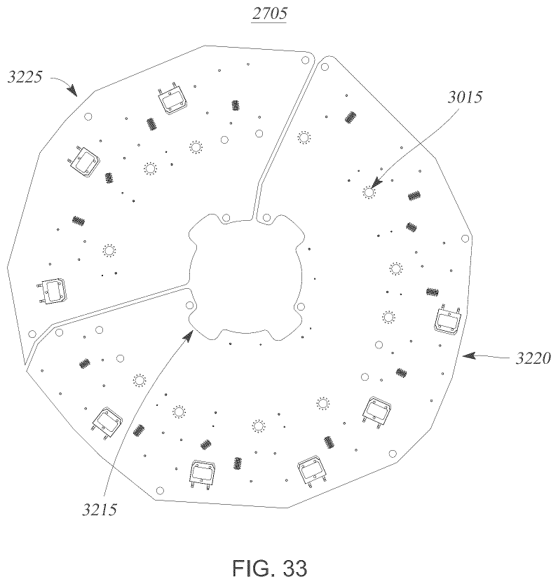

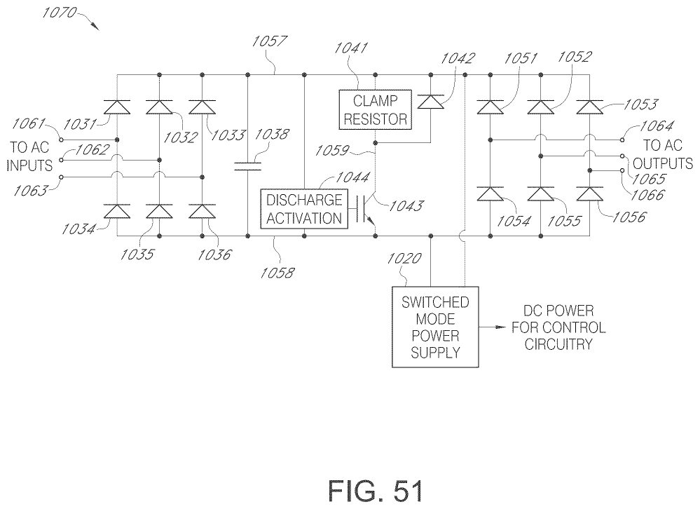

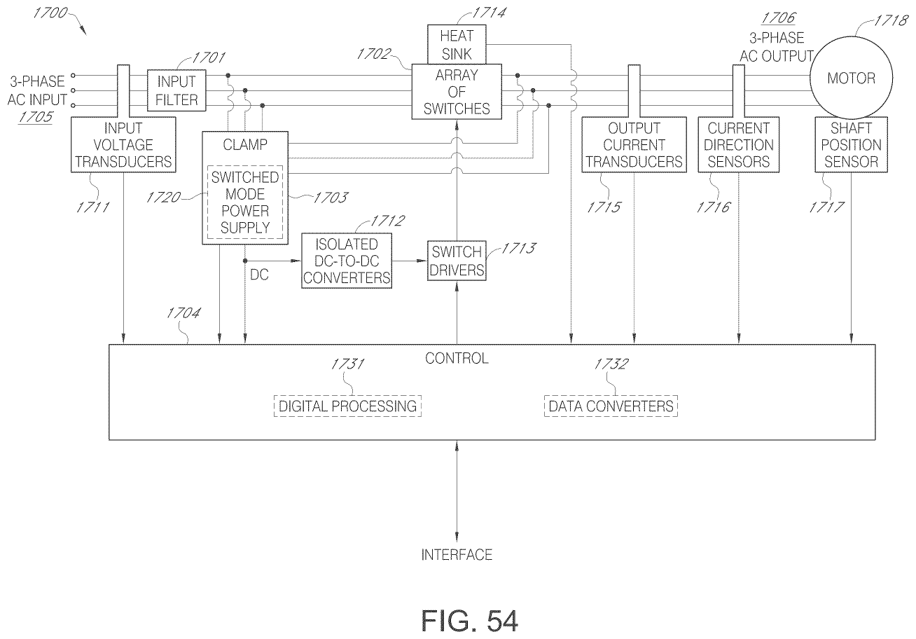

FIG. 32 and FIG. 33 are front and back views, respectively, of the control layer 2705 of the multi-board power plane 2000, which, like the power layer 2700, can include one or more components of the matrix converter. The control layer 2705 may include one or more input filter capacitors 3205, clamp capacitors 3210, data connectors 1970, support apertures 3020, and/or power connectors 3015. In some embodiments, the electronic components of the control layer 2705 may be used as power quality filter components (e.g., the input filter capacitors 3205). As described above, the control electronic modules may be positioned in a circular arrangement and may be in contact with the conductive cover 2020 to effectively transfer heat from the low temperature components 2025 (e.g., the capacitors 3205, 3210) into the external environment. It should be understood that the control layer 2705 may also, or alternatively, have one or more power quality filters, power quality capacitors, peak supporters, input phase wires, shunt resistors, clamp modules, clamp resistor wires, gate driver power supply, controller cards, copper connectors, current sensors, gate drivers, power supply, and/or any other control electronics module/power qualify filter components. Furthermore, the control electronic modules and electronic components described herein may be distributed or positioned in any configuration among the various PCB boards, including on either side of the boards. Alternatively, or in addition, any of the electronic components may be distributed or positioned in the terminal box 1960 (e.g., one or more power modules may be in the terminal box 1960 in some other embodiments). The input filter capacitors 3205 may correspond to one or more of the capacitors 1015, 1016, 1017 of the input filter 1001 of FIG. 50 or to capacitors of the input filter 1701 of FIG. 54, for example. The clamp capacitors 3210 may correspond to the capacitor 1038 of FIG. 51, or to capacitors of the clamps 1003, 1703 of FIGS. 50, 54.

In some embodiments, the control layer 2705 is a two-part layer with a first PCB board 3220 and a second PCB board 3325. Separating the control layer 2705 into two or more separate PCBs may offer several benefits, including improved accessibility for maintenance and repair, enhanced reliability by reducing the risk of a single point of failure, improved performance by using specialized materials/components for the different sides, and increased flexibility through a more modular design. In some embodiments, the control layer 2705 may include a non-circular opening 3215 to allow the raised attachment points 2510 of the end-plate housing 2235 (See, e.g., FIG. 25) to reach the other layers of the multi-board power plane 2000. The non-circular opening 3215 may also, or alternatively, allow one or more busbars or other components to reach the control layer 2705 and/or the other layers.

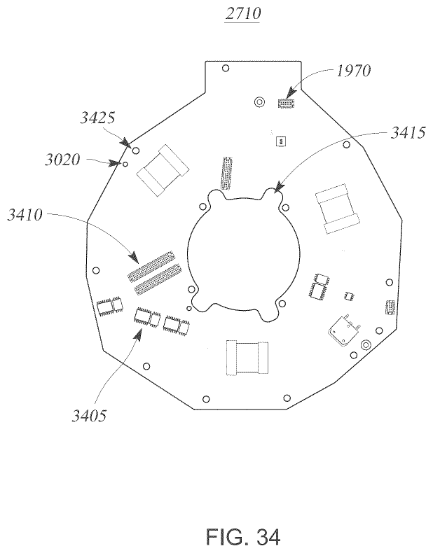

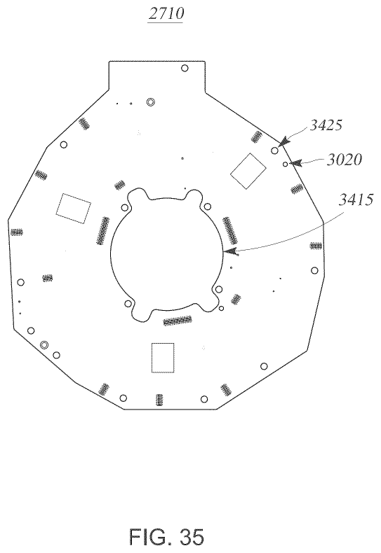

FIG. 34 and FIG. 35 are front and back views, respectively, of the second control layer 2710 of the multi-board power plane 2000. As described above, the second control layer 2710 may include any of the electronic components (e.g., control electronic modules, data connectors 1970, PCB mounting holes 3425, 3020) described herein. In some embodiments, the second control layer 2710 is a clamp control PCB. Like the control layer 2705 and the power layer 2700, the second control layer 2710 may include or one or more components of the matrix converter. Alternatively, or in addition, the second control layer 2710 may include a microprocessor interface 3410 to connect to a microprocessor of the third control layer 2730. In some embodiments, the second control layer 2710 may be smaller than the other layers of the multi-board power plane 2000. For example, the microprocessor interface 3410 can be a PCB-to-PCB connector allowing signals to pass from the second control layer 2710 to the third control layer 2730. The second control layer 2710 may also, or alternatively, have a non-circular opening 3415 and non-circular support apertures 3425, 3020. In some embodiments, the opening 3415 of the second control layer 2710 is circular and accommodates the central heat sink of the end-plate 1940. However, the size of the layers may vary to accommodate different preferences and use cases. The second control layer 2710 can further include one or more packaged integrated circuits 3405, which can perform control and drive functionality.

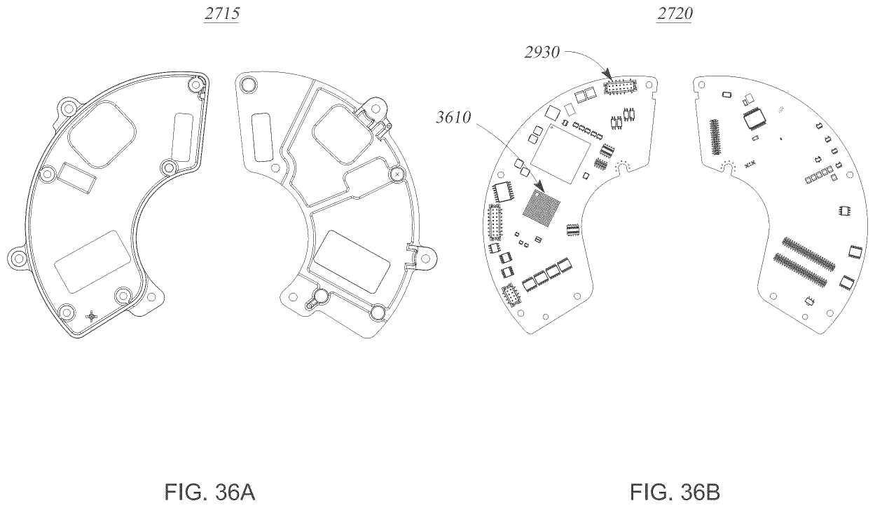

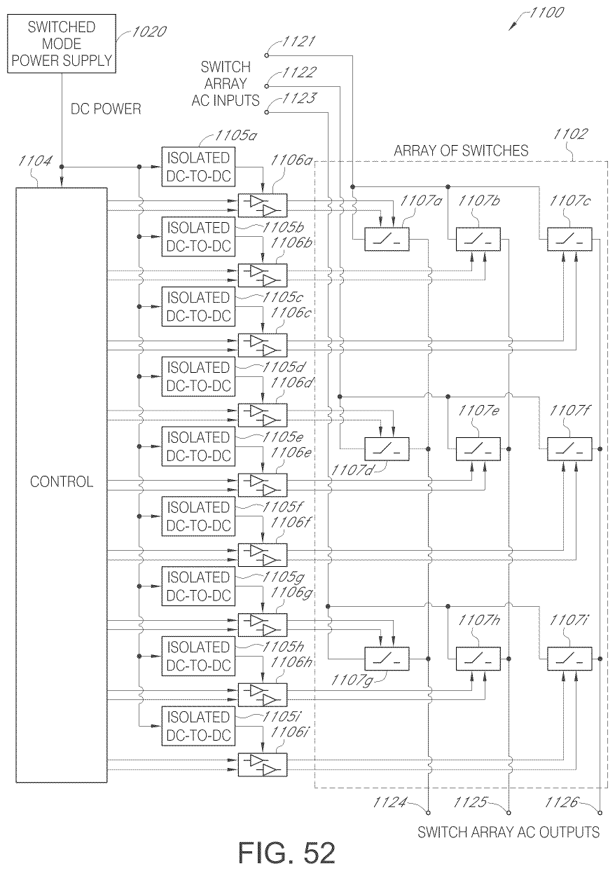

FIG. 36 is a front and a back view of the control PCB board 2720 and housing 2715 of the third control layer 2730 of the multi-board power plane 2000. For example, the PCB control board 2720 can be a main control board for controlling the operation of the matrix converter and other components of the embedded motor drive electronics, including other components mounted within the end-plate 1940. The housing 2715 can be a plastic carrier for carrying the PCB control board 2720. In some embodiments, the control PCB board 2720 may include one or more integrated circuits 3610 mounted thereon. For example, one or more of the integrated circuits 3610 can comprise the main microprocessor of the multi-board power plane 2000. The integrated circuits can include one or more field-programmable gate arrays, which can be programmable integrated circuits that can perform various digital logic functions and may consist of configurable logic blocks and programmable interconnects that allow field-programmable gate array 3610 to be customized for specific tasks, such as digital signal processing or control logic. In some embodiments, the PCB control board 2720 may correspond to some or all of the control circuitry 1004 of FIG. 50, some or all of the control PCB of the control block 1104 of FIG. 52, and/or some or all of the control circuitry of the control block of FIG. 54.

In some embodiments, the control PCB board 2720 may include any of the electronic components (e.g., control electronic modules, data connectors 1970, support apertures 3020) described herein. Furthermore, the housing 2715 may provide a physical barrier around the control PCB board 2720, protecting it from external factors such as dust, moisture, and mechanical damage, which may extend the lifespan of the control PCB board 2720 and improve the overall reliability of the multi-board power plane 2000. The housing 2715 may also, or alternatively, facilitate the dissipation of heat from the control PCB board 2720 by acting as a heat sink. In some embodiments, the housing 2715 may enhance the performance of the control PCB board 2720 by improving signal integrity, power efficiency, and/or electromagnetic compatibility. It should be understood that any of the PCBs of the multi-board power plane 2000 may have a housing.

FIG. 37 is a front and back view of the switched-mode power supply 2725 of the multi-board power plane 2000. In some embodiments, the switched-mode power supply 2725 may be a power supply that efficiently converts an input voltage into a desired output voltage. It may be used to power the multi-board power plane 2000 and the motor 1905 by providing a stable, regulated voltage. The switched-mode power supply 2725 may operate by switching one or more power transistors 3720B on and off at a high frequency, resulting in efficient power conversion with minimal losses. The power transistors 3720B may be metal-oxide-semiconductor field-effect transistors (MOSFETs). The switched-mode power supply 2725 may include one or more diodes 3720A. The diodes 3720A and/or power transistors 3720B may be attached to corresponding heat sinks 1975A, 1975B. The heat sinks 1975A, 1975B, 1975C may reduce the operating temperature of the power transistors 3720B and diodes 3720A to improve their efficiency and increase their lifespan.

In the illustrated embodiment, the switched-mode power supply 2725 includes a switch mode transformer 3710, a plurality of power supply capacitors 3705, and a current sensor 3715. The switch mode transformer 3710, input filter capacitors 3205, clamp capacitors 3210 (see FIG. 32), and/or heat sinks 1975A, 1975B, 1975C may be mounted to an epoxy pad 2615 to improve heat diffusion and prevent the electronic components from overheating. As discussed above, one side of the epoxy pad 2615 may be in contact with the conductive cover 2020. The switched-mode power supply 2725 may also include support apertures 3425, 3020, which can be PCB mounting holes. Overall, the control layers of the multi-board power plane 2000 may be used to efficiently control the power provided to the motor 1905.

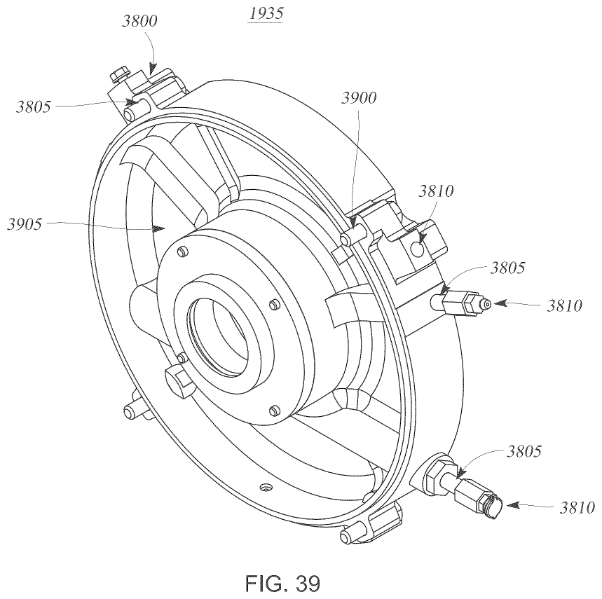

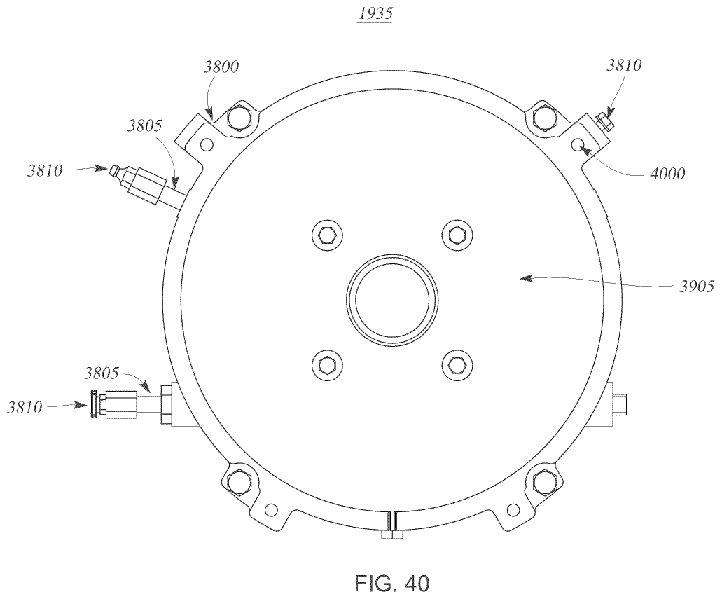

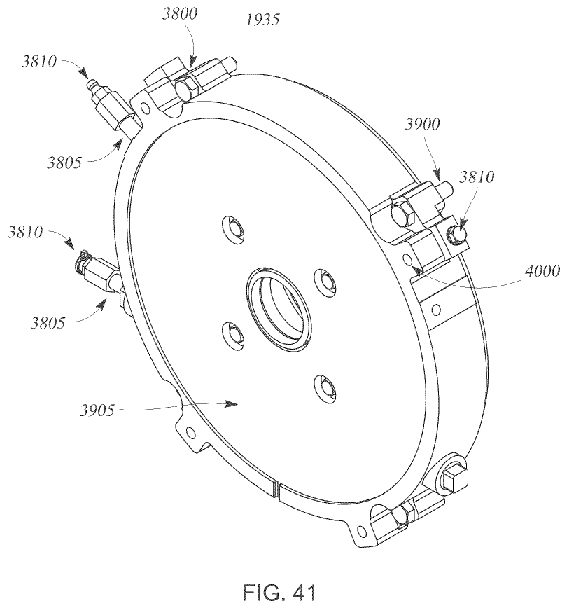

FIG. 38 and FIG. 39 are a front and front-perspective view, respectively of the mid-plate 1935 of the motor assembly 1900 of FIG. 19. FIG. 40 and FIG. 41 are a back and back-perspective view, respectively of the mid-plate 1935 of the motor assembly 1900 of FIG. 19. The mid-plate 1935 may include any features of mid-plate E, E′, and E″. For example, the mid-plate 1935 may have a wall 3905. In some embodiments, the mid-plate 1935 includes one or more bearing oil/grease tubes 3820. The grease tubes 3820 may include a service port 3825, 3815 for refilling or flushing the oil or grease. For example, service port 3825 may be a grease zerk fitting that allows input of fresh grease from a grease gun and service port 3815 may be a grease pressure release. That allows old grease to be expelled. The mid-plate 1935 may also, or alternatively, have a wall and one or more retaining members 3800 (e.g., such as four retaining member 3800). The retaining members 3800 may be Z-shaped with three different apertures. The three different apertures may allow the mid-plate 1935 to connect to the motor frame 1910 (distal to the mid-plate wall 3905), the terminal box 1960, and/or the end-plate 1940 (proximate to the mid-plate wall 3905). For example, the first aperture 3805 (FIGS. 38 and 39) may receive a motor frame 1910 fastener, the second aperture 3810 (FIGS. 38-41) may receive a terminal box 1960 fastener, and the third aperture 4000 (FIGS. 40-41) may receive a dowel and/or an end-plate 1940 fastener, as discussed previously, e.g., with respect to FIG. 22. In some embodiments, the retaining members 3800 may use screws 3900, bolts, rivets, snap-fit connectors, and/or magnets, to connect to other components. Additionally, or alternatively, the retaining members 3800 may receive a dowel in a friction fit. The other end of the dowel may be attached to the corresponding component. In some embodiments, a combination of any of the fastening methods described herein may be used.

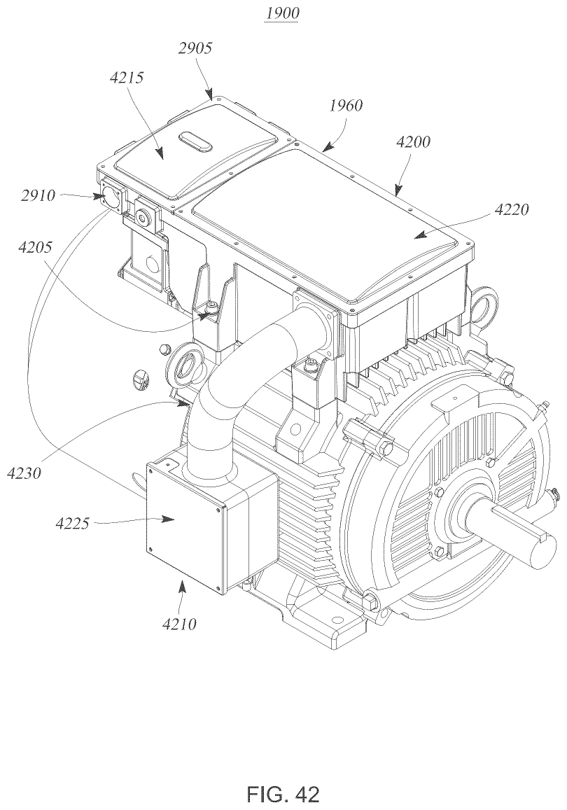

FIG. 42 is a perspective view of the motor assembly 1900 of FIG. 19. In some embodiments, the terminal box 1960 has a first electronic compartment 2905, a second electronic compartment 4200, and a third electronic compartment 4210. The three separate compartments may reduce electronic interference between the electronic components, as well as facilitate installation and repair of the motor assembly 1900. In some embodiments, the third electronic compartment 4210 may be connected to the second electronic compartment via a protective conduit 4230. The three separate compartments may have removable lids 4215, 4220, and 4225 that may be used as heat sinks to cool the electronic components within the respective electronic compartment. The removable lids 4215, 4220, and 4225 may use any of the fastening methods described herein to couple to the respective terminal box 1960 attachment points, as well as use gaskets to prevent dust, moisture, and/or grease from entering the motor assembly 1900 and terminal box 1960.

In some embodiments, the terminal box 1960 has one or more attachment points 4205 to facilitate coupling with the rest of the motor assembly 1900. The one or more attachment points 4205 may use any of the fastening methods described herein, as well as use gaskets to prevent dust, moisture, and/or grease from entering the motor assembly 1900 and terminal box 1960. As described above, the terminal box 1960 may have one or more connectors 2910 (e.g., six connectors 2910). The connectors 2910 will be described in more detail below. In some embodiments, the motor assembly 1900 may have multiple terminal boxes 1960.

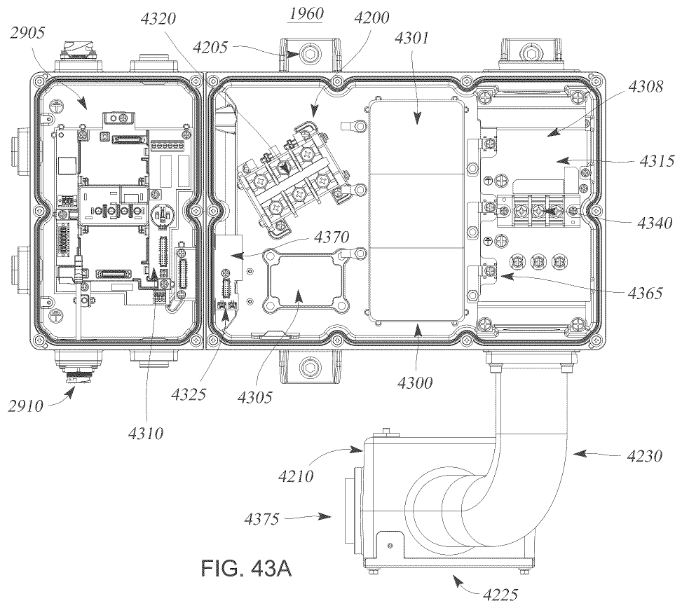

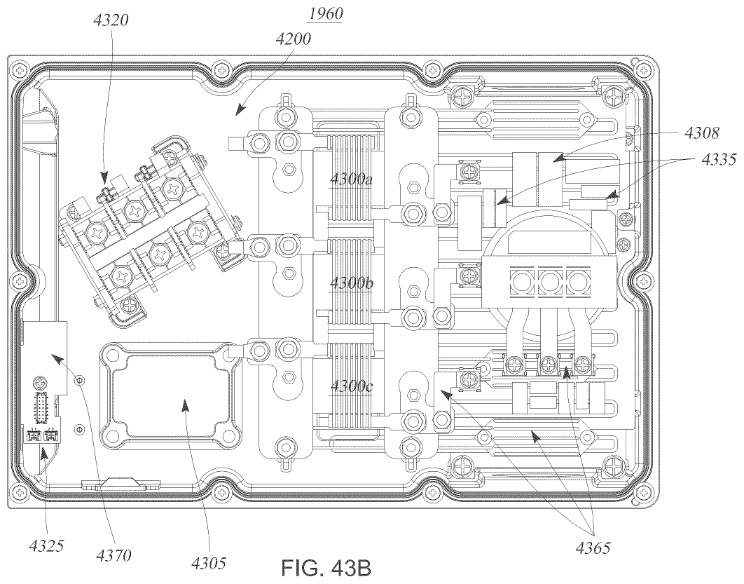

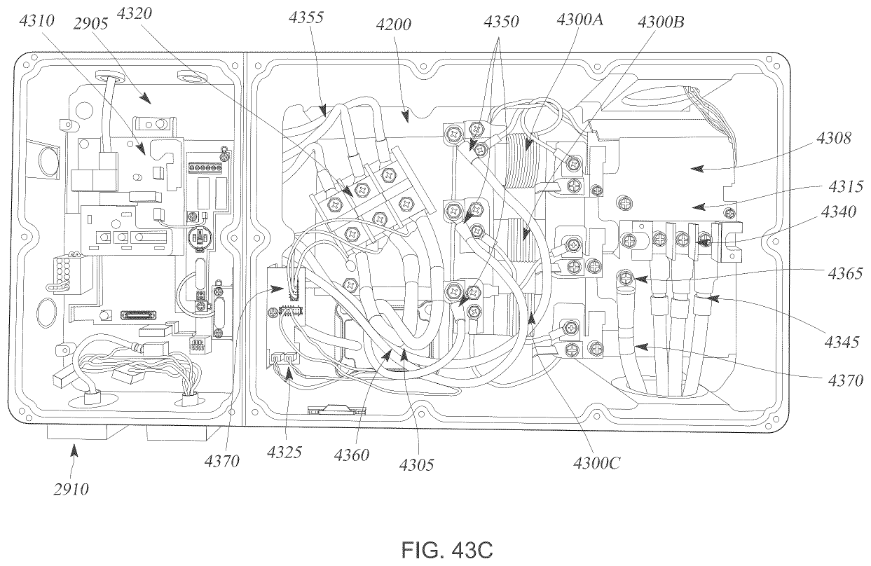

FIG. 43A is top view of the terminal box 1960 of the motor assembly 1900 of FIG. 19 with the lids 4215, 4220 removed. In some embodiments, the terminal box 1960 has one or more electronic components that communicate with electronic components in the end-plate 1940 to control the power provided to the motor 1905. Like terminal box TBH (see FIGS. 5B, 5C), the terminal box 1960 may have one or more inductors 4300 (e.g., three inductors 4300) that work with or that are part of the matrix converter, whereas the remaining components of the matrix converter are disposed within the end-plate 1940 (EMH in FIG. 5C). For instance, the inductors 4300 may be used to mitigate the transistor-switching noise generated by the matrix converter. In this capacity, the inductors 4300 may serve as low-pass filters, attenuating high-frequency noise while allowing the desired DC signals to pass through.

The inductors 4300 may be placed in series with the matrix converter's power modules 3105, or they may be connected in parallel with the load or other downstream components. By smoothing out the transistor switching noise, the inductors 4300 may improve the performance and reliability of the matrix converter. In some other embodiments, the inductors 4300 are disposed in the end-plate 1940 such that the entire matrix converter is disposed within the end-plate 1940. The inductors 4300 may correspond to the inductors 1011, 1012, 1013 of the input filter 1001 of FIG. 50 and/or the inductors of the input filter 1701 of FIG. 54, for example.

In some embodiments, the inductors 4300 are housed under a lid 4301. As shown, the terminal box 1960 can further include an opening 4305 that allows for wire connections to pass between the motor 1905 and the terminal box 1960, an input power terminal block 4340 allowing for connection of the input grid power to the matrix converter, an output motor power terminal block 4320 allowing for connection of the output power delivered by the matrix converter to the motor 1905, and one or more temperature sensors 4325 configured to detect the temperature of the motor and/or the terminal box 1960. The temperature sensors 4325 may additionally, or alternatively, be configured to detect the surface or interior temperature of the end-plate 1940. In some embodiments, temperature sensors 4325 are place within the end-plate 1940 and/or directly on the electronic components of the multi-board power plane 2000. The terminal box 1960 may also have one or more ground terminals 4365. As describe above, distributing the electronic components of a variable frequency drive and/or matrix converter between the terminal box 1960 and the end-plate 1940 allows the motor assembly size (e.g., the inline length) to remain compact and within applicable guidelines, while providing energy efficiency, adjustable operating speed and torque, and/or a lower starting current. It should be noted that the variable frequency drive may be configured to provide power to the electric motor.

With continued reference to FIG. 43A, the terminal box 1960 may have a radio frequency interference (RFI) filter 4308 covered by a steel shield 4315, busbars, and/or an application control board 4310. The application control board 4310 may allow a user to control and monitor the motor 1905 by connecting external hardware (e.g., computers, controllers, and/or sensors) to the application control board 4310. In some embodiments, the external hardware devices may communicate with the application control board 4310 through wireless signals such as Bluetooth or cellular radio. Alternatively, or in addition, the user may connect wires to the application control board 4310 to establish a physical link between the external hardware devices and the application control board 4310. For example, a user may connect one or more external hardware devices into the connectors 2910. The connector 2910 may be physically connected (e.g., via one or more wires) to the application control board 4310, the multi-board plane 2000, and/or any other component of the matrix converter. The application control board 4310 can also be connected to the matrix converter, including one or more processors or other components of the matrix converter within the end-plate 1940, thereby allowing for control of or programming of the matrix converter by the application control board 4310.

In some embodiments, the application control board 4310 may be connected to a secondary control board 4370. The secondary control board 4370 may span from the first electronic compartment 2905 to the second electronic compartment 4200. Thus, the secondary control board 4370 may enable the transmission of both information and power between the two electronic compartments 2905, 4200.

FIG. 43B shows a top view of a portion of the terminal box 1960 with the lid 4301 removed, thereby exposing the three input filter inductors 4300a, 4300b, 4300c. As describe above, the three input filter inductors 4300a, 4300b, 4300c may correspond to the inductors 1011, 1012, 1013 of the input filter 1001 of FIG. 50 and/or the inductors of the input filter 1701 of FIG. 54. FIG. 43B also shows the terminal box 1960 with the steel shield 4315 removed, thereby exposing components of the RFI filter 4308, which can include one or more surge protection varistors 4335 (e.g., metal-oxide varistors [MOVs]) configured to protect against grid voltage surges, one or capacitors, and one or more inductors (e.g., a toroid inductor).

FIG. 43C depicts another view of the terminal box 1960 with certain wiring connections shown, which were not shown in FIG. 43A or FIG. 43B for the purposes of simplicity. For example, FIG. 43C shows a first set of wires 4345 connecting grid power to the input terminal block 4340. In some embodiments, the first set of wires 4345 are routed through the protective conduit 4230 from the third electronic compartment 4210. The third electronic compartment 4210 may be connected to grid power via one or more connectors 4375. The first set of wires 4345 may include a ground wire 4370.

In some embodiments, the terminal box 1960 includes a second set of wires 4350 extending from outputs of the input filter inductors 4300a, 4300b, 4300c to the, through the opening 2447 of the terminal box 1960, to corresponding connection points 2405 in the wiring terminal 2400 of the end plate 1940 (FIG. 24B), and thereby to provide input power to the downstream components of the matrix converter residing in the end-plate 1940. The terminal box 1960 may also, or alternatively, include a third set of wires 4355 extending from an output of the matrix converter in the end-plate 1940, via corresponding connection points 2405 in the wiring terminal 2400 of the end-plate 1940, through the opening 2447 in the terminal box 1960, thereby providing AC-AC converted power signals from the matrix converter to an input of the output motor power terminal block 4320. In this fashion, the second set of wires 4350 and/or third set of wires 4355 may be routed from the second electronic compartment 4200 to the end-plate 1940 via the wiring terminal 2400. For example, one or more wires from the second set of wires 4350 and/or third set of wires 4355 may correspond to cable 2920 and/or power cable 2925, as shown in FIGS. 28 and 29B. In the illustrated embodiment, a fourth set of wires 4360 extends from an output of the output motor power terminal block 4320 through the opening 4305 in the bottom of the terminal box 1960, to the motor 1905, thereby delivering AC-AC converted power signals from the matrix converter to the motor 1905.

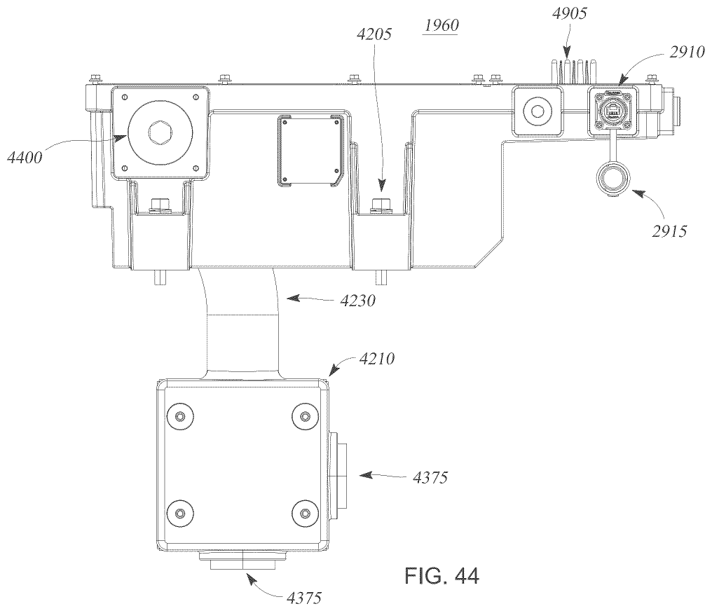

FIG. 44 and FIG. 45 are a side view and a cross-section side view, respectively, of the terminal box 1960 of the motor assembly 1900 of FIG. 19. In some embodiments, the terminal box 1960 has a connector 4400 that may be used to connect a fourth electronic compartment to the terminal box 1960. Thus, the terminal box 1960 may advantageously be customized to the needs and preferences of the user. In some embodiments, some of the electronic components have cooling fins 4405 that may be in physical contact with one of the removable lids 4215. In some embodiments, the motor assembly 1900 may have multiple terminal boxes 1960. For instance, the motor assembly may have a terminal box 1960 on the top and bottom of the motor frame 1910. It should be noted that multiple terminal boxes may be added without needing to expand the overall length of the motor assembly 1900.

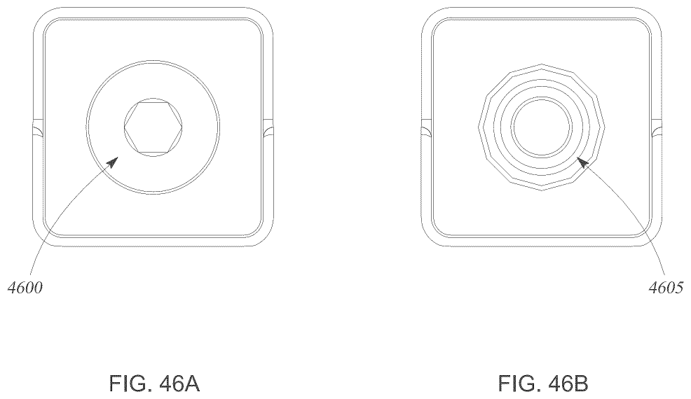

FIG. 46A and FIG. 46B are front view of the connectors 2910 of the terminal box 1960 of the motor assembly 1900. FIG. 46A illustrates the connector 2910 with a protective cover 4600. In some embodiments, the protective cover 4600 may be made of rubber, metal, or any other materials disclosed herein. The protective cover 4600 may be used to seal and protect connectors 2910 that are not being used. FIG. 46B illustrates the connector 2910 with no protective cover or with the protective cover removed. In some embodiments, the connector 2910 can have a self-sealing grommet 4605. In some embodiments, the protective grommet 4605 is configured such that a user can punch a hole in the self-sealing grommet 4605 before inserting a cable through the grommet 4605. However, in other embodiments, the self-sealing grommet includes a pre-configured cable aperture (e.g., a slit). The self-sealing grommets 4605 may provide a flexible and compressible seal around a conductor or cable as it passes through the self-sealing grommet 4605. For example, when the cable is inserted into the punched or pre-configured aperture in the self-sealing grommets 4605, the material of the self-sealing grommets 4605 may deform and compress around the cable creating a seal that prevents moisture, liquids, gases, dust, or other contaminants from entering or exiting through the connector 2910. In some embodiments, the base of the terminal box 1960 is designed with a slope to facilitate the drainage of moisture, liquids, and/or grease to exit via a vent (not shown).

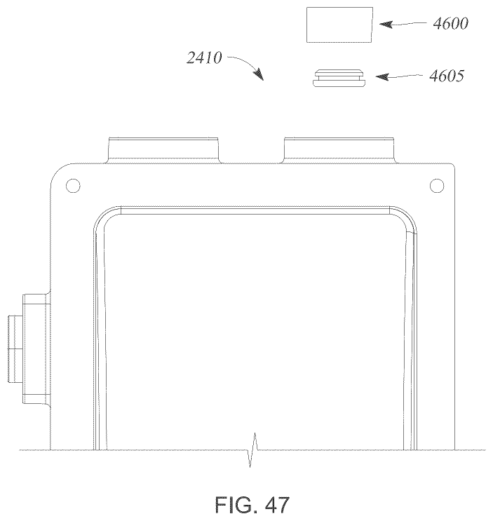

In some embodiments, the self-sealing grommet 4605 may provide strain relief and support for the cable, helping to prevent damage or failure due to mechanical stress. Alternatively, or in addition, the self-sealing grommets 4605 may have a built-in wire clamp and/or a locking mechanism to help secure the cable and prevent it from slipping or coming loose. FIG. 47 is a top-exploded view of the connectors 2910 of the terminal box 1960 of the motor assembly 1900. In some embodiments, the self-sealing grommets 4605 may be made of rubber, silicone, neoprene, plastic, or any other material that is resistant to water, oil, and other environmental factors.

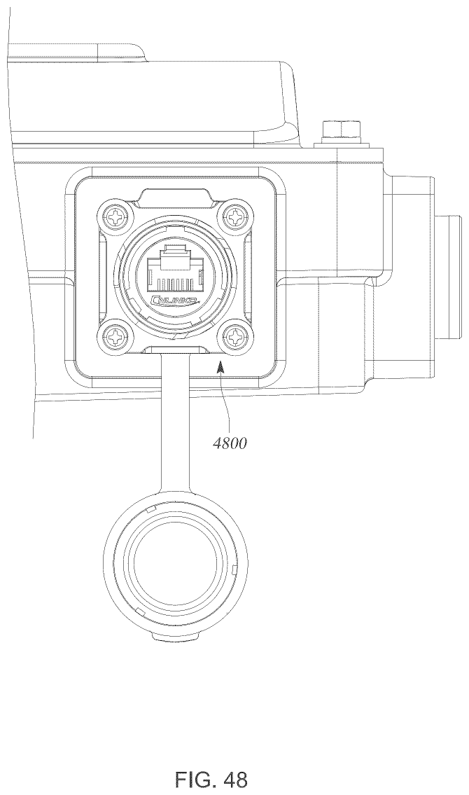

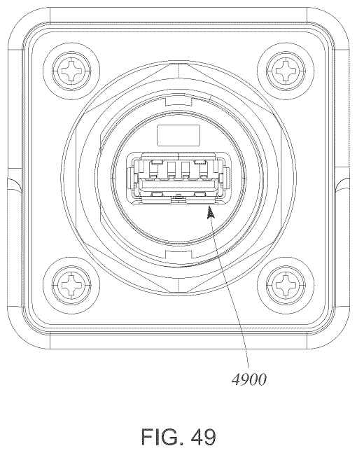

FIG. 48 and FIG. 49 are front view of the connectors 4800 and 4900 of the terminal box 1960 of the motor assembly 1900. In some embodiments, the connectors may be RJ-11 connectors 4800 and/or USB-B connectors 4900. However, any type of connector may be used (e.g., ethernet, USB-C, HDMI, DisplayPort, etc.). It should be understood that a combination of connectors may be used for the terminal box 1960. As described above, these connectors 4800 and 4900 allow a user to easily connect external hardware to the electronic components of the motor. The overall multi-board power plane 2000 and terminal box 1960 implementation allows for the manufacture of an embedded electronic motor drive in power levels greater than that currently produced in the marketplace and in the space envelope of an electric motor.

One drawback of conventional electric motors is that they are run at a fixed speed based on the input frequency of the AC power supply, and control of the rotational speed of a pump or other rotary device coupled to the electric motor is provided via mechanical structure (e.g., a brake, throttle valve), resulting in a waste of energy. Another drawback of existing electric motors is that the maximum speed of the electric motor is limited to the AC power supply's input frequency, thereby requiring a larger pump to be installed when increased pressure or flow of the pump is desired.

A matrix converter is a type of motor drive circuit that can adjust motor input frequency and voltage to control AC motor speed and torque as desired. For example, variable speed operation of an electric motor can improve reliability and throughput while reducing energy consumption. As discussed, the embodiments disclosed herein can include a matrix converter. For example, any of the embodiments discussed herein can include the matrix converters shown and described with respect to FIGS. 50-54, or any of the matrix converters described herein.

A matrix converter receives a multi-phase AC input voltage and opens and closes switches of a switch array over time to thereby synthesize a multi-phase AC output voltage with desired frequency and phase. Various circuits are used in a matrix converter for control functions. For instance, a processor and/or field programmable gate array (FPGA) can be used for computations related to a modulation algorithm that selects which particular switches of the array are opened or closed at a given moment, and switch drivers can be included to provide DC control signals to the control inputs of the switches.

The matrix converter can also include a clamp circuit that dissipates load energy (for instance, overvoltage conditions arising during shutdown) by clamping one or more inputs terminal of the matrix converter to one or more output terminals of the matrix converter. Including the clamp circuit enhances robustness, for instance, by providing a discharge path for excess load current and/or to handle overcurrent and shutdown conditions.

In certain embodiments herein, a matrix converter includes an array of switches having AC inputs that receives a multi-phase AC input voltage and AC outputs that provide a multi-phase AC output voltage to a load. The matrix converter further includes control circuitry that opens or closes individual switches of the array, and a clamp circuit connected between the AC inputs and AC outputs of the array and operable to dissipate energy of the load in response to an overvoltage condition. The clamp circuit includes a switched mode power supply operable to generate a DC supply voltage for the control circuitry.

Implementing the matrix converter in this manner provides a number of advantages, including an ability to maintain the control circuitry on for a longer duration of time when the AC input power is lost or of poor quality.

FIG. 50 is a schematic diagram of a matrix converter 1030 according to one embodiment. The matrix converter 1030 includes an input filter 1001, an array of switches 1002, a clamp circuit 1003, control circuitry 1004, 3-phase AC input terminals 1005, and 3-phase AC output terminals 1006.

In the illustrated embodiment, the input filter 1001 is implemented as an inductor-capacitor (LC) filter that serves to filter a 3-phase AC input voltage received on the 3-phase AC input terminals 1005 to generate a filtered 3-phase AC input voltage for the array of switches 1002. The input filter 1001 can also filter out switched noise caused by the array of switches 1002 and prevent such noise from contaminating the AC supply. The input filter 1001 can be a low pass filter. The 3-phase AC input voltage can correspond to, for example, three AC input voltage waveforms received from a power grid and each having a phase separation of about 120° and a desired voltage amplitude (for instance, 240 V or other desired voltage).

As shown in FIG. 50, the input filter 1001 includes a first inductor 1011 connected between a first AC input terminal and a first AC input to the array of switches 1002, a second inductor 1012 connected between a second AC input terminal and a second AC input to the array of switches 1002, and a third inductor 1013 connected between a third AC input terminal and a third AC input to the array of switches 1002. The input filter 1001 further includes a first capacitor 1015 electrically connected between the first AC input and the second AC input of the array of switches 1002, a second capacitor 1016 electrically connected between the second AC input and the third AC input of the array of switches 1002, and a third capacitor 1017 electrically connected between the first AC input and the third AC input of the array of switches 1002.

Including the input filter 1001 provides a number of advantages, such as providing protection against pre-charge and/or inrush current during power-up. Although one implementation of an input filter is depicted, matrix converters can be implemented with input filters of a wide variety of types. Accordingly, other implementations are possible.

The control circuitry 1004 opens or closes individual switches of the array of switches 1002 over time to thereby provide a 3-phase AC output voltage to the 3-phase AC output terminals 1006 with a desired frequency and phase relative to the 3-phase AC input voltage. The control circuitry 1004 can include various circuits for control functions. In a first example, the control circuitry 1004 can include a processor and/or FPGA for computations related to a modulation algorithm used to select which particular switches of the array 1002 are opened or closed at a given moment. In a second example, the control circuitry 1004 can include switch drivers that provide DC control signals to the switches of the array 1002 to thereby open or close the switches as desired.

The clamp circuit 1003 is electrically connected between the AC inputs and AC outputs of the array of switches 1002, and operates to dissipate energy during shutdown of the matrix converter 1030 or other overvoltage conditions. For example, the discharge activation device 1044 can sense a high voltage condition, and triggering the semiconductor switch 1043 to send cause overvoltage energy to pass through the clamp resistor 1041, thereby converting energy into thermal energy dissipated as heat. Including the clamp circuit 1003 enhances robustness, for instance, by providing a discharge path for excess load current and/or to handle overcurrent and shutdown conditions. For example, the clamp circuit 1003 can prevent freewheel paths for load current during shutdown and/or current paths for over-current.

In the illustrated embodiment, the clamp circuit 1003 includes a switched mode power supply 1020 that serves to generate DC power for the control circuitry 1004. In certain implementations, the supply voltage input to the switched mode power supply 1020 is directly connected to at least one internal node of the clamp circuit 1003. For example, a first internal node of the clamp circuit 1003 can serve to provide an input voltage to the switched mode power supply 1020 while a second internal node of the clamp circuit 1003 can serve as a ground voltage to the switched mode power supply 1020.

A switched mode power supply is an electronic power supply that incorporates a switching regulator to convert electrical power efficiently. For example, a switched mode power supply can convert power using switching devices that are turned on and off at high frequencies, and storage components such as inductors or capacitors to supply power when the switching device is in a non-conductive state.

Providing the input voltage to the switched mode power supply 1020 from a node of the clamp circuit 1003 provides a number of advantages, including an ability to maintain the control circuitry 1004 on for a longer duration of time when the AC input power is lost or of poor quality.

FIG. 51 is a schematic diagram of one embodiment of a clamp circuit 1070 for a matrix converter. The clamp circuit 1070 includes a switched mode power supply 1020, a first input clamping diode 1031, a second input clamping diode 1032, a third input clamping diode 1033, a fourth input clamping diode 1034, a fifth input clamping diode 1035, a sixth input clamping diode 1036, a clamp capacitor 1038, a clamp resistor 1041, a clamp diode 1042, an insulated gate bipolar transistor (IGBT) 1043, a discharge activation circuit 1044, a first output clamping diode 1051, a second output clamping diode 1052, a third output clamping diode 1053, a fourth output clamping diode 1054, a fifth output clamping diode 1055, and a sixth output clamping diode 1056.

Although one embodiment of a clamp circuit for a matrix converter is depicted, the teachings herein are applicable to clamp circuits implemented in a wide variety of ways. Accordingly, other implementations are possible.

The clamp circuit 1070 includes a first group of terminals 1061-1063 that connect to the AC inputs of an array of switches, and a second group of terminals 1064-1066 that connect to the AC outputs of the array of switches. The first group of terminals 1061-1063 includes a first terminal 1061, a second terminal 1062, and a third terminal 1063. Additionally, the second group of terminals 1064-1066 includes a fourth terminal 1064, a fifth terminal 1065, and a sixth terminal 1066.

As shown in FIG. 51, the input clamping diodes 1031-1036 serve as an input diode array connecting the first discharge node 1057 and the second discharge node 1058 to the AC inputs 1061-1063, while the output clamping diodes 1051-1056 serve as an output diode array connecting the first discharge node 1057 and the second discharge node 1056 to the AC outputs 1064-1066.

In the illustrated embodiment, the first input clamping diode 1031, the second input clamping diode 1032, and the third input clamping diode 1033 include anodes electrically connected to the first terminal 1061, the second terminal 1062, and the third terminal 1063, respectively. Additionally, each of the first input clamping diode 1031, the second input clamping diode 1032, and the third input clamping diode 1033 includes a cathode electrically connected to the first discharge node 1057. Furthermore, the fourth input clamping diode 1034, the fifth input clamping diode 1035, and the sixth input clamping diode 1036 include cathodes electrically connected to the first terminal 1061, the second terminal 1062, and the third terminal 1063, respectively. Additionally, each of the fourth input clamping diode 1034, the fifth input clamping diode 1035, and the sixth input clamping diode 1036 includes an anode electrically connected to the second discharge node 1058. Furthermore, the clamp capacitor 1038 is electrically connected between the first discharge node 1057 and the second discharge node 1058.

With continuing reference to FIG. 51, the clamp resistor 1041 is electrically connected in series with the IGBT 1043 in a discharge path between the first discharge node 1057 and the second discharge node 1058. Although the IGBT 1043 illustrates one example of a discharge device, other implementations of discharge devices can be used.

The clamp resistor 1041 can be implemented in a wide variety of ways. For example, implementing the clamp resistor 1041 with low inductance can inhibits large voltages from developing across the clamp resistor 1041 during clamping.

In the illustrated embodiment, the gate of the IGBT 1043 is controlled by the discharge activation circuit 1044. In certain implementations, the discharge activation circuit 1044 selectively turns on the IGBT 1043 based on monitoring a voltage difference between the first discharge node 1057 and the second discharge node 1058. For example, the discharge activation circuit 1044 can activate the IGBT 1043 when the voltage difference between the first discharge node 1057 and the second discharge node 1058 indicates an overvoltage condition. In certain implementations, the discharge activation circuit 1044 provides the control circuitry with an overvoltage sensing signal indicating whether or not overvoltage has been detected.

As shown in FIG. 51, the clamp diode 1042 is connected in parallel with the clamp resistor 1041, with an anode of the clamp diode 1042 electrically connected to an intermediate node 1059 along the discharge path. Additionally, the cathode of the clamp diode 1042 is electrically connected to first discharge node 1057. The clamp diode 1042 serves as a freewheeling path for any inductive voltage spike generated by the rapid switching of the IGBT 1043 (or other semiconductor discharge device) into a parasitic inductance of the clamp resistor 1041.

In the illustrated embodiment, the switched mode power supply 1020 receives an input supply voltage corresponding to a voltage difference between the first discharge node 1057 and the second discharge node 1058, and generates a regulated DC output voltage that powers control circuitry of a matrix converter. For example, the second discharge node 1058 can serve as a ground voltage to the switched mode power supply 1020, while the first discharge node 1057 can serve as the input supply voltage to switched mode power supply 1020. In certain implementations, the switched mode power supply 1020 is operable over a voltage range of at least 250 V DC to 1000 V DC, thereby enhancing performance in the presence of fluctuations in voltage of the first discharge node 1057 and/or the second discharge node 1058.

As shown in FIG. 51, the first output clamping diode 1051, the second output clamping diode 1052, and the third output clamping diode 1053 include anodes electrically connected to the fourth terminal 1064, the fifth terminal 1065, and the sixth terminal 1066, respectively. Additionally, each of the first output clamping diode 1051, the second output clamping diode 1052, and the third output clamping diode 1053 includes a cathode electrically connected to the first discharge node 1057. Furthermore, the fourth output clamping diode 1054, the fifth output clamping diode 1055, and the sixth output clamping diode 1056 include cathodes electrically connected to the fourth terminal 1064, the fifth terminal 1065, and the sixth terminal 1066, respectively. Additionally, each of the fourth output clamping diode 1054, the fifth output clamping diode 1055, and the sixth output clamping diode 1056 includes an anode electrically connected to the second discharge node 1058.

FIG. 52 is a schematic diagram of one embodiment of a portion of circuitry 1100 of a matrix converter. The circuitry 1100 includes an array of switches 1102, switch drivers 1106a-1106i that drive bidirectional switches 1107a-1107i of the array 1102, a control circuit 1104 that generates input control signals to the switch drivers 1106a-1106i, isolated DC-to-DC converters 1105a-1105i that power the switch drivers 1106a-1106i, and a switched mode power supply 1020 that powers the control circuit 1104 and the isolated DC-to-DC converters 1105a-1105i.

As shown in FIG. 52, the array of switches 1102 includes a first bidirectional switch 1107a connected between a first AC input 1121 and a first AC output 1124, a second bidirectional switch 1107b connected between the first AC input 1121 and a second AC output 1125, a third bidirectional switch 1107c connected between the first AC input 1121 and a third AC output 1126, a fourth bidirectional switch 1107d connected between the second AC input 1122 and the first AC output 1124, a fifth bidirectional switch 1107e connected between the second AC input 1122 and the second AC output 1125, a sixth bidirectional switch 1107f connected between the second AC input 1122 and the third AC output 1126, a seventh bidirectional switch 1107g connected between the third AC input 1123 and the first AC output 1124, an eighth bidirectional switch 1107h connected between the third AC input 1123 and the second AC output 1125, and a ninth bidirectional switch 1107i connected between the third AC input 1123 and the third AC output 1126.

The bidirectional switches 1107a-1107i serve to conduct both positive and negative currents, and are implemented to be able to block both positive and negative voltages.

As shown in FIG. 52, each of the bidirectional switches 1107a-1107i receive a pair of switch control signals. In particular, the bidirectional switches 1107a-1107i receive first to ninth pairs of switch control signals from switch drivers 1106a-1106i, respectively. The switch drivers 1106a-1106i receive first to ninth pairs of input signals from the control circuit 1104. By controlling the state of the input signals over time, the control circuit 1104 achieves a desired modulation algorithm, such as Venturini modulation, Alesina modulation, scalar modulation, fictitious DC-link modulation, and/or space vector modulator. Furthermore, the control circuit 1104 generates the input signals to provide current commutation and/or other desired switching properties.

In the illustrated embodiment, the switched mode power supply 1020 receives an input voltage from internal node(s) of a clamp circuit (not shown in FIG. 52) and generates a DC voltage that powers the control circuit 1104. Additionally, the DC voltage serves as an input to the isolated DC-to-DC converters 1105a-1105i, respectively. The isolated DC-to-DC converters 1105a-1105i in turn provide first to ninth DC voltages to the switch drivers 1106a-1106i, respectively. The isolated DC-to-DC converters 1105a-1105i can be implemented in a wide variety of ways, including, but not limited to, as flyback converters.

FIGS. 53A-53C illustrate various embodiments of bidirectional switches for an array of switches of a matrix converter. Although various examples of bidirectional switches are shown, the teachings herein are applicable to bidirectional switches implemented in a wide variety of ways.

FIG. 53A is a schematic diagram of a bidirectional switch 1600 according to one embodiment. The bidirectional switch 1600 includes a first IGBT 1601, a second IGB2 1602, a first diode 1603, and a second diode 1604. The bidirectional switch 1600 is arranged in a common emitter back-to-back IGBT configuration.

As shown in FIG. 53A, the gate of the first IGBT 1601 receives a first control signal CTL1, and the gate of the second IGBT 1602 receives a second control signal CTL2. Additionally, the collector of the first IGBT 1601 is electrically connected to an input terminal IN and to a cathode of the first diode 1603, and the emitter of the first IGBT 1601 is electrically connected to the emitter of the second IGBT 1602 and to the anodes of the first diode 1603 and the second diode 1604. Furthermore, the collector of the second IGBT 1602 is electrically connected to an output terminal OUT and to a cathode of the second diode 1604.

FIG. 53B is a schematic diagram of a bidirectional switch 1620 according to another embodiment. The bidirectional switch 1620 includes a first IGBT 1621, a second IGBT 1622, a first diode 1623, and a second diode 1624. The bidirectional switch 1620 is arranged in a common collector back-to-back IGBT configuration.

As shown in FIG. 53B, the gate of the first IGBT 1621 receives a first control signal CTL1, and the gate of the second IGBT 1622 receives a second control signal CTL2. Additionally, the emitter of the first IGBT 1621 is electrically connected to an input terminal IN and to an anode of the first diode 1623, and the collector of the first IGBT 1621 is electrically connected to the collector of the second IGBT 1622 and to the cathodes of the first diode 1623 and the second diode 1624. Furthermore, the emitter of the second IGBT 1622 is electrically connected to an output terminal OUT and to an anode of the second diode 1624.

FIG. 53C is a schematic diagram of a bidirectional switch 1640 according to another embodiment. The bidirectional switch 1640 includes a first bidirectional IGBT 1641 and a second bidirectional IGBT 1642. The bidirectional switch 1640 is arranged in a reverse blocking IGBT configuration.

As shown in FIG. 53C, the gate of the first bidirectional IGBT 1641 receives a first control signal CTL1, and the gate of the second bidirectional IGBT 1642 receives a second control signal CTL2. Additionally, a collector/emitter of the first bidirectional IGBT 1641 is electrically connected to the input terminal IN and to the emitter/collector of the second bidirectional IGBT 1642, and an emitter/collector of the first bidirectional IGBT 1641 is electrically connected to the output terminal OUT and to the collector/emitter of the second bidirectional IGBT 1642. Thus, the first bidirectional IGBT 1641 and the second bidirectional IGBT 1642 serves as a pair of switching devices arranged in anti-parallel.

With respect to FIGS. 15A-15C, the first control signal CTL1 and the second control signal CTL2 are provided by a switch driver. Additionally, the input terminal IN couples to an AC input of a switch array, while the output terminal OUT couples to an AC output of a switch array.

FIG. 54 is a schematic diagram of a matrix converter 1700 according to another embodiment. The matrix converter 1700 is providing power to a motor 1718, and includes an input filter 1701, an array of switches 1702, a clamp circuit 1703, a control circuit 1704, 3-phase AC input terminals 1705, 3-phase AC output terminals 1706, input voltage transducers 1711, isolated DC-to-DC converters 1712, switch drivers 1713, a heat sink 1714, output current transducers 1715, current direction sensors 1716, and a shaft position sensor 1717.

As shown in FIG. 54, the clamp circuit 1703 includes a switched mode power supply 1720 that generates a regulated DC voltage that powers the control circuit 1704 and that serves as an input voltage to the isolated DC-to-DC converters 1712. The isolated DC-to-DC converters 1712 (for instance, flyback converters) output DC voltages that power the switch drivers 1713.

With continuing reference to FIG. 54, the control circuit 1704 is electrically connected to an interface, such as a serial interface or bus. The interface can connect to a network to facilitate remote control over the matrix converter 1700 and motor 1718. Additionally, the control circuit 1704 includes digital processing circuitry 1731 (for instance, a processor and/or FPGA) that digitally processes data, and data converters 1732 that provide analog-to-digital conversion and digital-to-analog conversion operations. For example, the data converters 1732 can serve to provide conversion of signals received from the depicted sensors and transducers.

The control circuit 1704 receives a variety of signals that indicate operating conditions of the matrix converter 1700. For example, in the illustrated embodiment, the control circuit 1704 receives input voltage sensing signals from the input voltage transducers 1711, an overvoltage sensing signal from the clamp circuit 1703 (for example, from a discharge activation circuit of the clamp circuit 1703), a temperature sensing signal from the heat sink 1704, output current sensing signals from the output current transducers 1715, current direction sensing signals from the current direction sensors 1716, and a shaft position sensing signal from the shaft position sensor 1717.

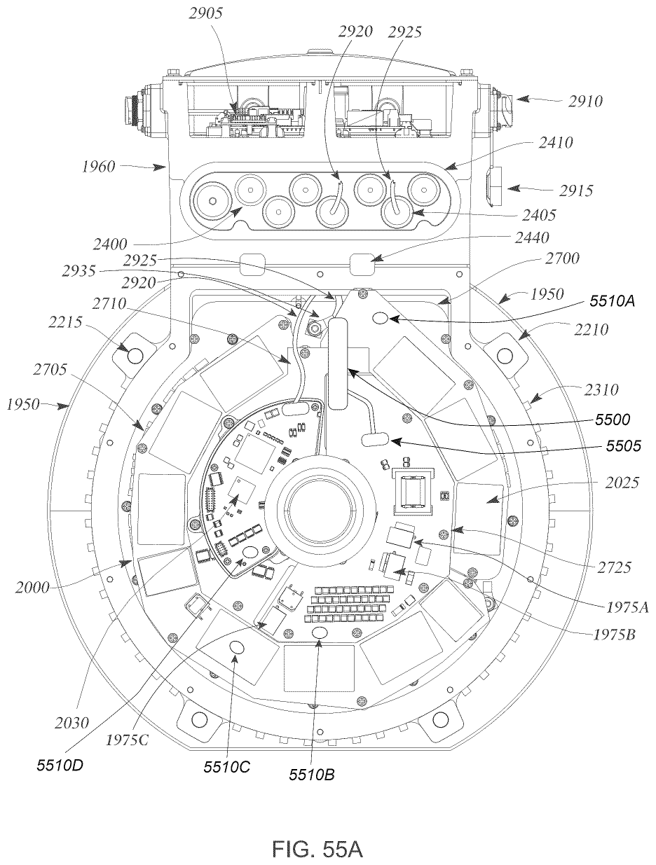

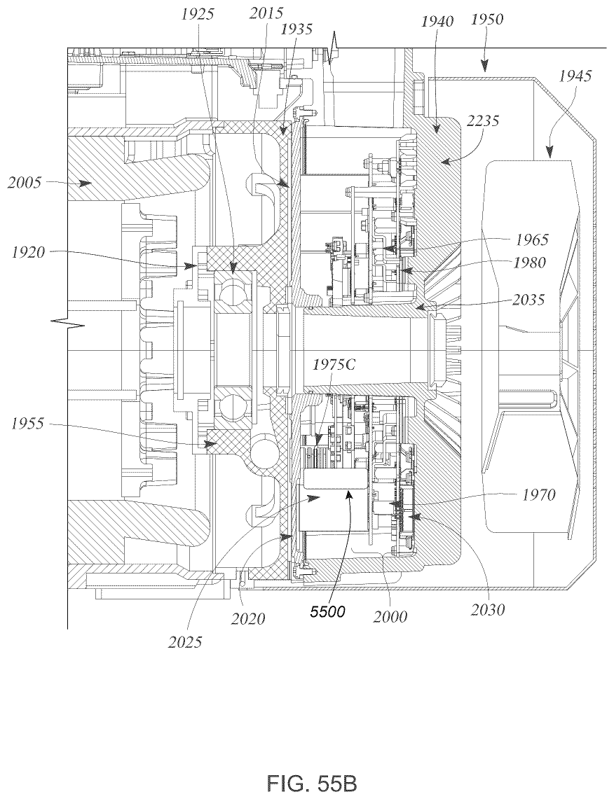

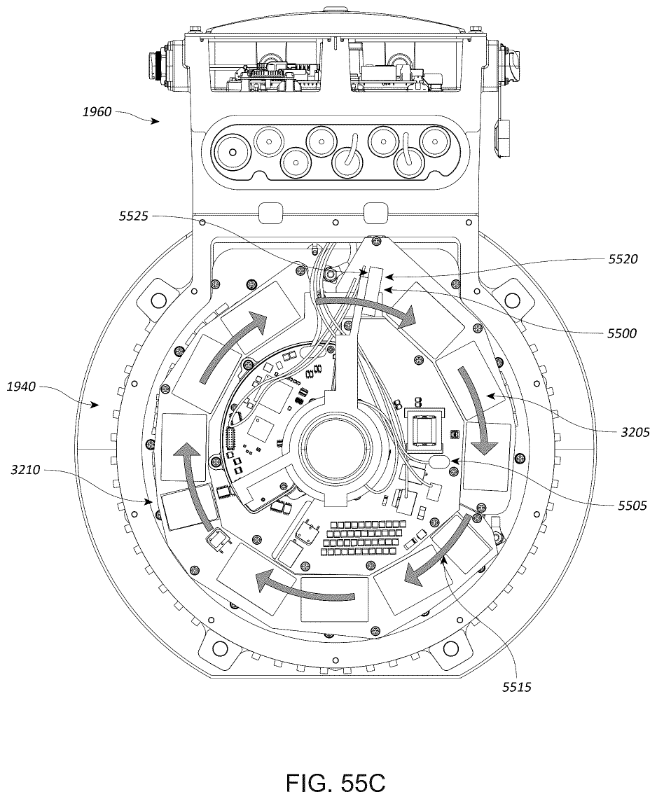

FIG. 55A is a front cross-section view (mid-plate side 1935) of the end-plate 1940 and the motor assembly 1900 that includes a fan 5500. In some embodiments, the fan 5500 provides active cooling (internal air circulation) to improve air flow, heat distribution, and/or to reduce wear on the motor assembly 1900 by providing more optimal operation temperatures. For example, in some embodiments, the fan 5500 circulates the air within the end-plate 1940. The internal air circulation may equalize the air temperatures within the end-plate 1940 and/or reduce temperature stratification. For example, the air circulation may reduce the number of hot spots and/or the peak temperature of the hot spots within the end-plate 1940.

As described above, the motor assembly 1900 may include one or more temperature sensors 4325, 5510A-D. The temperature sensors 4325, 5510A-D may be placed within the end-plate 1940 in a distributed fashion so as to provide an indication of the temperature at different locations in the end-plate 1940, or to provide an average temperature based on measurements from the multiple sensors 4325, 5510A-D. In some embodiments, one or more temperature sensors 4325, 5510A-D may detect the temperature of the surface of the end-plate 1940 and/or the temperature of the interior of the end-plate 1940. In some embodiments, the temperature sensors 4325, 5510A-D may detect the temperature of individual components or groups of components of the multi-board power plane (e.g., the high temperature components 2030). For example, temperature sensor 5510C may be positioned directly on a low temperature component 2025.

The fan 5500 may connect to the multi-board power-plane 2000 via a connector 5505. In some embodiments, the fan may be in communication with the control layer 2705, the second control layer 2710, the third control layer 2730, and/or a power layer 2700. Thus, the fan 5500 may be controlled by any of the electronic components of the multi-board power plane 2000 or by any electronic components in communication with the multi-board power plane 2000. For example, the fan 5500 can be controlled by any of the microprocessors of the multi-board power-plane 2000 or a microprocessor of within the terminal box 1960 such as a microprocessor of the application control board 4310. Thus, the fan 5500 may be integrated with the variable frequency drive electronics unit.

In some embodiments, the fan 5500 may be a variable speed fan. For example, the speed of the fan 5500 may be selected at least partly based on the temperature of the motor assembly detected by some or all of the temperature sensors described herein. Additionally, or alternatively, the speed of the fan 5500 may be selected at least partly based on the surface or interior temperature of the end-plate 1945. For example, the speed of the fan 5500 may increase as the interior temperature of the end-plate 1945 increases. Similarly, the speed of the fan 5500 may decrease as the interior temperature of the end-plate 1945 decreases. Controlling the speed of the fan 5500 based on the temperature of the motor assembly 1900 and/or end-plate 1940 can increase the life span of the fan 5500 while providing sufficient cooling to protect the electronic components of the multi-board power plane 2000 from damage or unnecessary wear. In some embodiments, the speed of the fan 5500 may be based on the temperature of one or more of the electronic components (e.g., the high temperature 2030 components and/or the low temperature components 2025).

In some embodiments, the speed of the fan 5500 increases as the difference between two thermal sensors 4325, 5510A-D increases. For example, the speed of the fan 5500 may be based on the temperature difference of the control layer 2705 and third control layer 2730. Similarly, the speed of the fan may increase as the temperature difference between the top (by terminal box 1960) and bottom of the end-plate 1940 increases. Thus, the fan 5500 speed may be optimized to reduce temperature differences within the end-plate 1940. The speed of the fan 5500 may also, or alternatively, be based at least partly on the speed and/or torque of the motor 1905. For example, the speed of the fan 5500 may increase as the speed and/or torque of the motor 1905 increases. Similarly, the speed of the fan 5500 may decrease as the speed and/or torque of the motor 1905 decreases. Alternatively, or in addition, the speed of the fan 5500 may be at least partly based on the current and/or voltage being used by the motor 1905.

FIG. 55B is a cross-sectional view of part of the motor assembly 1900 that includes a fan 5500. In some embodiments, the fan 5500 may increase the amount of heat transferred to the heat sinks 1975A, 1975B, 1975C and/or conductive cover 2020. Thus, the heat produced by the electronic components may be effectively and efficiently dispersed from the high temperature components 2030 to the end-plate housing 2235 and further to the radial cooling fins 2305 and peripheral cooling fins 2310 (FIG. 23). As described above, in some embodiments, the motor assembly 1900 may have a fan 1945 positioned outside the end-plate 1940. In some embodiments, the speed of the exterior fan 1945 generally matches the speed of the interior fan 5500, and/or a change in speed of the exterior fan 1945 generally matches, tracks, or otherwise relates to a change in speed of the interior fan 5500. For example, when the exterior fan speed increases, the interior fan speed can increase, and when the exterior fan speed decreases, the interior fan speed can decrease, or vice versa. Thus, in some embodiments, the interior fan 5500 and the exterior fan 1945 may work together to reduce the temperature of the motor assembly 1900 and the electronic components of the multi-board power plan 2000. It should be noted that the speed of the exterior fan 1945 may also, or alternatively, be based on the temperature of the end-plate 1940, a temperature difference of the end-plate 1940, or the speed, torque, current, and/or voltage of the motor 1905.

As shown, the interior fan 5500 can be positioned generally proximal to the mid-plate 1935 and distal to the exterior fan 1945. Thus, the interior fan 5500 can particularly impact the temperature of components within the end-plate 1940 that are proximate the mid-plate 1935 and/or mounted on the mid-plate side of one or more of the boards in the multi-board power plane 2000 (e.g., the power quality capacitors 3205, clamp capacitors 3210, or the third control layer 2730) whereas the exterior fan 1945 can particularly impact temperature of components within the end-plate 1940 distal to the mid-plate 1935 and/or mounted on the exterior fan side of one or more of the boards in the multi-board power plane 2000 (e.g., the power modules 3105 or the current sensing modules 3106).

FIG. 55C is a front view of an embodiment of the end-plate 1940. In some embodiments, the fan 5500 is a DC or AC powered axial fan. Alternatively, the fan 5500 may be a centrifugal fan, and/or cross-flow fan. The fan 5500 may have an intake 5525 and an outlet 5520 and may be a high airflow fan and produce high static pressure. The high airflow and high static pressure may ensure that the air from the fan 5500 can easily circulate within the end-plate and between the various PCB boards and electronic components as shown by the airflow arrows 5515. In some embodiments, there are multiple fans 5500 located within the end-plate 1940. For example, a first fan may be placed near the top of the end-plate 1940 (e.g., by the terminal box 1960) and a second fan may be placed near the bottom of the end-plate 1940.

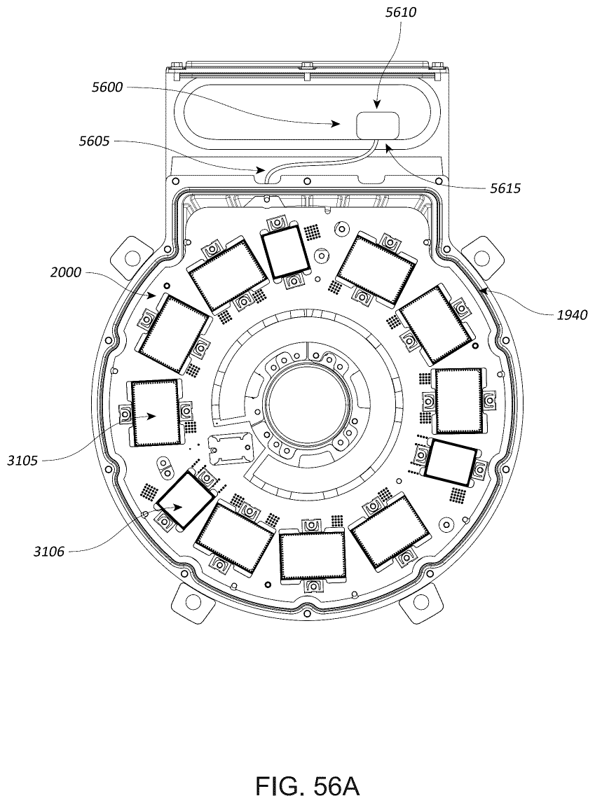

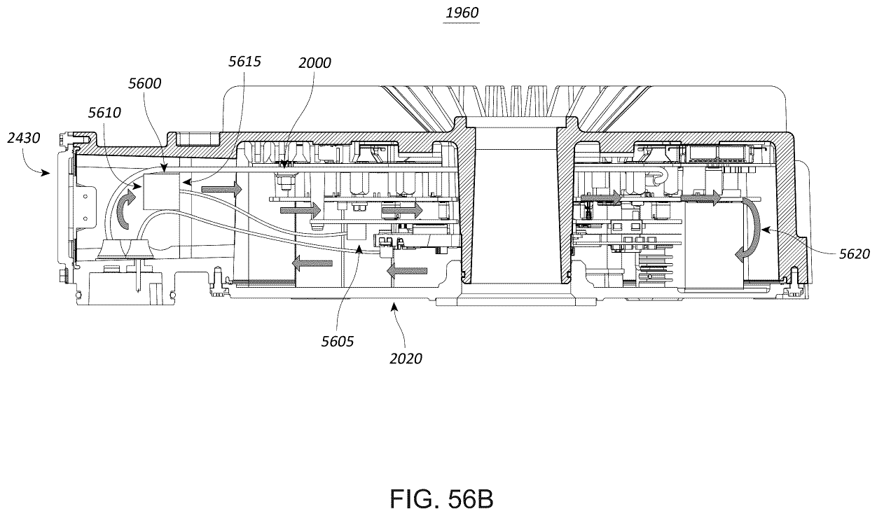

FIGS. 56A and 56B are back and side views, respectively, of an embodiment of the endplate 1940 that includes a fan 5600. In some embodiments, the fan 5600 is placed at the top of the end-plate 1940 (e.g., in the rectangular section by the terminal box 1960) and/or within the terminal box 1960. In some embodiments, there may be one or more vents connecting the top of the end-plate 1940 with the bottom of the end-plate 1940 that contains the PCB boards and electronic components. It should be understood that the fan 5600 may be placed anywhere within the end-plate 1940 based on the needs and preferences of the user. For example, the location of the fan 5600 may be selected to optimized airflow and heat distribution. The fan 5600 may have an intake 5610 and an outlet 5615 and may circulate air as shown by airflow arrows 5620. In some embodiments, the endplate may include fan 5500, fan 5600, and/or one or more additional fans. The fan 5600 may be a DC or AC powered fan, and may be an axial, centrifugal, and/or cross-flow fan.

Similar to fan 5500, fan 5600 may be connected to the multi-board power plane 2000 via connector 5605. In some embodiments, the fan 5600 is easily accessible. For example, the fan 5600 may be access for maintenance or repair by removing top cover 2430. Similarly, fan 5500 may be accessed by removing the conductive cover 2020.

Implementing the matrix converter 1700 with such sensors provides a number of functions, such as over-current trip protection, over-voltage trip protection, thermal trip protection, and/or enhanced control over rotation, torque, and/or speed of the motor 1718.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale.

Although described and illustrated with respect to exemplary embodiments thereof, the foregoing and various other additions and omissions may be made therein and thereto without departing from the spirit and scope.

### Additional Embodiments

In embodiments of the present disclosure, a motor assembly may be in accordance with any of the following clauses:

Clause 1. A motor assembly, comprising: a motor housing; an electrical motor at least partially disposed in the motor housing; a mid-plate disposed in-line with the motor housing, the mid-plate having a first mid-plate wall distal to the motor housing; an end-plate defining a first cavity and disposed in-line with the mid-plate such that the mid-plate is between the motor housing and the end-plate, the end-plate having a first end-plate wall proximal to the first mid-plate wall, wherein the first end-plate wall is comprised of a conductive material; and a variable frequency drive electronics unit disposed within the first cavity and configured to provide power to the electrical motor, wherein the first end-plate wall serves as a heat sink for one or more components of the variable frequency drive electronics unit.

Clause 2. The motor assembly of any of the previous clauses, wherein the variable frequency drive electronics unit comprises a circuit board, a plurality of power modules and a plurality of power control components.

Clause 3. The motor assembly of any of the previous clauses, wherein the plurality of power control components comprises a plurality of power quality filter components mounted to the circuit board about a center of the circuit board.

Clause 4. The motor assembly of any of the previous clauses, wherein the plurality of power quality filter components is in physical contact with the first end-plate wall.

Clause 5. The motor assembly of any of the previous clauses, wherein the first end-plate wall has one or more receded sections configured to contact at least one power quality filter component of the plurality of power quality filter components.

Clause 6. The motor assembly of any of the previous clauses, wherein the plurality of power modules is mounted to the circuit board about a center of the circuit board.

Clause 7. The motor assembly of any of the previous clauses, wherein the plurality of power modules is in physical contact with a second end-plate wall, wherein the first end-plate wall and the second end-plate wall define the first cavity.

Clause 8. The motor assembly of any of the previous clauses, wherein the circuit board has a first side and a second side, wherein the plurality of power control components is on the first side, and the plurality of power modules is on the second side.

Clause 9. The motor assembly of any of the previous clauses, wherein the first mid-plate wall and the first end-plate wall are spaced from one another to define an insulative air gap.

Clause 10. The motor assembly of clause any of the previous clauses, wherein the insulative air gap is 3.5 mm thick.

Clause 11. The motor assembly of clause any of the previous clauses, wherein the insulative air gap has one or more vents, wherein the one or more vents are configured to dissipate heat from the insulative air gap.

Clause 12. The motor assembly of any of the previous clauses, wherein the end-plate has one or more mounting guides.

Clause 13. A plate assembly, comprising: a mid-plate, the mid-plate having a mid-plate wall; an end-plate defining a first cavity and disposed in-line with the mid-plate, the end-plate having a first end-plate wall proximal to the mid-plate wall, wherein the first end-plate wall is comprised of a conductive material; and a variable frequency drive electronics unit disposed within the first cavity and configured to provide power to an electrical motor, wherein the first end-plate wall serves as a heat sink for one or more components of the variable frequency drive electronics unit.

Clause 14. The plate assembly of any of the previous clauses, wherein the variable frequency drive electronics unit comprises a circuit board, a plurality of power modules and a plurality of power control components, wherein the plurality of power control components comprises a plurality of power quality filter components.

Clause 15. The plate assembly of any of the previous clauses, wherein the plurality of power quality filter components is in physical contact with the first end-plate wall.

Clause 16. The plate assembly of any of the previous clauses, wherein the first end-plate wall has one or more receded sections configured to contact at least one power quality filter component of the plurality of power quality filter components.

Clause 17. The plate assembly of any of the previous clauses, wherein the mid-plate wall and the first end-plate wall are spaced from one another to define an insulative air gap.

Clause 18. The plate assembly of any of the previous clauses, the insulative air gap has one or more vents, wherein the one or more vents are configured to dissipate heat from the insulative air gap.

Clause 19. The plate assembly of any of the previous clauses, wherein the insulative air gap is 3.5 mm thick.

Clause 20. The plate assembly of any of the previous clauses, wherein the plate assembly further comprises: a motor housing disposed in-line with the mid-plate, wherein the mid-plate is between the motor housing and the end-plate and the mid-plate wall is distal to the motor housing; and, the electrical motor at least partially disposed in the motor housing, wherein the electrical motor is distal to the mid-plate wall.

Clause 21. A motor assembly, comprising: a motor housing; an electrical motor at least partially disposed in the motor housing; a mid-plate disposed in-line with the motor housing, the mid-plate having a first mid-plate wall distal to the motor housing; an end-plate defining a first cavity and disposed in-line with the mid-plate such that the mid-plate is between the motor housing and the end-plate, the end-plate having a first end-plate wall proximal to the first mid-plate wall, wherein the first end-plate wall is comprised of a conductive material; and a variable frequency drive electronics unit disposed within the first cavity and configured to provide power to the electrical motor, wherein the first end-plate wall serves as a heat sink for one or more components of the variable frequency drive electronics unit.

Clause 22. The motor assembly of any of the previous clauses, wherein the variable frequency drive electronics unit comprises a circuit board, a plurality of power modules and a plurality of power control components.

Clause 23. The motor assembly of any of the previous clauses, wherein the plurality of power control components comprises a plurality of power quality filter components mounted to the circuit board about a center of the circuit board.

Clause 24. The motor assembly of any of the previous clauses, wherein the plurality of power quality filter components is in physical contact with the first end-plate wall.

Clause 25. The motor assembly of any of the previous clauses, wherein the first end-plate wall has one or more receded sections configured to contact at least one power quality filter component of the plurality of power quality filter components.

Clause 26. The motor assembly of any of the previous clauses, wherein the plurality of power modules is mounted to the circuit board about a center of the circuit board.

Clause 27. The motor assembly of any of the previous clauses, wherein the plurality of power modules is in physical contact with a second end-plate wall, wherein the first end-plate wall and the second end-plate wall define the first cavity.

Clause 28. The motor assembly of any of the previous clauses, wherein the circuit board has a first side and a second side, wherein the plurality of power control components is on the first side, and the plurality of power modules is on the second side.

Clause 29. The motor assembly of any of the previous clauses, wherein the first mid-plate wall and the first end-plate wall are spaced from one another to define an insulative air gap.

Clause 30. The motor assembly of any of the previous clauses, wherein the insulative air gap is 3.5 mm thick.

Clause 31. The motor assembly of any of the previous clauses, the insulative air gap has one or more vents, wherein the one or more vents are configured to dissipate heat from the insulative air gap.

Clause 32. The motor assembly of any of the previous clauses, wherein the end-plate has one or more mounting guides.

Clause 33. A motor assembly, comprising: a motor housing; an electrical motor at least partially disposed in the motor housing; a mid-plate disposed in-line with the motor housing, the mid-plate having a first mid-plate wall; an end-plate disposed in-line with the mid-plate such that the mid-plate is between the motor housing and the end-plate, the end-plate defining a first cavity and comprising a first end-plate wall proximal to the first mid-plate wall; and, a variable frequency drive electronics unit disposed within the first cavity and configured to provide power to the electrical motor; wherein the mid-plate and the end-plate are arranged such that the first mid-plate wall and the first end-plate wall are spaced from one another to define an insulative air gap between the mid-plate and the end-plate.

Clause 34. The motor assembly of any of the previous clauses, wherein the variable frequency drive electronics unit comprises a circuit board, a plurality of power modules and a plurality of power control components.

Clause 35. The motor assembly of any of the previous clauses, wherein the plurality of power control components comprises a plurality of power quality filter components mounted to the circuit board about a center of the circuit board.

Clause 36. The motor assembly of any of the previous clauses, wherein the first end-plate wall is a heat sink.

Clause 37. The motor assembly of any of the previous clauses, wherein the plurality of power quality filter components is in physical contact with the first end-plate wall.

Clause 38. The motor assembly of any of the previous clauses, wherein the first end-plate wall has one or more receded sections configured to contact at least one power quality filter component of the plurality of power quality filter components.

Clause 39. The motor assembly of any of the previous clauses, wherein the insulative air gap is 3.5 mm thick.

Clause 40. The motor assembly of any of the previous clauses, wherein the insulative air gap has one or more vents, wherein the one or more vents are configured to dissipate heat from the insulative air gap.

Clause 41. A motor assembly, comprising: a motor housing; an electrical motor at least partially disposed in the motor housing; a variable frequency drive unit disposed in-line with the motor housing, the variable frequency drive unit comprising a drive unit housing defining a first cavity; a terminal box supported by the motor housing, wherein the terminal box defines a second cavity; and a variable frequency drive electronics unit disposed partially within the first cavity and partially within the second cavity and configured to provide power to the electrical motor.

Clause 42. The motor assembly of any of the previous clauses, wherein the variable frequency drive electronics unit comprises a circuit board, a plurality of power modules and a plurality of power control components.

Clause 43. The motor assembly of any of the previous clauses, wherein the plurality of power modules is positioned within the first cavity, and the plurality of power control components is positioned within the first cavity and the second cavity.

Clause 44. The motor assembly of any of the previous clauses, wherein the plurality of power control components positioned within the second cavity include one or more inductors.

Clause 45. The motor assembly of any of the previous clauses, wherein the plurality of power control components positioned within the second cavity are one or more power quality filter components.

Clause 46. The motor assembly of any of the previous clauses, wherein the plurality of power control components positioned within the second cavity include one or more surge protection varistors, one or more capacitors, one or more RFI filters, and a circuit board.

Clause 47. The motor assembly of any of the previous clauses, wherein the terminal box is removably coupled from the motor housing.

Clause 48. The motor assembly of any of the previous clauses, wherein the terminal box has one or more connectors with self-sealing grommets.

Clause 49. A motor assembly, comprising: a motor housing; an electrical motor at least partially disposed in the motor housing; a variable frequency drive electronics unit housing disposed in-line with the motor housing and defining a first cavity, the drive electronics unit housing having one or more guide features configured to align with one or more corresponding guide features for removable mounting of the variable frequency drive electronics unit housing, such that the variable frequency drive electronics unit housing is supported by the motor housing; and variable frequency drive electronics disposed within the first cavity and configured to provide power to the electrical motor.

Clause 50. The motor assembly of any of the previous clauses, wherein the variable frequency drive electronics comprises a circuit board, a plurality of power modules and a plurality of power control components.

Clause 51. The motor assembly of any of the previous clauses, wherein the plurality of power control components comprises a plurality of power quality filter components mounted to the circuit board about a center of the circuit board.

Clause 52. The motor assembly of any of the previous clauses, further comprising a mid-plate disposed between the variable frequency drive electronics unit housing and the motor housing, the mid-plate comprising the one or more corresponding guide features.

Clause 53. The motor assembly of any of the previous clauses, wherein the circuit board has a first side and a second side, wherein the plurality of power control components is on the first side, and the plurality of power modules is on the second side.

Clause 54. The motor assembly of any of the previous clauses, wherein the motor housing comprises the one or more corresponding guide features.

Clause 55. The motor assembly of any of the previous clauses, wherein the one or more guide features are of male orientation and the one or more corresponding guide features are of female orientation.

Clause 56. A method of installing a variable frequency drive electronics unit housing comprising mating one or more guide features of the variable frequency drive electronics unit housing with one or more corresponding guide features of a motor housing, and subsequently fastening the variable frequency drive electronics unit housing for mounted support by the motor housing.

Clause 57. A motor assembly, comprising: a motor housing; an electrical motor at least partially disposed in the motor housing; a variable frequency drive unit disposed in-line with the motor housing, the variable frequency drive unit defining a first cavity and comprising a first wall proximal to the motor housing and a second wall distal to the motor housing; a terminal box disposed on the motor housing, wherein the terminal box comprises of a second cavity; and a variable frequency drive electronics unit configured to provide power to the electrical motor comprising: a first segment comprising group of a plurality of electrical components disposed within the first cavity; and a second segment comprising one or more electrical components disposed within the second cavity.

Clause 58. The motor assembly of any of the previous clauses, wherein the first wall comprises a thermal heat sink configured to dissipate heat generated by the variable frequency drive electronics unit.

Clause 59. The motor assembly of any of the previous clauses, further comprising a mid-plate disposed between the variable frequency drive unit and the motor housing such that the first wall of the motor housing is proximal to the mid-plate.

Clause 60. The motor assembly of any of the previous clauses, wherein the first and second segments of the variable frequency drive electronics unit implement a matrix converter.

### Group 2:

Clause 1. A motor assembly, comprising: a motor housing; an electrical motor at least partially disposed in the motor housing; a motor drive housing defining a first cavity and disposed in-line with the motor housing, the motor drive housing having a first motor drive housing wall proximal to the motor housing, and a second motor drive housing wall distal to the electrical motor, wherein the first motor drive housing wall comprises a conductive material; a first fan disposed in-line with the motor housing and the motor drive housing, wherein the motor drive housing is disposed between the first fan and the motor housing; and a variable frequency drive electronics unit disposed within the first cavity and configured to provide power to the electrical motor, wherein the first motor drive housing wall serves as a heat sink for one or more components of the variable frequency drive electronics unit, the variable frequency drive electronics unit comprising: at least one circuit board, a plurality of power modules, a second fan, and a plurality of power control components comprising a plurality of power quality filter components mounted to the at least one circuit board.

Clause 2. The motor assembly of clause 1, wherein the variable frequency drive electronics unit comprises one or more thermal sensor.

Clause 3. The motor assembly of clause 2, wherein the first fan is a variable speed fan, wherein the speed of the first fan is at least partly based on a temperature within the motor drive housing.

Clause 4. The motor assembly of clause 3, wherein the second fan is a variable speed fan, wherein the speed of the second fan is at least partly based on the temperature within the motor drive housing.

Clause 5. The motor assembly of clause 4, wherein the speed of the second fan is at least partly based on a temperature differential within the motor drive housing.

Clause 6. The motor assembly of clause 1, wherein the speed of the first fan and second fan is at least partly based on a current being drawn by the motor.

Clause 7. The motor assembly of clause 4, wherein the plurality of power quality filter components is in physical contact with the first motor drive housing wall.

Clause 8. The motor assembly of clause 1, wherein the first motor drive housing wall has one or more receded sections configured to contact at least one power quality filter component of the plurality of power quality filter components.

Clause 9. The motor assembly of clause 1, wherein the plurality of power modules is mounted to the at least one circuit board about a center of the at least one circuit board.

Clause 10. The motor assembly of clause 9, wherein the plurality of power modules is in physical contact with the second motor drive housing wall, wherein the first motor drive housing wall and the second motor drive housing wall define the first cavity.

Clause 11. The motor assembly of clause 1, wherein the at least one circuit board has a first side and a second side, wherein the plurality of power control components is on the first side, and the plurality of power modules is on the second side.

Clause 12. The motor assembly of clause 1, further comprising a mid-plate disposed between the motor drive housing and the motor housing, wherein a first mid-plate wall of the mid-plate and the first motor drive housing wall are spaced from one another to define an insulative air gap.

Clause 13. The motor assembly of clause 12, wherein the insulative air gap is 3.5 mm thick.

Clause 14. The motor assembly of clause 13, wherein the insulative air gap has one or more vents, wherein the one or more vents are configured to dissipate heat from the insulative air gap.

Clause 15. The motor assembly of clause 1, wherein the motor drive housing has one or more mounting guides.

Clause 16. A plate assembly, comprising: a mid-plate, the mid-plate having a mid-plate wall; an end-plate defining a first cavity and disposed in-line with the mid-plate, the end-plate having a first end-plate wall proximal to the mid-plate wall, wherein the first end-plate wall is comprised of a conductive material; a variable frequency drive electronics unit disposed within the first cavity and configured to provide power to an electrical motor, wherein the first end-plate wall serves as a heat sink for one or more components of the variable frequency drive electronics unit; a first fan disposed within the end-plate; and a second fan disposed in-line with the end-plate proximal to a second wall of the end-plate.

Clause 17. The plate assembly of clause 16, wherein the variable frequency drive electronics unit comprises one or more thermal sensor.

Clause 18. The plate assembly of clause 17, wherein the first fan is a variable speed fan, wherein the speed of the first fan is at least partly based on a temperature within the end-plate.

Clause 19. The plate assembly of clause 17, wherein the second fan is a variable speed fan, wherein the speed of the second fan is at least partly based on a temperature within the end-plate.

Clause 20. The plate assembly of clause 17, wherein the speed of the first fan and second fan is at least partly based on a temperature differential within the end-plate.

Clause 21. The plate assembly of clause 16, wherein the variable frequency drive electronics unit comprises a circuit board, a plurality of power modules and a plurality of power control components, wherein the plurality of power control components comprises a plurality of power quality filter components.

Clause 22. The plate assembly of clause 21, wherein the plurality of power quality filter components is in physical contact with the first end-plate wall.

Clause 23. The plate assembly of clause 22, wherein the first end-plate wall has one or more receded sections configured to contact at least one power quality filter component of the plurality of power quality filter components.

Clause 24. The plate assembly of clause 16, wherein the mid-plate wall and the first end-plate wall are spaced from one another to define an insulative air gap.

Clause 25. The plate assembly of clause 24, the insulative air gap has one or more vents, wherein the one or more vents are configured to dissipate heat from the insulative air gap.

Clause 26. The plate assembly of clause 24, wherein the insulative air gap is 3.5 mm thick.

Clause 27. The plate assembly of clause 16, wherein the plate assembly further comprises: a motor housing disposed in-line with the mid-plate, wherein the mid-plate is between the motor housing and the end-plate and the mid-plate wall is distal to the motor housing; and the electrical motor at least partially disposed in the motor housing, wherein the electrical motor is distal to the mid-plate wall.

Clause 28. A motor assembly, comprising: a motor housing; an electrical motor at least partially disposed in the motor housing; a mid-plate disposed in-line with the motor housing, the mid-plate having a first mid-plate wall; an end-plate disposed in-line with the mid-plate such that the mid-plate is between the motor housing and the end-plate, the end-plate defining a first cavity and comprising a first end-plate wall proximal to the first mid-plate wall; and a variable frequency drive electronics unit disposed within the first cavity and configured to provide power to the electrical motor, wherein the variable frequency drive electronics unit comprises one or more variable speed fans; wherein the mid-plate and the end-plate are arranged such that the first mid-plate wall and the first end-plate wall are spaced from one another to define an insulative air gap between the mid-plate and the end-plate.

Clause 29. The motor assembly of clause 28, wherein the variable frequency drive electronics unit comprises a circuit board, a plurality of power modules and a plurality of power control components.

Clause 30. The motor assembly of clause 29, wherein the plurality of power control components comprises a plurality of power quality filter components mounted to the circuit board about a center of the circuit board.

Clause 31. The motor assembly of clause 30, wherein the first end-plate wall is a heat sink.

Clause 32. The motor assembly of clause 31, wherein the plurality of power quality filter components is in physical contact with the first end-plate wall.

Clause 33. The motor assembly of clause 32, wherein the first end-plate wall has one or more receded sections configured to contact at least one power quality filter component of the plurality of power quality filter components.

Clause 34. The motor assembly of clause 28, wherein the insulative air gap is 3.5 mm thick.

Clause 35. The motor assembly of clause 34, wherein the insulative air gap has one or more vents, wherein the one or more vents are configured to dissipate heat from the insulative air gap.

1. A motor assembly, comprising:
a motor housing;
an electrical motor at least partially disposed in the motor housing;
a motor drive housing defining a first cavity and disposed in-line with the motor housing, the motor drive housing having a first motor drive housing wall proximal to the motor housing, and a second motor drive housing wall distal to the electrical motor, wherein the first motor drive housing wall comprises a conductive material;
a first fan disposed in-line with the motor housing and the motor drive housing, wherein the motor drive housing is disposed between the first fan and the motor housing; and
a variable frequency drive electronics unit disposed within the first cavity and configured to provide power to the electrical motor, wherein the first motor drive housing wall serves as a heat sink for one or more components of the variable frequency drive electronics unit, the variable frequency drive electronics unit comprising:
at least one circuit board,
a plurality of power modules,
a second fan, and
a plurality of power control components comprising a plurality of power quality filter components mounted to the at least one circuit board.

2. The motor assembly of claim 1, wherein the variable frequency drive electronics unit comprises one or more thermal sensor.

3. The motor assembly of claim 2, wherein the first fan is a variable speed fan, wherein a speed of the first fan is at least partly based on a temperature within the motor drive housing.

4. The motor assembly of claim 3, wherein the second fan is a variable speed fan, wherein a speed of the second fan is at least partly based on the temperature within the motor drive housing.

5. The motor assembly of claim 4, wherein the speed of the second fan is at least partly based on a temperature differential within the motor drive housing.

6. The motor assembly of claim 1, wherein a speed of the first fan and second fan is at least partly based on a current being drawn by the motor.

7. A plate assembly, comprising:
a mid-plate, the mid-plate having a mid-plate wall;
an end-plate defining a first cavity and disposed in-line with the mid-plate, the end-plate having a first end-plate wall proximal to the mid-plate wall, wherein the first end-plate wall is comprised of a conductive material;
a variable frequency drive electronics unit disposed within the first cavity and configured to provide power to an electrical motor, wherein the first end-plate wall serves as a heat sink for one or more components of the variable frequency drive electronics unit;
a first fan disposed within the end-plate; and
a second fan disposed in-line with the end-plate proximal to a second wall of the end-plate.

8. The plate assembly of claim 7, wherein the variable frequency drive electronics unit comprises one or more thermal sensor.

9. The plate assembly of claim 8, wherein the first fan is a variable speed fan, wherein a speed of the first fan is at least partly based on a temperature within the end-plate.

10. The plate assembly of claim 8, wherein the second fan is a variable speed fan, wherein a speed of the second fan is at least partly based on a temperature within the end-plate.

11. The plate assembly of claim 8, wherein a speed of the first fan and second fan is at least partly based on a temperature differential within the end-plate.

12. The plate assembly of claim 7, wherein the variable frequency drive electronics unit comprises a circuit board, a plurality of power modules and a plurality of power control components, wherein the plurality of power control components comprises a plurality of power quality filter components.

13. The plate assembly of claim 12, wherein the plurality of power quality filter components is in physical contact with the first end-plate wall.

14. The plate assembly of claim 13, wherein the first end-plate wall has one or more receded sections configured to contact at least one power quality filter component of the plurality of power quality filter components.

15. The plate assembly of claim 7, wherein the plate assembly further comprises:
a motor housing disposed in-line with the mid-plate, wherein the mid-plate is between the motor housing and the end-plate and the mid-plate wall is distal to the motor housing; and
the electrical motor at least partially disposed in the motor housing, wherein the electrical motor is distal to the mid-plate wall.

16. A motor assembly, comprising:
a motor housing;
an electrical motor at least partially disposed in the motor housing;
a mid-plate disposed in-line with the motor housing, the mid-plate having a first mid-plate wall;
an end-plate disposed in-line with the mid-plate such that the mid-plate is between the motor housing and the end-plate, the end-plate defining a first cavity and comprising a first end-plate wall proximal to the first mid-plate wall; and
a variable frequency drive electronics unit disposed within the first cavity and configured to provide power to the electrical motor, wherein the variable frequency drive electronics unit comprises one or more variable speed fans;
wherein the mid-plate and the end-plate are arranged such that the first mid-plate wall and the first end-plate wall are spaced from one another to define an insulative air gap between the mid-plate and the end-plate.

17. The motor assembly of claim 16, wherein the variable frequency drive electronics unit comprises a circuit board, a plurality of power modules and a plurality of power control components.

18. The motor assembly of claim 17, wherein the plurality of power control components comprises a plurality of power quality filter components mounted to the circuit board about a center of the circuit board.

19. The motor assembly of claim 16, wherein the insulative air gap is 3.5 mm thick.

20. The motor assembly of claim 16, wherein the insulative air gap has one or more vents, wherein the one or more vents are configured to dissipate heat from the insulative air gap.
